(19) United States
(12) Patent Application Publication
(10) Pub. No.: US 2024/0185541 A1
(43) Pub. Date: Jun. 6, 2024

(54) APPARATUS, SYSTEMS, METHODS AND COMPUTER PROGRAM PRODUCTS PERTAINING TO THE PRINTING OF THREE-DIMENSIONAL ARTICLES

(71) Applicant: Food Printing Technologies, LLC, Williamsville, NY (US)

(72) Inventors: Theodore F. Cyman, Jr., Minneola, FL (US); David M. Cyman, Minneola, FL (US); Nichole L. Nash, Minneola, FL (US)

(21) Appl. No.: 18/450,059

(22) Filed: Aug. 15, 2023

Related U.S. Application Data
(60) Provisional application No. 63/373,371, filed on Aug. 24, 2022.
(60) Provisional application No. 63/486,162, filed on Feb. 21, 2023.

(51) Int. Cl. G06T 19/00; G06F 3/12; G06T 5/50; G06T 11/60; G06V 10/56; G06V 10/60

(52) U.S. Cl. CPC G06T 19/006; G06F 3/12; G06T 5/50; G06T 11/60; G06V 10/56; G06V 10/60; G06T 2207/20221

(57) ABSTRACT

Apparatus, systems, methods and computer program pertaining to the printing of three-dimensional articles.

### CROSS-REFERENCE TO RELATED APPLICATIONS

This is a U.S. patent application claiming priority to and the benefit under 35 U.S.C. 119(e) of U.S. Provisional Application Ser. No. 63/373,371, filed Aug. 24, 2022, and U.S. Provisional Application Ser. No. 63/486,162, filed Feb. 21, 2023. The contents of each said provisional application are incorporated herein by this reference in their entirety.

### BACKGROUND

### 1. Field

The present disclosure relates to printing. More particularly, the disclosure is directed to the printing of articles, particularly three-dimensional articles, including but not limited to edible articles such as food products.

### 2. Description of the Prior Art

By way of background, edible food products are sometimes printed with images containing text and/or graphics using non-contact printing techniques. For example, cookies, cakes, pastries, confections, candies and the like have been printed using ink-jet printing apparatus set up to apply food-grade editable ink directly onto food surfaces. Current food printing techniques suffer from a number of disadvantages, including inability to accurately determine and maintain precise food/print head positioning, lack of efficient image-to-printer calibration and normalization techniques, absence of efficient production workflow control from image creation through product production and pack-out, non-centralized coordination between suppliers of production goods and services, printed product producers, sales entities, and direct consumers, and overall lack of scalability.

It is to improvements in the printing of articles, particularly three-dimensional articles, and still more particularly edible articles such as food products, that the present disclosure is directed.

### SUMMARY

In one aspect, a scanning and print control system including a scanner, a production controller and a printing apparatus, captures specific information of articles (e.g., edible articles such as food products) to be printed. Embodiments may include the use of an integrated or detached camera and display technology to define the specific location, size, and shape of the articles when placed on a tray and thereafter to be printed.

In another aspect, a global print manager supports the creation of print job requests, distributes specific information and/or graphic images to be printed on articles (e.g., edible food products) to one or more scanning and print control systems. Embodiments may scale image dimensions to match the size and shape of the articles to be printed, manage color profiles and maintain calibration data to support positional registration of the printed image placement on the articles as printing occurs.

In another aspect, an augmented reality (AR) system may capture, assign, distribute, and bind a specific AR event/media related to an article (e.g., an editable article such as a food product) that may (or may not) have a graphic image printed on the article.

Other aspects providing further features and advantages are additionally disclosed.

### BRIEF DESCRIPTION OF THE DRAWINGS

The foregoing and other features and advantages will be apparent from the following more particular description of example embodiments, as illustrated in the accompanying Drawings.

FIG. 1 is a functional block diagram showing an example scanning and print control system that includes an integrated scanner and production controller, and a set of printers for printing images on food products and other production devices.

FIG. 2 is a perspective view showing the integrated scanner and production controller of the scanning and print control system of FIG. 1.

FIG. 3 is a cross-sectional view of the integrated scanner and production controller of FIG. 2.

FIG. 4 is a perspective view of the integrated scanner and production controller of FIG. 2 during a stage if an example article placement operation.

FIG. 5 is a perspective view of the integrated scanner and production controller of FIG. 2 during another stage of an example article placement operation.

FIG. 6 is a perspective view of the integrated scanner and production controller of FIG. 2 during another stage of an example article placement operation.

FIG. 7 is a diagrammatic side view illustration of the integrated scanner and production controller of FIG. 2 showing an example product position detection operation.

FIG. 8 is a diagrammatic side view illustration of the integrated scanner and production controller of FIG. 2 showing an example article height-determining operation.

FIGS. 9A, 9B and 9C are diagrammatic plan view illustrations of the integrated scanner and production controller of FIG. 2 showing aspects of the article height-determining operation of FIG. 8.

FIG. 10 is a diagrammatic side view illustration of the integrated scanner and production controller of FIG. 2 showing further aspects of the article height-determining operation of FIG. 8.

FIGS. 11A and 11B are perspective views of a printing apparatus and a tray of articles to be printed, with FIG. 11A illustrating the articles before printing and FIG. 11B illustrating the articles after printing.

FIG. 12 is a functional block diagram showing another embodiment of a scanning and print control system that includes a scanner, a production controller, a printer and a movable article conveyor.

FIG. 13 is a functional block diagram showing the scanning and print control system of FIG. 1 coordinating with an example global print manager.

FIG. 14 is a functional block diagram showing an embodiment of the global print manager of FIG. 13.

FIG. 15 is a functional block diagram illustrating components of the global print manager of FIG. 13 that support interactions with suppliers of goods and services used for the production of printed articles.

FIG. 16 is a functional block diagram illustrating components of the global print manager of FIG. 13 that support interactions with sales entities involved in the sale of printed articles.

FIG. 17 is a functional block diagram illustrating components of the global print manager of FIG. 13 that support interactions with members of the general public.

FIG. 18 is a diagrammatic illustration showing example operations that may be performed by the global print manager of FIG. 13 to create a print job request.

FIG. 19 is a functional block diagram illustrating components of the global print manager of FIG. 13 that support interactions with printed article producers.

FIG. 20 is a flow diagram depicting an example printed article production workflow operation that may be implemented by the global print manager of FIG. 13 in conjunction with the scanning and print control system of FIG. 1.

FIG. 21 is a flow diagram depicting example operations that may be performed by a client application to create a print job request.

FIG. 22 is a flow diagram depicting example operations that may be performed by the global print manager of FIG. 13 to create a print job request.

FIG. 23 is a flow diagram depicting example operations that may be performed by the scanning and print control system of FIG. 1 to fulfill a print job request.

FIG. 24 is a functional block diagram showing an example augmented reality (AR) controller operable to capture, assign, distribute, and bind specific AR content related to a printed article.

FIG. 25 is a functional block diagram illustrating example transformation, image encoding and binding, 3D object generator, asset storage and streaming service components of the AR controller of FIG. 24.

FIG. 26 is a diagrammatic illustration showing example AR-enhanced print job template operations that may be performed by the AR controller of FIG. 24 to create an AR-enhanced print job request or augment a non-AR-enhanced print job request to support the display of AR content in proximity to a printed article.

FIG. 27 is a flow diagram illustrating example AR workflow operations involving the AR controller of FIG. 21, the global print manager of FIG. 13, and the scanning and print control system of FIG. 1.

FIG. 28 is a flow diagram illustrating example operations that may be performed by an AR content creator application to create an AR-enhanced print job request.

FIG. 29 is a flow diagram depicting example operations that may be performed by the AR controller of FIG. 24 to create an AR-enhanced print job request.

FIG. 30 is a flow diagram illustrating example operations that may be performed by an AR content receiver application to display AR content associated with an AR-enhanced print job request.

FIG. 31 is a functional block another example augmented reality (AR) controller operable to capture, assign, distribute, and bind specific AR content related to a printed article.

FIG. 32 is a functional block diagram illustrating example transformation, image encoding and binding, 3D object generator, asset storage, streaming service and product control logic of the AR controller of FIG. 31.

FIGS. 33A-33C collectively illustrate a three-part functional block diagram illustrating example services that may be provided by the product control logic of FIG. 32.

FIG. 34 is a functional block diagram illustrating an anchor image auto adjust service that may be provided by the product control logic of FIG. 32.

FIG. 35 is a flow diagram illustrating example processing that may be performed by the anchor image auto adjust service of FIG. 34.

FIG. 36A is a functional block diagram illustrating a first example component of a multiple anchor images to AR asset service that may be provided by the product control logic of FIG. 32.

FIG. 36B is a functional block diagram illustrating a second example component of a multiple anchor images to AR asset service that may be provided by the product control logic of FIG. 32.

FIG. 37 is a flow diagram illustrating example processing that may be performed in accordance with the first and second example components of the multiple anchor images to AR asset service shown in FIGS. 36A and 36B.

FIG. 38 is a functional block diagram illustrating an NFC tap mode of an NFC RFID under anchor image service that may be provided by the product control logic of FIG. 32.

FIG. 39 is a listing of example products that may be deployed as AR-enhanced articles using a printed medium, a standardized encoded image that may be provided by an anchor image QR, App clip code service, and/or embedded technology that may be provided by an NFC RFID under anchor image service of the product control logic of FIG. 32.

FIG. 40 is a flow diagram illustrating example AR workflow operations involving the AR controller of FIG. 31, the global print manager of FIG. 13, and the scanning and print control system of FIG. 1, and utilizing printed media, standardized encoded images, and/or embedded technology.

FIG. 41 is another flow diagram illustrating example AR workflow operations involving the AR controller of FIG. 31, the global print manager of FIG. 13, and the scanning and print control system of FIG. 1, and utilizing printed media, standardized encoded images, and/or embedded technology.

FIG. 42 is another flow diagram illustrating example AR workflow operations involving the AR controller of FIG. 31, the global print manager of FIG. 13, and the scanning and print control system of FIG. 1, and utilizing printed media, standardized encoded images, and/or embedded technology.

FIG. 43 is a functional block diagram illustrating an example dynamic anchor decoding service that may be provided by the product control logic of FIG. 32.

FIG. 44 is a functional block diagram illustrating aspects the example dynamic anchor decoding service of FIG. 43.

FIG. 45 is a flow diagram illustrating example processing that may be performed by the dynamic anchor decoding service of FIGS. 43-44.

FIG. 46 is a flow diagram illustrating further example processing that may be performed by the dynamic anchor decoding service of FIGS. 43-44.

FIG. 47 is a flow diagram illustrating example processing that may be performed by an AR content receiver application to invoke the dynamic anchor decoding service of FIGS. 43-44.

FIGS. 48A-48B collectively represent a flow diagram illustrating example operations that may be performed by an AR content creator application to create an AR enhanced print job request.

FIGS. 49A-49C collectively represent a flow diagram depicting example operations that may be performed by the AR controller of FIG. 24 to create an AR-enhanced print job request.

FIG. 50 is a flow diagram illustrating example operations that may be performed by an AR content receiver application to display AR content associated with an AR-enhanced print job request.

FIG. 51 is a functional block diagram depicting example data processing functionality according to an embodiment of the present invention.

FIG. 52 is a functional block diagram depicting a cloud computing environment according to an embodiment of the present invention.

FIG. 53 is a functional block diagram depicting abstraction model layers according to an embodiment of the present invention.

### DETAILED DESCRIPTION OF EXAMPLE EMBODIMENTS

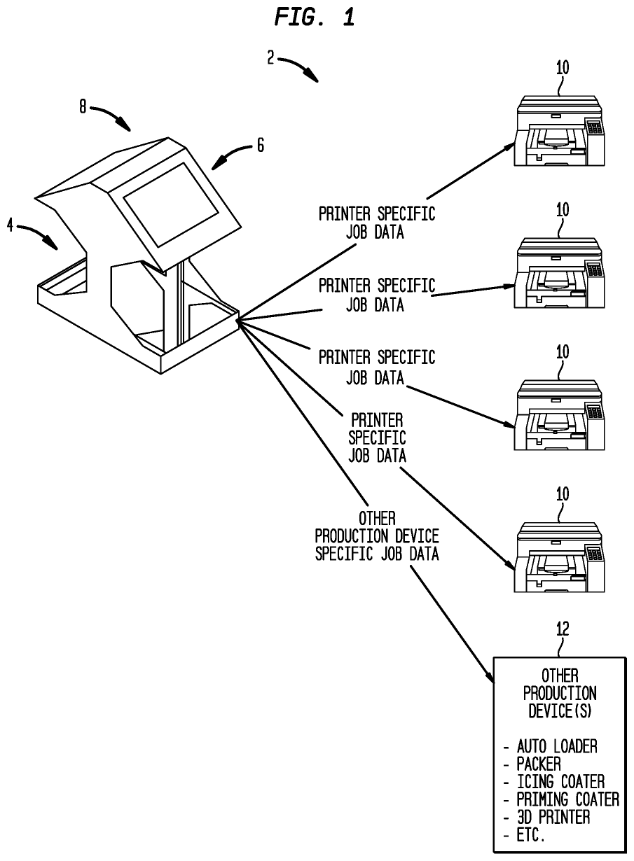

Turning now to the drawing figures, FIG. 1 illustrates a scanning and print control system 2 constructed in accordance with an example embodiment of the present disclosure. The scanning and print control system 2 captures specific information of 3D (three-dimensional) articles (such as edible food products) to be printed, and manages production scale job printing on the articles with full color images that may include text, graphics or combinations of text and graphics. Advantageously, the articles may be printed as individual units that have been processed to their final production size (e.g., a collection of individual cookies that may have irregular size and/or shape), with no post printing division or segmentation of a multi-unit medium (e.g., a sheet of conjoined articles formed with a standard print media size to facilitate printing) being required.

Example components of the scanning and print control system include a scanning camera system (scanner) 4 and a production controller 6. As described in more detail below, the scanner 4 is used to scan the articles to be printed and the scan images are processed by the production controller 6 to determine article positioning and height prior to printing. The production controller 6 is additionally used for print job run workflow control, including per-job color management, per-job image normalization using various device-specific and resource-specific calibration data, and on-the-fly RIPing (Raster Image Processing) to generate printer-specific job data. The scanner 4 and production controller 6 may be physically integrated together so as to provide an integrated scanner and production controller 8, as exemplified by FIG. 1. Alternatively, the scanner 4 and production controller 6 may be implemented as standalone devices that communicate with each other but are not otherwise integrated. In either case, the scanner 4 and production controller 6 functionality will be collectively referred to herein as a “scanner/production controller” 4/6 for ease of description.

The scanning and print control system 2 may further include one or more one or more full color printers 10 that receive RIPed printer specific job data from the production controller via suitable data communication pathways, such as a wired or wireless network, dedicated point-to-point communication channels (e.g, direct cable connections), or otherwise.

Additional production devices 12 may likewise be provided as part of the scanning and print control system 2. These may include an auto loader that feeds articles to be printed to one or more of the printers 10, a packer that packages articles for shipment following printing, an icing coater and a primer coater for use when printing food products that receive icing and/or primer prior to printing, and a 3D printer that fabricates three-dimensional articles. Each of these production devices 12 may be controlled by production device specific job data received from the production controller 6.

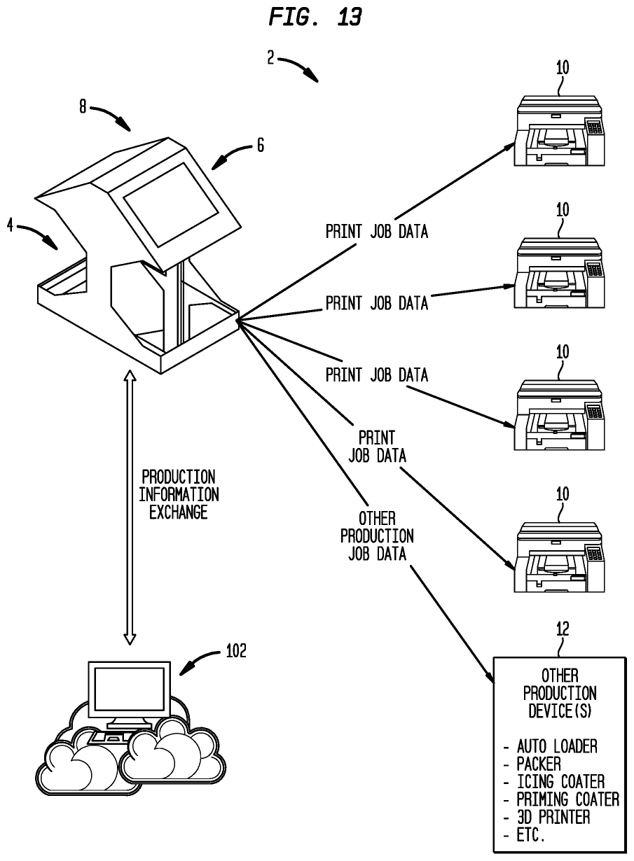

In an embodiment, the scanning and print control system 2 may operate independently to manage all aspects of printed article production—from blank article acquisition to print job request origination to final printing, packaging and shipment. Typically, however, the scanning and print control system 2 will operate in cooperation with another device or system, such as a global print manager (described below in connection with FIGS. 13-19) that performs various operations needed to support print job request creation, provides a database or other information storage resource for maintaining, among other things, print job request information and associated print job template data, and assigns print job requests (a.k.a., orders) for fulfillment as production print runs by one or more instances of the scanning and print control system. As will be described below in connection with FIGS. 13-19, print job request information may include job-related specifications such as job ID, customer identification, recipient identification, quantity, price, payment method, delivery method, etc. Print job template data may include, for each print job request, one or more job templates that each include (1) an identification of the type of article to be printed along with an article image/template, (2) one or more user-selected images and overlays to be printed on the article, and (3) a set of job template metadata specifying how the images and overlays are to be assembled for printing.

Note that there may be operational scenarios of the global print manager where a single production print run involves multiple articles of the same type being printed with different images and/or multiple articles of different type being printed with the same or different images. In that case, a single production print run may constitute several print job requests (e.g., one for each article type), with each print job request constituting one or more print job templates (e.g., one for each image combination to be printed on the job request article type), in order to accommodate all of the print run requirements.

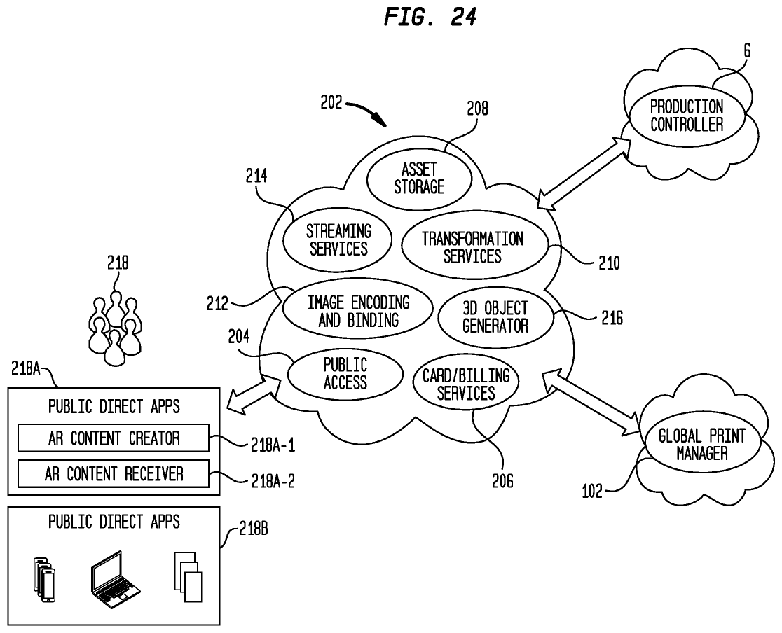

In addition to the scanning and print control system 2 operating in conjunction with the global print manager of FIGS. 13-19, the global print manager may itself operate in conjunction with other devices and systems. As will be discussed below in connection with FIGS. 24-26, one such device or system is an augmented reality (AR) controller that may be used to provide an enhanced printed article experience that includes AR effects.

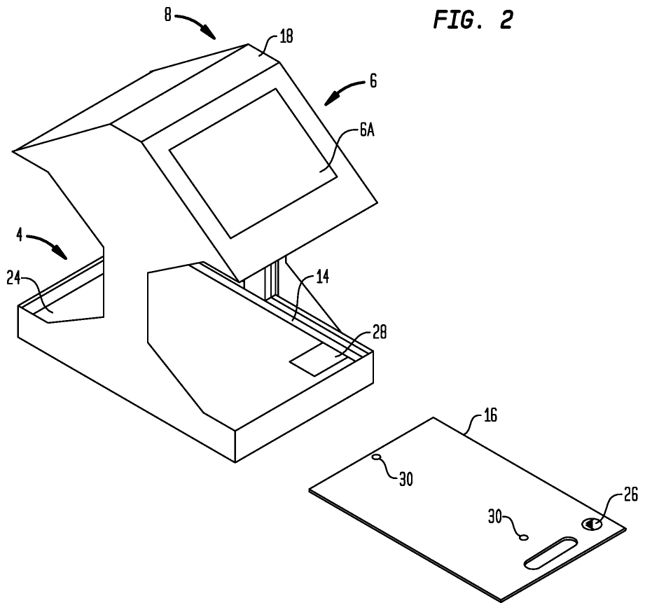

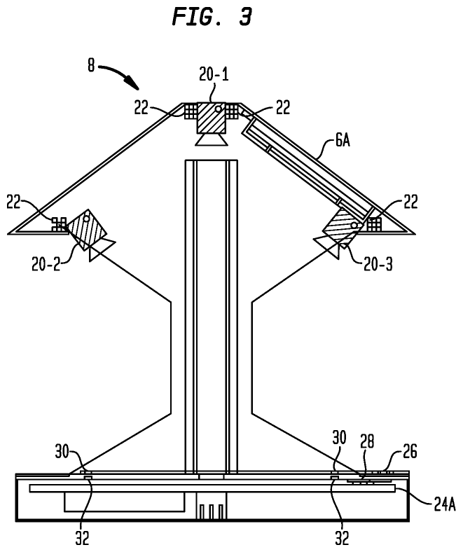

Turning now to FIGS. 2 and 3, the scanner/production controller 4/6 of the scanning and print control system 2 may include a lower tray holder 14 that receives removable article carrier trays 16, and an upper hood 18 that mounts the production controller 6 and a set of integrated or detached cameras 20 (shown as 20-1, 20-2 and 20-3). In the illustrated embodiment, the production controller 6 is implemented as a programmed touch PC control system having a touch screen 6A that is accessible on the top side of the hood 18 to provide a user interface. Alternative embodiments of the production controller 6 may utilize other types of data processing processing devices or systems, including but not limited to a computer workstation or personal computer equipped with a standard keyboard or keypad, a pointer device and a display monitor, a portable tablet device, an embedded controller with an associated input/output terminal, etc.

The cameras 20 of the scanner/production controller 4/6 are mounted to the underside of the hood 18, and may include a central camera 20-1, a first side camera 20-2 and a second side camera 20-3. Each camera 20 may be mounted on camera rails 22 for adjusting camera position in one or more desired directions. In some embodiments, the camera rails 22 might only be used for one-time camera setup purposes to establish camera positions that will remain fixed during subsequent operations. In other embodiments, the camera rails 22 might be used for dynamic camera positioning to accommodate different print job requests or when fulfilling a single large print job request. For example, if the cameras 20 cannot scan all of the articles to be printed from a single vantage point, the cameras could be moved to capture several scan images that may be stitched together to generate a complete article scanning image.

The cameras 20 operate in conjunction with display technology 24 provided in the tray holder to define the specific location, size, and shape of the articles to be printed. Specifically, the central camera 20-1 is used to determine the x-y axis location and rotational orientation of each article (hereinafter referred to as the article's “position”), and the side cameras 20-2 and 20-3 are used to determine the z-axis thickness of each article (hereinafter referred to as the article's “height” or “height profile”). The display technology 24 provided in the tray holder may include an upwardly-facing video monitor 24A providing back light control. As described in more detail below, the video monitor 24A may be operated in several modes, including (1) an article-placement mode to indicate where items are to be placed for printing, (2) a fine position-determining mode to assist camera 1 detect the position of each article with high accuracy, and (3) a height-determining mode to assist side camera 20-2 and side camera 20-3 determine the height of each article 38.

The print run production workflow operations performed by the scanning and print control system 2 may begin with calling up a print job request to be fulfilled and pulling the associated print job request information and job template data. If the scanning and print control system 2 operates in conjunction with a global print manager (e.g., as per FIGS. 13-19), the print job request information and associated print job template data may be accessed from the global print manager's database or other storage resource. This information and data may be downloaded by the production controller 6 when the print job request is called up (or any time thereafter). Alternatively, if the scanning and print control system 2 operates independently of a global print manager, the print job request information and associated print job template data may already be available in a database or other storage resource managed by the production controller 6.

Once the print job request has been called up at the production controller 6 and the relevant print job information and job template data has been pulled, an article carrier tray 16 may be chosen and inserted into the tray carrier 14. This may be carried out by a production worker or in an automated manner. Each article carrier tray 16 may include an RFID chip 26 situated at a predetermined location on the tray (e.g., in a specified corner). The tray RFID chip 26 is programmed with a unique tray identifier that distinguishes that tray from other trays. The tray carrier 14 may include an RFID reader 28 that is positioned to read the tray RFID chip 26 when the article carrier tray 16 is inserted. The tray identifier allows the production controller 6 to assign the inserted article carrier tray 16 to the current print job request, and to detect when the article carrier tray is inserted into a particular printer 10 of the scanning and print control system 2.

Although an article carrier tray 16 may be the only tray assigned to a particular production print run, this is not always the case. Any given production print run may require either multiple article carrier trays 16, or that a single article carrier tray be used multiple times. An article carrier tray 16 may be likened to a paper page of a conventional print job. Both are of finite size and the production print run may call for more information to be printed than can fit on a single “page.” For any given article carrier tray 16, only a given number of articles will fit onto the tray at one time, depending on the size and shape of the articles. If the production print run requires more printed articles than can be placed on a single article carrier tray 16, either that tray may be reused for printing additional “pages” of the same print run or additional trays may be assigned to the print run and used for printing the additional “pages.” If the scanning and print control system utilizes multiple printers 10, some or all of the “pages” for a given production print run request may be printed in parallel.

Each time an article carrier tray 16 is used for printing a “page” that includes a plurality of articles that can fit on a single article carrier tray, a tray page setup operation will be performed that establishes the tray position of each article to be printed with images specified by the job template(s) associated with the print job request(s) that comprise the production print run, thereby defining one or more tray page print items. The tray position of each print item may based on a local coordinate system associated with the article carrier tray 16. This information may be referred to as tray page setup data. The tray page setup data may be stored in association with existing print job request assets. For redundancy purposes, the tray page setup data may be stored locally by the scanner/production controller 4/6, with a copy being maintained by a remote system or device, such as the global print manager of FIGS. 13-19. In an embodiment, the stored tray page setup data may be indexed by the article tray identifier.

The article positions that comprise the tray page setup data may be manually established by a production operator using the production controller's touch screen 6A (or other user interface). Alternatively, the article positions may be calculated automatically by the production controller 6 based on its knowledge of the article carrier tray 16 and the print job template data. Using this knowledge, the production controller 16 may invoke a “best fit” type of algorithm to determine how many of the articles to be printed can fit on the tray page during the production print run, and where the articles need to be placed to ensure they all fit. The algorithm may take into account factors such as tray size, article type, number of articles to be printed, etc., so as to optimize available tray space and ensure that the least number of print job “pages” are needed to complete the job request. The tray page setup data may further include article height profile information corresponding to the type of article being printed. In an alternate embodiment, the calculations used to generate the tray page setup data could be performed by a system or device other than the production controller 6, such as the global print manager of FIGS. 13-19.

Once the tray page setup data has been generated, the article carrier tray 16 may be loaded with the articles to be printed, with placement assistance from the scanner/production controller 4/6. The scanner/production controller 4/6 may then scan the article carrier tray 16 to verify the exact position of each article, together with its height profile. This fine-position and height profile information may be used to make necessary adjustments to the tray page setup data so that for each print item, the print item image(s) will be precisely aligned and oriented relative to the corresponding print item article.

To aid proper positioning in the tray carrier 14 during article placement and scanning, each article carrier tray 16 may be provided with tray registration magnets 30 that interact with tray carrier magnets 32 providing fixed-position datum points. The magnetic interactions between the tray registration magnets 30 and tray carrier magnets 32 maintain the article carrier tray 16 in a predefined tray registration position to ensure the accuracy of the position determining operations performed by the scanner/production controller 4/6. As described in more detail below in connection with FIGS. 11A-11B, the printers 10 may also have tray registration magnets to ensure that accurate tray positioning is established and maintained while printing. A slot or other opening 34 may be provided at one end of the article carrier tray 16 to assist in inserting and removing the tray in the tray carrier 14 (and also in a printer 10 during print operations).

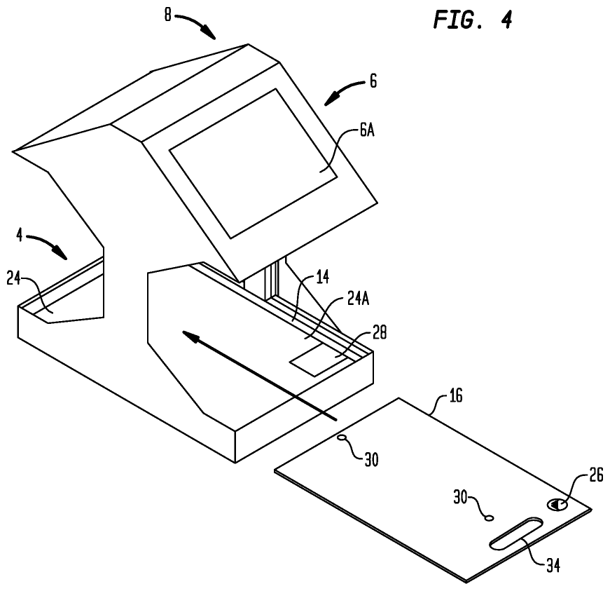

FIGS. 4-6 illustrate an example rough-positioning operation that may be performed by the scanner/production controller to guide the placement of articles to be printed on an article carrier tray 16.

FIG. 4 depicts a first stage of the rough-positioning operation in which an article carrier tray 16 is selected and inserted into the tray carrier 14 of the scanner/production controller 4/6. The article carrier tray 16 will be secured by the tray registration and tray carrier magnets 30/32 in the predefined tray registration position, with the tray RFID chip 26 being situated above the tray holder's RFID reader 28. As previously noted, the production controller 6 may identify the article carrier tray 16 by reading the tray's RFID chip, and assign the tray to the current production print run. The production controller 6 may now generate the tray page setup data that establishes the tray positions of the articles that will be printed with particular images (i.e., the print items).

For example, if a production print run requires two articles of different type to be printed with the same (or different) images based on two print job requests with one print job template each, the tray page setup data could have the following format:
Tray ID=tray_id_xxxyyy:
Article 1: x pos.=x1, y pos.=y1; rot. angle=r1; print job request=job_request_id_1; print job template=job_template_id_1;
Article 2: x pos.=x2, y pos.=y2; rot. angle=r2; print job request=job_request_id_2; print job template=job_template_id_1.

Similarly, if a production print run requires two articles of the same type to be printed with different images based on one print job request with two print job templates (one for each image), the tray page setup data could have the following format:
Tray ID=tray_id_xxxyyy:
Article 1: x pos.=x1, y pos.=y1; rot. angle=r1; print job request=job_request_id_1; print job template=job_template_id_1;
Article 2: x pos.=x2, y pos.=y2; rot. angle=r2; print job request=job_request_id_1; print job template=job_template_id_2.

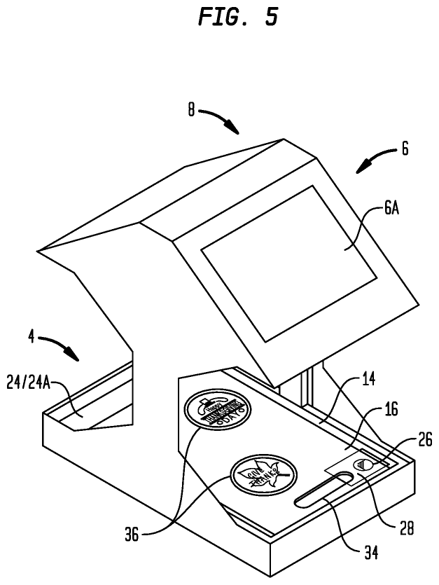

FIG. 5 depicts a second stage of the rough-positioning operation in which the production controller places the tray holder video monitor 24A in its article-placement mode. In this mode, the video monitor 24A displays article placement images 36 using the tray page setup data to identify where each article is to be placed for one “page” of the print job request. It will be observed that the article placement images 36 displayed by the video monitor are visible through the article carrier tray 16. This may be accomplished by fabricating the tray from a suitable transparent or translucent material.

To ensure that the correct article types are placed at the correct article locations, the article placement images 36 may depict the actual print items, including the articles themselves together with the user-specified images and overlays that will be printed on the articles, in particular orientations, as all defined by the job template assigned to each article specified in the tray page setup data. In the illustrated example of FIG. 5, the print job request consists of two cookies of identical type, one to be printed according to a first job template with a first Thanksgiving holiday image, and the other to be printed according to a second job template with a second Thanksgiving holiday image. If the production controller 6 includes a touch screen 6A or other visual output device, the article placement images shown in FIG. 5 may be displayed on the output device for soft proofing or other verification purposes.

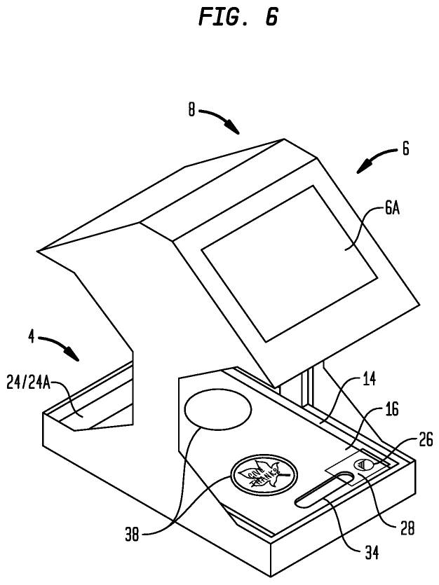

FIG. 6 depicts a third stage of the rough-positioning operation in which articles 38 have been placed onto the article carrier tray 16 at the locations indicated by the article placement images 36 displayed in FIG. 5 by the video monitor 24A (shown in FIG. 3). The latter are of course no longer visible insofar as they are covered by the articles 38.

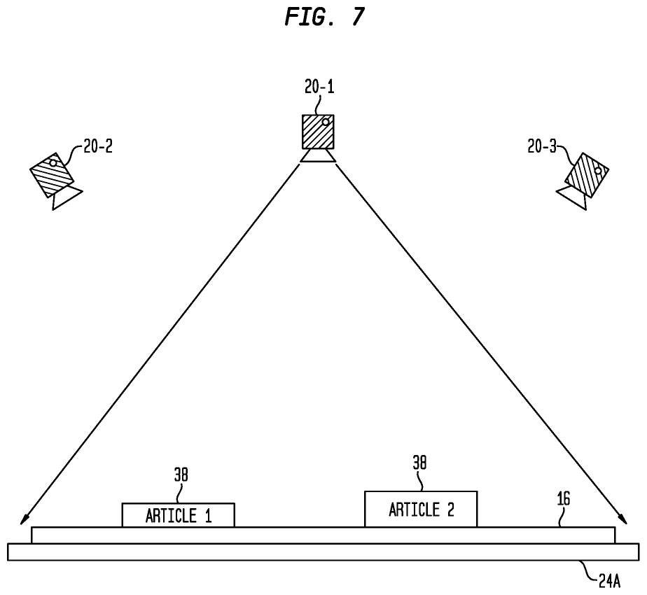

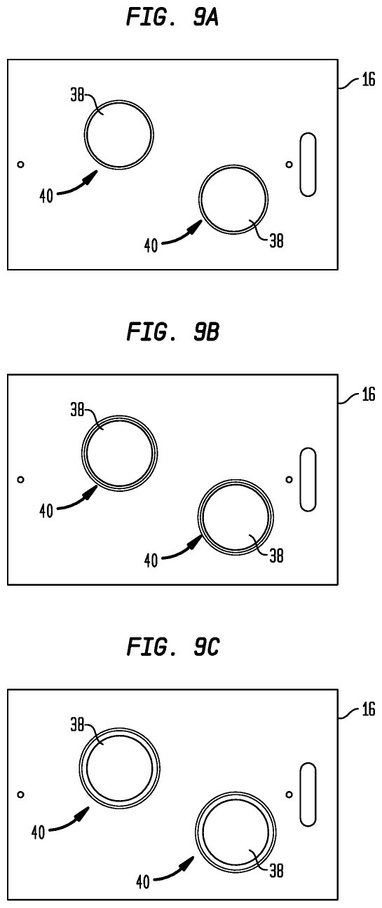

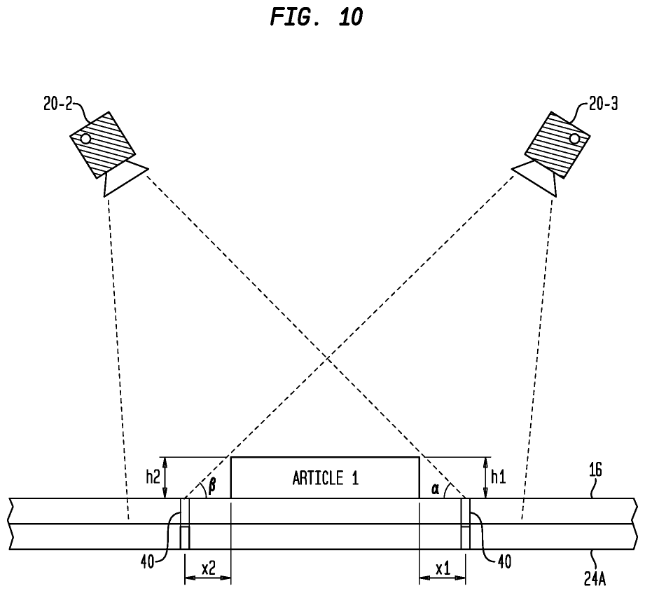

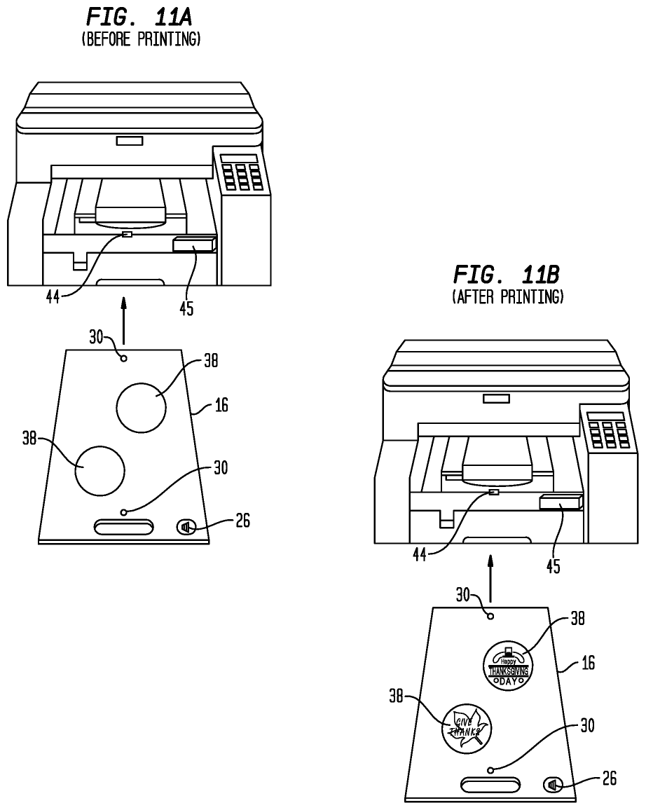

FIGS. 7-10 illustrate the fine-positioning and height-determining operations that may be performed by the scanner/production controller 4/6 to fine-tune the tray page setup data and to verify the height profile characteristics of the articles 38 to be printed.

FIG. 7 depicts a fine-positioning operation in which the actual position of each article 38 placed on the article carrier tray 16 is precisely determined. In many cases, the articles 38 will have been placed fairly accurately on the article carrier tray 16 as a result of the rough positioning operations of FIGS. 4-6, but the positioning may not be exact and may have a small degree of error that needs to be ascertained so that printing adjustments can be made. These positioning errors may result in the articles 38 being variably positioned on the article carrier tray 16 at positions that can vary along a length and/or width of the tray. In addition, there may be situations where the rough positioning operations are bypassed for job performance efficiency reasons. For example, the print job request may be a large multi-page batch job in which numerous articles of the same type are printed with the same image on multiple article carrier tray “pages,” such that performing the rough positioning operations of FIGS. 4-6 could delay production. In such cases, the fine positioning operation of FIG. 7 may represent the sole article position-determining operation performed by the scanner/production controller 4/6, with the generation of tray page setup data being deferred until the fine positioning operation has been completed.

To initiate the fine-positioning operation, the production controller 6 places the video monitor 24A in its fine position-determining mode. In this mode, the video monitor 24A may display diffuse backlighting or the like emanating from below the articles 38 situated on the article carrier tray 16. This backlighting provides the contrast needed by the central camera 20-1 to detect all article edges. Using computer vision techniques, the production controller 6 can determine the x-y location of each article 38 with high accuracy, and use this information to update, as necessary, the previously-described tray page setup data. The production controller 6 may likewise determine the rotational orientation of each article 38. Although rotational orientation may not be needed for articles that are perfectly round, many articles to be printed will not be round, such as a Christmas tree-shaped cookie, etc. The rotational information determined by the fine-positioning operation may be used to further update the tray page setup data. The updated article position information (i.e., the x-y location and rotational orientation of each article 38) determined by the fine-positioning operation will be used by the production controller 6 to make any necessary alignment adjustments between the print job template images and the articles to be printed when RIPing the printer specific job data (as per the updated tray page setup data). This will ensure that the print images will be laid down at the precise locations and orientations specified by the updated tray page setup data. In an embodiment, the fine-positioning operation could also be used to verify the actual dimensions of each article 38, which define its size and shape. If an article's actual dimensions deviate from what is expected for the article type specified in the print job template, the actual dimensions could be used to scale the images and overlays to be printed.

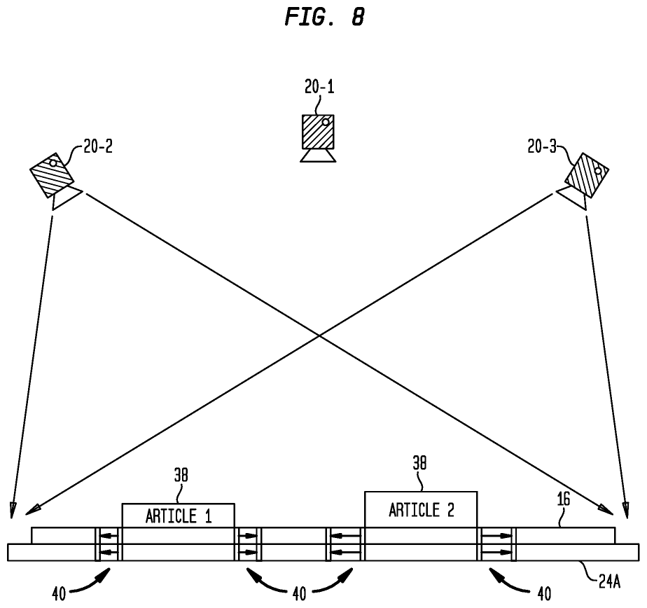

FIGS. 8-10 depict an article height-determining operation in which the height profile of each article placed on an article carrier tray 16 (as per FIG. 6) is precisely calculated. To initiate the height-determining operation, the production controller 6 places the video monitor 24A in its height-determining mode. In this mode, the video monitor 24A may cast a light outline 40 (e.g, ring) around each article 38 whose shape conforms to the outline of the article (for any given article shape). Alternatively, the video monitor 24A could project a silhouette of the article 38 from below the article. By way of example only, FIGS. 8-10 illustrate the use of light outlines. The light outline 40 (or silhouette) begins at the edge of the article 38 and is then increased in size (expanded) until both of side camera 20-2 and side camera 20-3 detect the entire light outline (or silhouette). Initially, the side cameras 20-2 and 20-3 will only see the portions of the light outline 40 (or silhouette) that lie on the near side of the article 38 that is most proximate to the camera. As the light outline 40 (or silhouette) increases in size, the side cameras 20-2 and 20-3 will detect more and more of the outline (or silhouette). Eventually, each side camera 20-2 and 20-3 will detect the portion of the light outline 4 (or silhouette) that emerges into the camera's field of view on the far side of the article that is most distal to the camera. The height of that side of the article 38 may then be calculated based on the distance between the light outline 40 (or silhouette) and the actual article outline (i.e., edge), and the angle of the side camera 20-2 or 20-3 relative to that side of the article.

FIG. 10 is illustrative of an embodiment that uses a light outline 40 to determine the height of a single article 38. Side camera 20-2 may be used to detect the height “h1” of the right side of article 38 and side camera 20-3 may be used to detect the height “h2” of the left side of article 38. If side camera 20-2 first sees the entire light outline 40 when the outline is at a distance of “x1” from the right side of article 38 at a viewing angle α, the production controller 6 may calculate the height “h1” using the formula: h1=x1*tan α. Similarly, if side camera 20-3 first sees the entire light outline 40 when the outline is at a distance of “x2” from the left side of article 38 at a viewing angle J, the production controller 6 may calculate the height “h2” using the formula: h2=x2*tan β. The article height profile is based on the height measurements obtained using side cameras 20-2 and 20-3, and may be represented in various ways, such as an average height, a maximum/minimum height, a height vs. x-y position gradient (i.e., field gradient), or otherwise.

The article height profile information determined by the scanner/production controller 4/6 may be stored in association with the updated tray page setup data. The production controller 6 may use the calculated article height profile information for the articles 38 to be printed to adjust the printer 10 assigned to run the print job. In particular, knowing each article's height profile allows appropriate print head height adjustments to be made in order to ensure high-quality imaging. The print head height adjustment parameters may be incorporated into the RIPed printer specific job data sent to the printer 10.

FIGS. 11A and 11B illustrate an example article printing operation in which one page of a print job request is printed using the article carrier tray 16 and the articles 38 shown in FIGS. 5-10. FIG. 11A depicts the articles 38 prior to printing. The articles 38 have been loaded onto the article carrier tray 16 in their correct positions and scanning has been performed to determine the precise position and height profile of each article, and to update the tray page setup data to make any necessary corrections thereto. Using a manual or automated operation, the article carrier tray 16 may be conveyed from the scanner/production controller 4/6 and inserted into the printer 10. The printer 10 may include a tray carrier 42 equipped with printer magnets 44 (only one of which is shown in FIGS. 11A and 11B) for registering the article carrier tray 16 in the correct position for printing by magnetically engaging the tray registration magnets 30. The printer 10 may also include an RFID reader 45 situated to read the RFID chip 26 on the article carrier tray 16 when the latter is inserted. The printer RFID reader 45 may read the tray identifier and confirm to the production controller 6 that this particular printer 10 is ready to print this particular article carrier tray 16. Based on the tray identifier, the production controller 6 will load the relevant tray page setup data and assemble the print job template data for each print item. The production controller 6 may then RIP the images to be printed onto the articles 38 at the corresponding positions (and orientations) of the articles on the article carrier tray 16. Following RIPing, the production controller 6 may send the RIPed printer specific job data to the printer 10 to initiate printing of the images. The images will be printed directly onto the articles 38 using the printer's printhead, which may be an ink-jet or other non-contact printhead, with the printhead being controlled according to the determined position, height and orientation of the articles so as to faithfully reproduce the images at a precisely defined location and orientation on each article. Following printing, the article carrier tray 16 may be removed from the printer 10 using a manual or automated operation. As shown in FIG. 11B, the articles have been correctly printed with the images specified by the print job request. The printed articles 38 may now be removed from the article carrier tray 16, inspected for quality, packaged and shipped to the recipient specified by print job request.

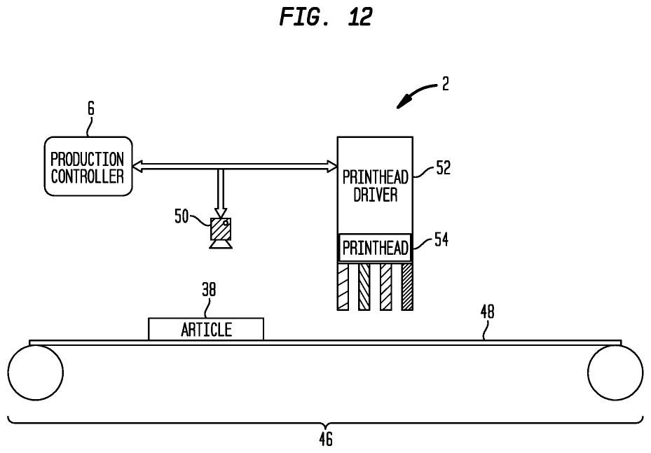

Turning now to FIG. 12, a modified embodiment of the scanning and print control system 2 is shown for use in high-speed printing environments. In this embodiment, a plurality of articles 38 to be printed (only one is shown) are placed on an assembly line conveyor 46 representing an article carrier that includes a moving belt or parchment paper 48. The plurality of articles 38 may be have dimensions that differ from each other and may be variably positioned on the conveyor 46 at positions that can vary along a length and/or width of the moving belt or parchment paper 48. The production controller 6 operates in conjunction with a scanning system 50 to manage production scale printing by a full color printhead driver 52 that drives a printhead 54 equipped to lay down images on the articles 38 as they pass underneath. In this embodiment, the previously-described rough-positioning operation may be eliminated. Article position (including orientation) and height, as well as article size and shape, may be determined solely by the scanning system 50, which may be implemented using any suitable sensing technology, such as a camera or other image capture device, an optical reader, a laser or LED scanner, etc., as each article 38 passes underneath, capturing line-by-line article image slices starting at the leading edge of the article and continuing to the trailing edge thereof. Each article image slice captured by the scanning system 50 is input to the production controller 6. The production controller 6 may utilize the speed of the conveyor 46 (which may be provided by an encoder) to calculate when the article segment corresponding to the article image slice passes under the printhead 54. As it does, the production controller 6 outputs a corresponding slice of the print job image to the printhead driver 52, which drives the printhead 54 to paint the slice onto the article 38. In this way, the print job image may be painted line by line onto multiple articles 38 at high speed, and which may be more or less randomly positioned on the conveyor 46 along a length and/or width thereof.

As previously discussed, the scanning and print control system of FIG. 1 may operate in conjunction with a global print manager. FIG. 13 illustrates one embodiment 102 of a global print manager. The global print manager 102 may be used to control multiple instances of the scanning and print control system 2, offload production workflow tasks therefrom, provide print job storage assets, and offer additional functionality to support large scale article printing operations.

The global print manager 102 may be implemented using any suitable computer server technology, including but not limited to a network-accessible server or server cluster provisioned with dedicated hardware and software resources (e.g., data processing devices or systems, storage devices or systems, networks, networking components, software applications, etc.) or with virtualized hardware and software resources (e.g., provided as cloud computing services).

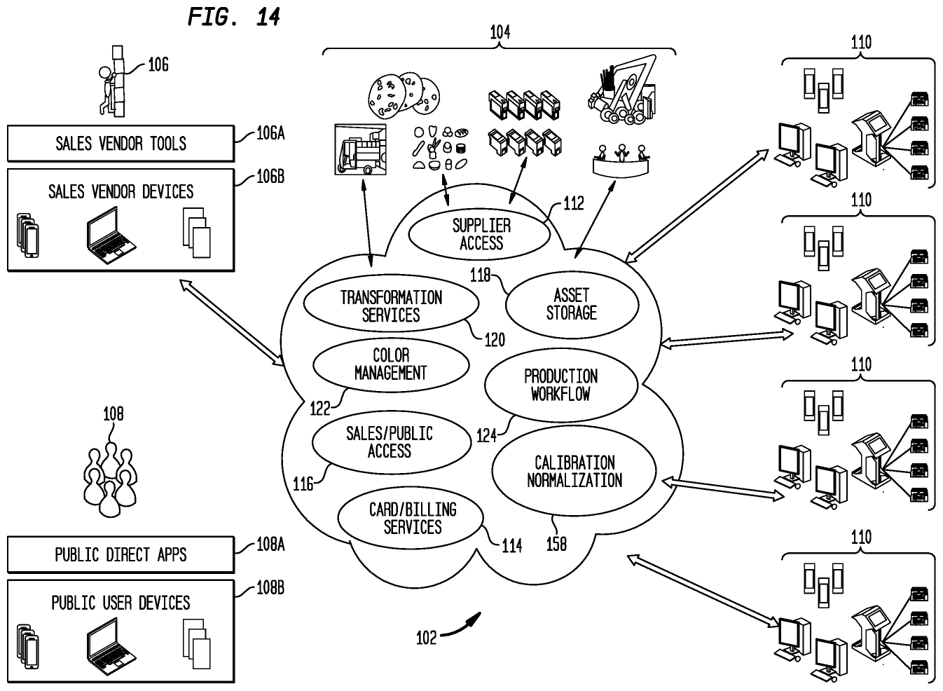

FIG. 14 illustrates an example embodiment of the global print manager 102 and its operational environment. In this embodiment, the global print manager 102 interacts with various client entities to support highly scalable print management operations. For example, the global print manager 102 may interact with suppliers 104 involved in the production and distribution of raw materials and finished goods. The global print manager 102 may also interact with printed article sales vendors 106 who wish to offer printed articles to customers. The global print manager 102 may likewise interact with members of the general public 108 who wish to create printed articles for personal (or commercial) use. Finally, the global print manager may 104 interact with one or more production companies 110 that produce printed articles, and which may implement instances of the scanning and print control system 2 of FIGS. 1-12.

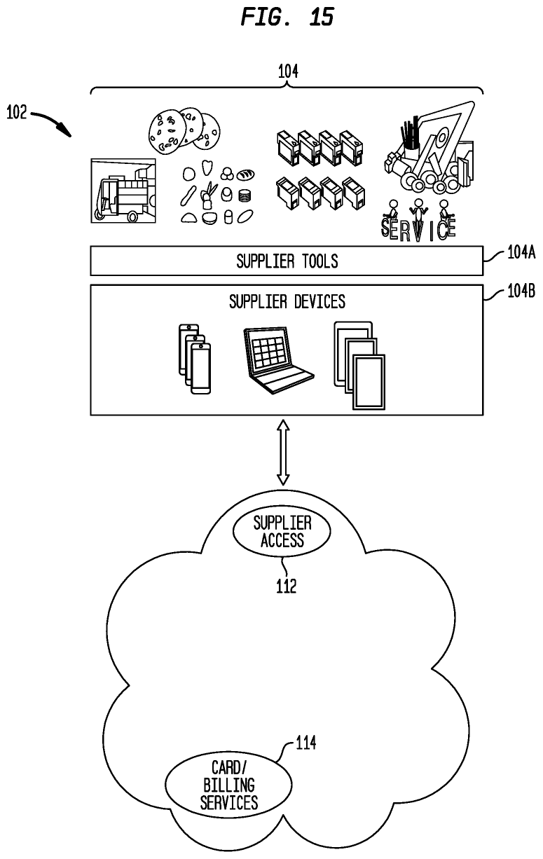

FIG. 15 illustrates example global print manager functionality that may be provided for suppliers 104. In an embodiment, suppliers 104 served by the global print manager may include article suppliers that provide blank articles to be printed (e.g., baked goods, icings, packaging, etc.), printing ink suppliers that provide specialized (e.g., edible) printing inks, graphic design suppliers that provide artwork images to be printed, and common carriers involved in the transportation and delivery of raw materials and finished goods. All suppliers 104 may be pre-qualified in order to ensure that requisite supplier capabilities and standards are met. For raw material suppliers, calibration metrics may be used to ensure repeatability of all final products. For example, in the case of article suppliers, the calibration metrics may require that all articles conform to strict article size and shape specifications. For ink suppliers, the calibration metrics may require that all inks conform to color and ingredient specifications. For artwork suppliers, calibration metrics may require consistency of artwork image resolution, size, file type and color profile. For common carrier suppliers, calibration metrics may require demonstrable capability to satisfy applicable delivery schedules.

Suppliers 104 may utilize one or more supplier tools 104A (e.g., mobile applications, web applications, etc.) running on supplier devices 104B that interface with the global print manager 102 via a supplier access portal 112. The supplier access portal 112 may be used for all production-related communications to and from suppliers 104, ensuring that production flow control is managed effectively and printed article quality is maintained. Suppliers 104 may also access card/billing services 114 (e.g., via the supplier access portal 112) in order to submit invoices for goods sold and services rendered, or perform other accounting tasks.

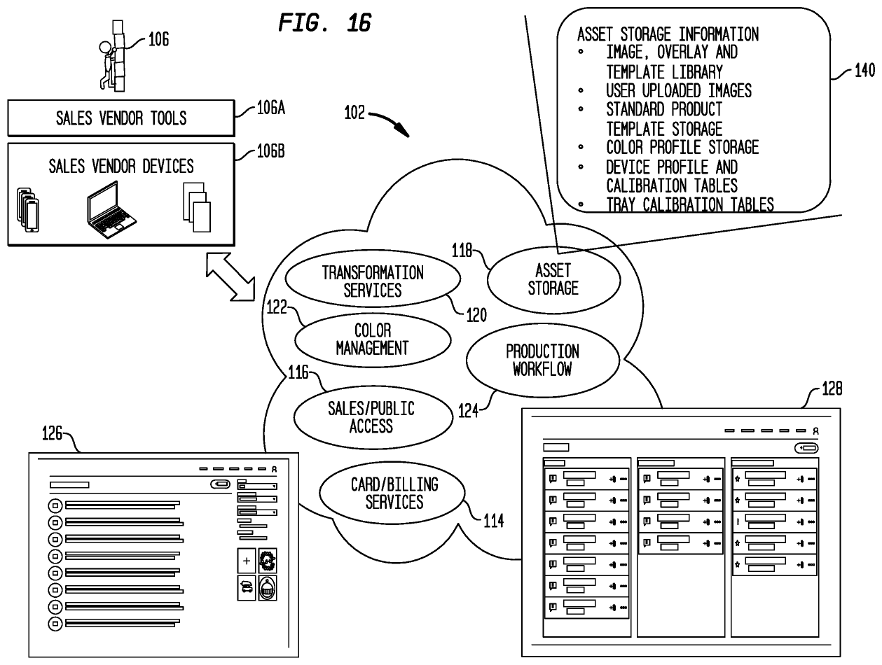

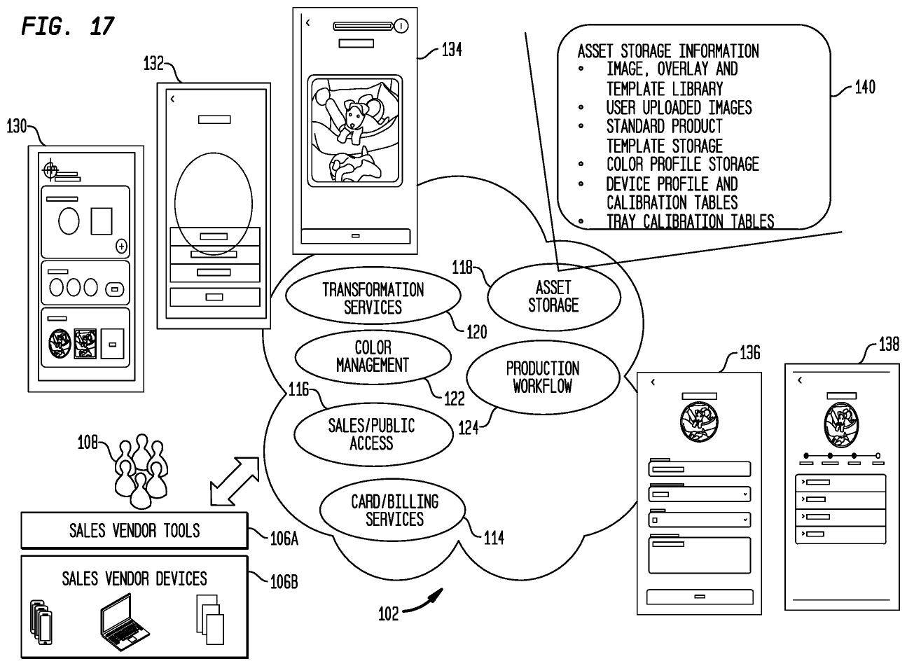

FIGS. 16 and 17 illustrate example global print manager functionality that may be respectively provided for sales vendors 106 and members of the general public 108. This functionality may include a sales/public access portal 116 together with various back-end service components that assist in the creation, management and tracking of job requests for printed articles. The sales/public access portal 116 may be used for all production-related communications to and from sales entities 106 and members of the public 108. The back-end service components may include an asset storage component 118, a transformation services component 120, a color management component 122, and a production workflow component 124.

FIG. 16 depicts example sales tools 106A (e.g., mobile applications, web applications, etc.) that may run as global print manager client applications on sales vendor devices 106B used by sales vendors 106. These sales tools may access the sales side of the sales/public access portal 116 in order to originate print job requests, manage print run production, create and manage print job templates, article templates, and other resources, and to access various production metrics and information specific to print job requests in support of sales vendor operations. The sales tools 106A may also be used to access card/billing services 114 (e.g., via the sales/public access portal 116 or directly) in order to pay for print job requests and perform other accounting tasks.

The two boxes 126 and 128 shown in FIG. 16 depict example screen shots that may be generated as a result of interactions between the sales tools 106A and the sales side of the sales/public access portal 116. Although the screen shots 126 and 128 are specific to a web-based application, this is for purposes of illustration only. In the left-hand box 126 of FIG. 16, an example user interface is presented that allows users to select a print job request from a list of print job requests. Upon selection, detailed information about the print job request may be provided, including but not limited to the current status of the print job request, the author of the print job request, the production company assigned to handle the print job request, the print job request creation date and the print job request modification date (assuming edits were made subsequent to creation). In the right-hand box 128 of FIG. 16, an example user interface is presented that allows users to determine the status of multiple print job requests according to their current state of production. By way of the example, the print job request production states may be organized into a “To Do” category, an “In Progress” category, and an “In Production” category. In an embodiment, the print job request information provided in the two boxes of 126 and 128 FIG. 16 may be generated by querying the back-end asset storage 118 and production workflow components 124 of the global print manager 102.

Additional user interface images may be generated as a result of interactions between the global print manager 102 and the sales vendor tools 106A in order to support sales vendor operations, such as to (1) manage print job requests (additionally referred to as “orders”), (2) create and manage print images, article image/templates, and other resources, (3) access various production metrics and information specific to print job requests/orders), and (4) access the global print manager's card/billing services.

FIG. 17 depicts example public direct applications 108A (e.g., mobile applications, web applications, etc.) that may run as global print manager client applications on public user devices 108B used by members of the general public 108. The public direct applications 108A may be used to author new print job requests and to track those print job requests to completion. As in the case of the sales tools 106A, the public direct applications 108A may also be used to access card/billing services 114 (e.g., via the sales/public access portal 116 or directly) in order to pay for job requests and perform other accounting tasks.

The five boxes 130, 132, 134, 136 and 138 in FIG. 17 depict example screen shots that may be generated as a result of interactions between the public direction applications and the public side of the sales/public access portal. Although the screen shots are specific to a mobile application, this is for purposes of illustration only. In the far left-hand box 130 of FIG. 17, an example user interface is presented that allows users to start a new print job request order, identify print job requests that are currently in progress, and identify print job requests that have been completed. In the second-from-left-hand box 132 of FIG. 17, an example user interface is presented that allows users to select an image for use in a print job request. In the third-from-left-hand box 134 of FIG. 17, an example user interface is presented that allows users to place an image on an article when creating a print job request. In the second-from-right-hand box 136 of FIG. 17, and example user interface is presented that allows users to fill in print job request order details. In the far right-hand box 138 of FIG. 17, an example user interface is presented that allows users to view status information about print job requests that are currently in progress. In an embodiment, the print job request information provided in the five boxes 130, 132, 134, 136 and 138 of FIG. 17 may be generated by querying the back-end asset storage 118 and production workflow components 124 of the global print manager 102.

Additional user interface images may be generated as a result of interactions between the global print manager 102 and the public access tools 108A in order to support public user operations, such as to (1) originate print job requests, (2) track print job requests, and (3) access the global print manager's card/billing services.

As previously noted, the global print manager 102 may provide various back-end server components that assist users in creating and managing job requests for printed article. Examples of these server components, which include asset storage 118, transformation services 120, color management 122 and production workflow 124, will now be described with continuing reference to FIGS. 16 and 17.

The asset storage component 118 of the global print manager 102 may represent one or more databases or other data storage resources that provide an application-wide repository for print production assets, such as print job request information and associated print job template data. As previously mentioned, the print job request information may include job-related specifications such as job ID, customer identification, recipient identification, quantity, price, payment method, delivery method, etc. Print job template data may include, for each print job request, one or more job templates that each include (1) an identification of the type of article to be printed and an associated article image/template, (2) one or more user-selected images and overlays to be printed on the article, and (3) a set of metadata specifying how the images and overlays are to be assembled for printing. The asset storage 118 may therefore maintain a library of print job request information, print job template data, article type data, image data, and template metadata. Other print production assets maintained by the asset storage 118 may include color profile data, device profile data, and calibration/normalization data for article carrier trays, printers, scanners, blank articles, and job templates. This is depicted in the upper right-hand box 140 of FIGS. 16 and 17.

The transformation services component 120 of the global print manager 102 supports the transformation of images and overlays used for print job requests. Example transformation services may include a file-conversion operation that transforms templates, layered images and image overlays from a format that does not support transparency (e.g., JPEG, GIF, etc.) into a format that does support transparency (e.g., PNG, SVG, PDF, etc.). The file-conversion operation may be performed when a template, image or image overlay is first uploaded to the global print manager 102, when the asset is first used in a print job request, or at any other appropriate time. Additional transformation service operations may include positioning, resizing and orienting user-selected layered images and image overlays. These operations may be performed during the creation of a print job request. The transformation services component 120 may also be used to convert full-scale images into thumbnail images that can be displayed to users for quick reference when searching for images in the asset storage 118.

The color management component 122 of the global print manager 102 handles color profile conversion and normalization of job templates images and overlays, either when they are first uploaded to the system, or otherwise. For example, such images and overlays may be converted from their native color space (e.g., sRGB) to an absolute color space (e.g., CIELAB or CIEXYZ). This allows the global print manager 102 to standardize color profiles to ensure a uniform reproduction regardless of which print company production system is used for article printing. It also gives users the power to build their own printed articles to their own specifications. In an embodiment, the color management component 122 may support the adjustment and management of image color during the creation of print job requests.

The production workflow component 124 of the global print manager 102 handles all aspects of print job request origination and production, including print job creation, storage, assignment and distribution to production companies, and tracking of print job production status.

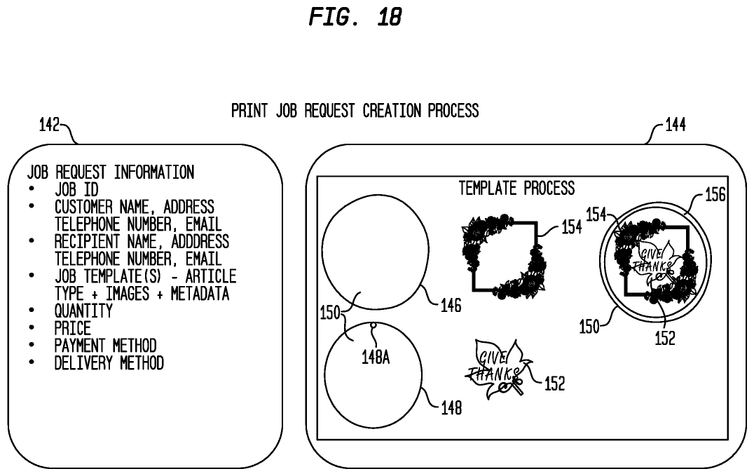

FIG. 18 illustrates example operations that may be performed by the production workflow component 124 to support the creation of new print job requests by users. Initially, a user, such a member of the public 108 or a sales vendor 106, may access the sales/public access portal 116 via their client application 108A or 106A, and thereafter start a new print job request session. In an embodiment, a user interface such as the one shown in the far left-hand box 130 of FIG. 17 may be presented for this purpose. Selecting the “Start a New Order” option results in the global print manager 102 starting a new print job request session. The production workflow manager 124 generates a unique job ID and initializes a new job request information object 142 for organizing the job request assets to be created by the user. As shown in the left-hand box of FIG. 18, the fields of the job request information object 142 may include:
1. Job ID
2. Customer name, address, telephone number, email address
3. Recipient name, address, telephone number, email address
4. Job Template(s)—Article type+Images+Metadata
5. Quantity
6. Price
7. Payment Method
8. Delivery Method

As noted above, the job ID of field 1 may be generated automatically by the global print manager 102. The job information of fields 2-3 and 5-8 may be specified via user text entry. In an embodiment, a user interface such as the one shown in the second-from-right-hand box 132 of FIG. 17 may be presented for this purpose. The article type, images and metadata information of field 4 may be created via the print job template process now to be described. The goal of the template process is to create a print job template that organizes all of the various print job images, overlays and metadata. In an embodiment, the template process may be built using the Microsoft .NET Core software development framework and .NET Core-compatible image manipulation libraries. Other development frameworks, tools and libraries may also be used.

The right-hand box of FIG. 18 illustrates an example print job template process 144 that may be used to populate the “Job Template(s)” field 4 of the job request information object. The template process 144 may begin with the user selecting an article type to be printed. In an embodiment, a user interface such as the one shown in the far left-hand box 130 of FIG. 17 may be used for this purpose. As shown in this box, images of different article types may be presented for selection. For a baked goods item, the article type might be a round cookie, a square cookie, a Christmas tree cookie, a Thanksgiving cookie, etc. In an embodiment, selecting the article type selects a corresponding image of the blank article from the asset storage 118 and inserts it into a print job build user interface that guides the user through the template process 144. In an embodiment, user interfaces such as those shown in the second-from-left-hand box 132 and the third-from-left-hand box 134 of FIG. 17 may be used for this purpose. The upper left-hand image 146 of the template process 144 of FIG. 18 depicts an example article blank in the form of a particular type of round cookie.

In an embodiment, the blank article image 146 is paired with a transparent clipping path image to define where one or more images selected by the user will be printed on the product. In the template process 144 of FIG. 18, an example clipping path image 148 is shown below the blank article image 146. This clipping path image 148 follows the outline of the article image 146, and is therefore circular in FIG. 18 because the article image depicts a round cookie. Although not shown in FIG. 18, the clipping path image 148 (which is invisible to the user) will be precisely centered over the article in order to guide the subsequent placement of user-selected images. In an embodiment, the clipping path image 148 may include a small alpha channel orientation mark 148A (also invisible to the user) that defines a reference rotational orientation of the article image 146 for rotationally aligning the article image and the user-selected image(s) placed thereon. The orientation mark 148A is used by the scanner/production controller 4/6 of FIGS. 1-12 to orient the article images displayed during the rough positioning operations of FIGS. 4-6, and to synchronize the job template image(s) with the article if the fine positioning operation of FIG. 7 detects that the article is rotationally skewed on the tray. The article image 146, together with its clipping path image 148 and orientation mark 148A, may be referred to as an article image/template 150. The article image/template 150 serves as a precursor to the final print job template (field 4 of box 142) created by the user. The clipping path image 148 logically defines the shape and size of the article image 146 and the orientation mark 148A logically defines its rotational orientation.

In an embodiment, the article image/template 150 may be used by a production system (e.g., the scanning and print control system 2 of FIGS. 1-12) for article positioning in order to generate tray page setup data, and to thereafter update the article positions in response to scan operations performed by the system's scanner/production controller 4/6.

In an embodiment, the global print manager 102 may support the ability of sales vendor client applications 106A to define custom articles by creating their own article templates (using the global print manager) or by uploading article templates created on a different system (e.g., a system running photo editing software). A sales vendor 106 could specify that such article templates are private and restricted to vendor use only, or they could optionally grant public access to the templates so that they may be used by other clients of the global print manager 102.

The user may now select an image to be printed on the article (layered image) and optionally an image to be overlaid on the layered image (overlay image). In an embodiment, a user interface such as the one shown in the second-from-left-hand box 132 of FIG. 17 may be presented for the image-selection operations. This user interface allows 132 users to select existing images maintained in the global print manager's asset storage 118, upload custom images from the user's device (e.g., 106B or 108B), or create an image (such as by taking a picture) and uploading it in cases where the user device has a camera. For all images uploaded by the user, the transformation services component 120 and color management component 122 of the global print manager 102 may operate behind the scenes to modify the image file format and/or color profile, as necessary, and store the transformed images in the asset storage 118. The template box 144 of FIG. 18 illustrates two example images 152 and 154 that a user might select for printing on the cookie article represented by the article image 146 in order to create a Thanksgiving holiday-themed product. The lower center image 152 is a layered image that includes a Thanksgiving holiday message that says “Give Thanks.” The upper center image 154 is an overlay image consisting of decorative box that will be combined with the layered image 152 to create a final composite image 156 to be printed.

Once the user has selected one or more images to be printed, the user may begin the process of transforming the images to specify how they will be sized and placed on the article. In an embodiment, a user interface such as the one shown in the third-from-left-hand box 134 of FIG. 17 may be presented for the image-to-article placement operations. By way of example, a drag-and-drop gesture could be used, with the user grabbing the images to be placed and moving them onto the article image/template 150.

As previously noted, the clipping path image 148 will guide the placement of the user-selected images 152/154. When a user-selected image 152 or 154 is dragged over the article image/template 150, the portions of the user image that lie within the clipping path area 148 will be visible while image portions outside the clipping path will be clipped and therefore not visible. The user-selected image 152 or 154 may thus be maneuvered until it is fully visible on top of the article image/template 150. Note that this positioning operation presupposes that the user-selected image will fit within the clipping path area 148. To address situations where the user-selected images 152/154 are too large (or too small), the template process 144 could provide a capability for users to manually scale their images. Alternatively, the template process 144 could support automatic scaling based on the size of the clipping path 148 associated with the article image/template 150 selected by the user. In an embodiment, the user could also be given the option of rotating the selected image(s) 152/154 to be placed on the article image/template 150.

The upper right hand image in the template process 144 of FIG. 18 depicts a composite multi-layer virtual image 156 of the printed article. This multi-layer virtual image 156 may be built layer by layer as the user selects and places images 152 and 154 onto the article image/template 150. In FIG. 18, the multi-layer virtual image 156 includes three layers. The article image/template 150 depicting the cookie to be printed resides in the lowermost layer. The layered “Give Thanks” image 152 resides in a middle layer situated above the lowermost layer. The overlay image 154 comprising the decorative box resides in an uppermost layer situated above the middle layer.

The user may save the print job template once they are satisfied with the results. In response to the save request, the production workflow component 124 of the global print manager 104 may create or update the “Job Template(s)” field 4 of the job request information object 142. In an embodiment, each print job template of the print job request object 142 may define the print job article type and its corresponding article template, the one or more user-selected images, and a set of job template metadata. The job template metadata defines all of the production information needed to assemble the user-selected images for printing onto the article. Such information may include (1) the x-y location of the images 152/154 on the article image/template 150 (e.g., relative to the orientation mark 148A), (2) the rotational position of the images on the article image/template (e.g., relative to the orientation mark), (3) the layering order of the images, and (4) the scale of the images (i.e., to ensure the images fit within the confines of the clipping path 148).

The fully completed job request information object 142 may now be stored in the asset storage 118 and made available for print job production. In an embodiment, the job request information object 118 may be indexed in a print job request database (e.g., by job ID) so that the information therein may be accessed for fast look-up prior to fetching the print job template data itself. In an embodiment, a job template grouping structure may be used to combine the separate resources that comprise each print job template (i.e., the article type, the user images and the job template metadata) into a single resource that is embedded or referenced within the “Template(s)” field 4 of the print job request information object 142. This reduces job request information object storage overhead and improves the efficiency of print job request distribution to print production companies 110 (see FIG. 14). In particular, at print production time, the job request information object 142 may be passed to a print production system (e.g., the scanning and print control system 2 of FIGS. 1-12) to advise the print production company 110 of the print job request. The print production company 110 may then access the job template grouping structure to pull in the required job template data as needed. It will be appreciated that the job request information object 142 will be relatively small in size as compared to the job template data, and thus may be transferred quickly to the print production company 110 in advance of the latter pulling in the much larger data set represented by the job template data grouping structure.

In an embodiment, the job template grouping structure may be implemented as serialized data in the form of a job template text string that lists the file system pathnames where the individual job template resources are maintained in the asset storage. By way of example, the job template text string could be a JSON or XML string that organizes the print job template data into attribute-value pairs, with the attributes being template resource identifiers and the values being template resource asset storage locations. The job template grouping structure could also be implemented as an entry in a job template database (e.g., indexed by job ID) whose fields (e.g., columns) specify the locations of the individual job template resources in the asset storage.

Regardless of how the job template grouping structure is implemented, the metadata for each job template may itself be stored in its own type of grouping structure. In an embodiment, such metadata could be maintained in a metadata storage container that is embedded or referenced within the “Template(s)” field of the job request information object, or within the above-described job template grouping structure that is itself embedded or referenced within the “Template(s)” field of the job request information object, or within a separate “Metadata” field of the job request information object. By way of example, the metadata storage container could be implemented as serialized data in the form of a metadata text string. In an embodiment, the metadata text string could be a JSON or XML text string that organizes the metadata into attribute-value pairs, with the attributes being metadata categories and the values being the metadata information itself. The metadata storage container could also be implemented as an entry in a job template metadata database (e.g., indexed by job ID) whose fields (e.g., columns) specify the various categories of metadata information.

In the foregoing discussion, the “Job Template(s)” field 4 of the job request information object 142 serves to catalog, for each job template of the print job request, all of the resources needed to print user-selected images onto a particular article type, in the exact manner in which the resources were assembled during the template process 144, as specified by the job template metadata. At print production time, a production company 110 may create the print job from the job template using its print production system (e.g., the scanning and print control system of FIGS. 1-12), making such calibration and normalization adjustments as may be called for to accommodate the particular article carrier trays and printers selected for production, and/or to correct positioning errors detected during the production system's fine position-determining operation, and/or to adjust printhead height as dictated by the production system's height-determining operation.

As an alternative to the above-described job template paradigm, it would be possible to generate, at the end of the template process 144, a single flat image file (e.g., PNG, SVG, PDF) or a single multi-layer file (e.g., TIFF) that includes all of the constituent user-selected images, properly layered, positioned and oriented as per the job template metadata, and thus ready to submit for print production. In that case, the job request information object 142 would only need to identify the single flat or multi-layer image file as the sole print job resource. There would be no longer be any need to catalog separate user images in combination with job template metadata.

Both of the above-described embodiments have strengths and weaknesses. Sending the job template to the print production company 110 supports selectable and variable data, at the expense of software complexity and data transmission size. The alternative embodiment, while simpler and with less data transmission overhead, does not support the reuse of assets. Once an image is constructed, it cannot be modified. When a job template is used, changes can be made to one or more of its layers at print production time to allow for dynamic content configuration.

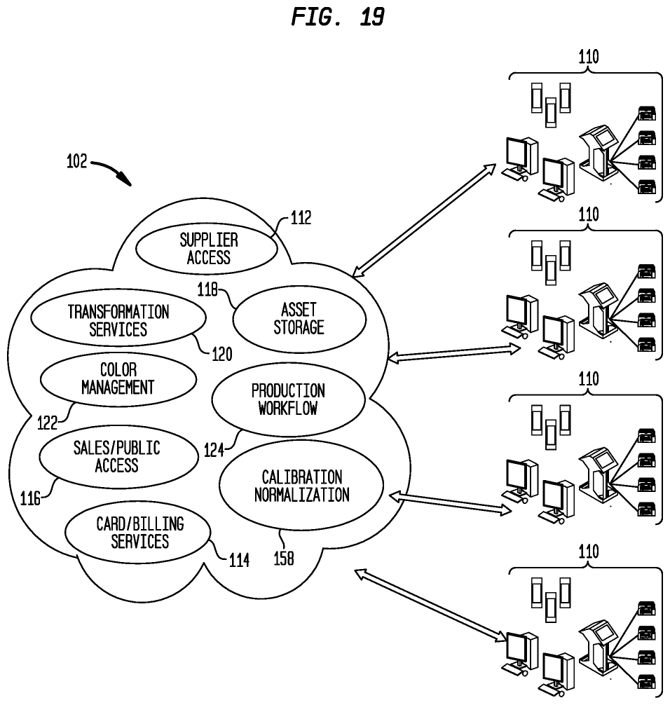

Turning now to FIG. 19, various components of the global print manager 102 that may interact with print production companies 110 are shown. Each print company may use a network-connected, automated print production system, such as the scanning and print control system 2 of FIGS. 1-12, to interact with the global print manager 102. The print production companies 110, via their print production systems, may be given access to some or all of the components that serve suppliers 104, sales vendors 106 and members of the general public 108. In addition, the print production companies 110 will interact via their print production systems with the production workflow component 124 of the global print manager 104, which is responsible for assigning print job requests to the print production companies, and tracking production print run workflow events, from production to packout.

The global print manager 102 is the application-wide repository for all user-created print job requests. The production workflow component 124 of the global print manager may allocate print job requests to different print production companies 110 based on certain criteria deemed important to the timely completion of the job request. Example allocation considerations include but are not limited to: (1) the print production company's physical proximity to the shipping location of the end user who will receive the printed articles, (2) the print production company's inventory of available blank articles on hand to print, (3) load balancing based on the distribution of unfinished print job requests being handling by individual print production companies, and (4) the available production capacity of each print production company 110.

In an embodiment, a print production company 110 may employ its print production system to connect to the global print manager 102 via the Internet or other network or in any other suitable manner. The production workflow component 124 of the global print manager 102 may provide the print production system with a list of print job requests that the print production company 110 has been assigned to fulfill. In an embodiment, the print job request assignments sent to the print production system could take the form of a listing of job IDs. The print production system may use the job IDs to search the global print manager's asset storage 118, find the corresponding job request information objects 142, and download the objects for review. If a web-based client-server model is used for communication between the global print manager 102 and the print production company 110, the job request information objects 142 may be converted from database entries into JSON objects that are transmitted as text to the print production company. If the print production company 110 decides to accept one or more of the print job requests, it may utilize the “Job Template(s)” field 4 of the corresponding job request information objects 142 to access the global print manager's asset storage 118 and download the job template resources needed for each accepted print job request. The print production system may then confirm receipt of the print job requests and set up print production in the form of production print runs, with each production print run constituting one or more separate print job requests (as previously described). The print production system may thereafter periodically update the production workflow component 124 of the global print manager 102 with a status upon completion of explicitly defined steps (registration, print started, print completed, packaging, shipping, complete). The print production system may also report any faults in the print production workflow to ensure that the status of a given job request is always known. The production work flow component 124 of the global print manager 102 may route this status information to the user that created or otherwise initiated the print job request (e.g., via their public direct application 106A or 108A) to provide up-to-date information regarding their order.

Additional user interface images may be generated as a result of interactions between the global print manager 102 and a print production system (e.g., the scanning and print control system 2 of FIGS. 1-12). In an embodiment, the user interface images may be displayed on the touch screen 6A of the scanner/production controller 4/6 (see FIG. 1). The user interface images support various print production system operations, such as to (1) interact with the global print manager 102 for the purpose of receiving print job requests, (2) create production print runs using the received print job requests, (2) perform article placement on article carrier trays 16, (3) perform article carrier tray scanning, and (4) manage scanning cameras 20 and printers 10.

As shown in FIG. 19, the global print manager 102 may include a calibration and normalization component 158 that supports the calibration and normalization of various print production resources. In an embodiment, the calibration and normalization component 158 may support article carrier tray calibration, printer calibration, scanner calibration, article type calibration, and job template calibration.

Tray calibration may be used to calibrate the dimensional characteristics of the article carrier trays 16 used by the print production companies. The tray calibration data may be stored for reference in the global print manger's asset storage 118, indexed by the article carrier tray identifier stored on the tray's RFID chip 26. As previously described in connection with FIGS. 4-10, when a production operator places the article carrier tray 16 onto the tray carrier 14 of the scanner/production controller 4/6 of FIG. 1, the scanner 4 will read the RFID chip 26 and report the tray identifier to the production controller 6. The production controller 6 will then have knowledge of exactly which article carrier tray 16 is being used for the current production print run. If the print production system does not already store the article tray's calibration data, it may download this data from the global print manager's asset storage and use it to generate the tray page setup data that guides the rough positioning of articles 38 on the tray 16.

Printer calibration may be used by the print production system to synchronize with a printer 10 to determine where it will lay down ink. This is helpful to the print production process because when an article carrier tray 16 is placed in the printer 10, the print company production system will know whether or not the placement of the articles on the article carrier tray is valid and the articles can be printed. If the printer does not have the ability to print onto all areas of the article carrier tray where articles have been placed for printing, or if an article's height is outside the printer's printhead adjustment range, an error message may be generated. In that case, the articles may need to be repositioned or the article carrier tray may have to be removed and inserted into a different printer. The printer calibration process may be performed when a new printer 10 is brought online at a given print production company 110. The printer calibration data may be stored for reference in the global print manager's asset storage 118, indexed by a printer ID. If the print production system does not already store the printer calibration data, it may download this data when a particular printer 10 has been selected for printing.

Scanner calibration may be used by the print production system to establish the camera scanner array to position and orient the cameras 20 for optimal registration and scanning performance. This operation may require physical movement of the camera 20 by a production operator, as guided by the print company production system. Scanner calibration may be performed when a new scanner 4 is brought online at a given print production company 110. The scanner calibration data may be stored for reference in the global print manager's asset storage 118, indexed by a scanner ID. If the print production system does not already store the scanner calibration data, it may download this data for use during article scanning operations.

Article type calibration may be used by the print production system to determine an article's size and height profile using the print production system scanner. This operation may be performed when a new article type is introduced into the production process, and will ensure proper performance and height clearance of the print heads of printers used by the print production company. The article calibration data may be stored in the global print manager's asset storage 118. If the printer production system does not already store this data, it may download the data for use in generating the tray page setup data that guides the rough positioning of articles 38 on an article carrier tray 16.

Template calibration is used by the print production system to perform adjustments to the job template of a print job request to ensure its images are correctly placed and oriented according to the results of the tray calibration, printer calibration, scanner calibration, and article type calibration operations. This process may be performed during production print run setup and execution by the print production system (e.g., as per the operations of FIGS. 4-10) to ensure that the job template images are laid down correctly. Template calibration may also be performed to a limited extent during print job request creation based on the results of article type calibration. Template calibration during print job request creation will typically not take into account tray calibration, printer calibration or scanner calibration insofar as those devices will not normally be known to the global print manager 102 when the print job request is created.

As previously discussed, print color corrections and image orientation/rotation may be performed by the global print manager 102 during print job request creation. The global print manager 102 may also perform color corrections and image orientation/rotation during the upload and grouping process of images in the asset storage 118. This allows the global print manager to standardize color profiles and image orientation to ensure a uniform reproduction regardless of which print production system performs article printing. This also gives the user the power to build a print job request to their own specifications. Then, as the print job request is placed with a print production system for incorporation into a production print run, that system may automatically adjust the print job's color and image orientation based on a profile that has been established for the specific printer 10 on which the article will be printed. This last minute adjustment may be performed when the printer 10 on which a given print job will be produced becomes known.

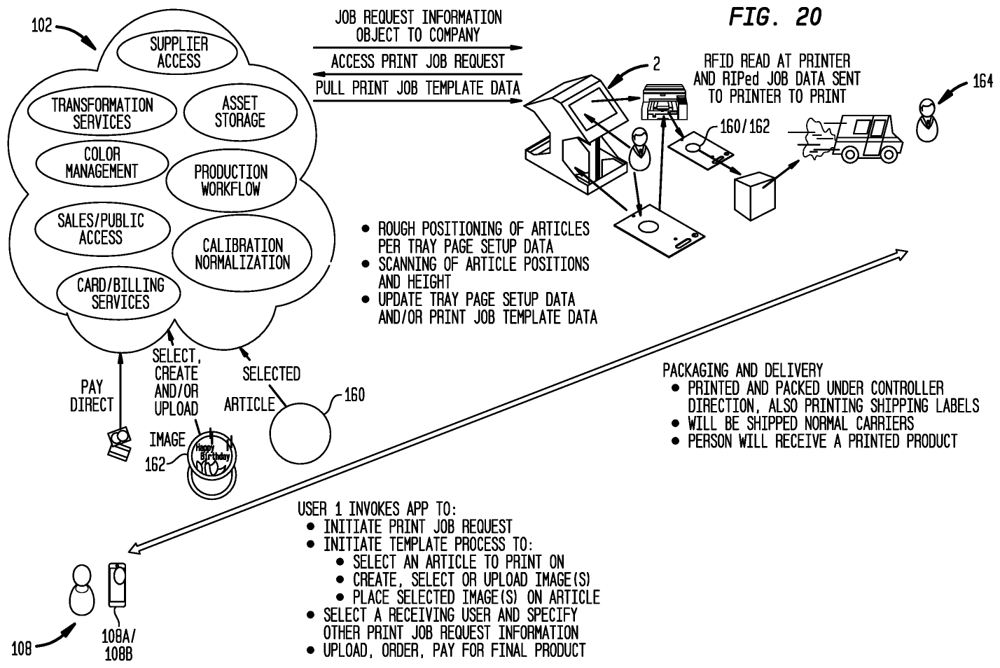

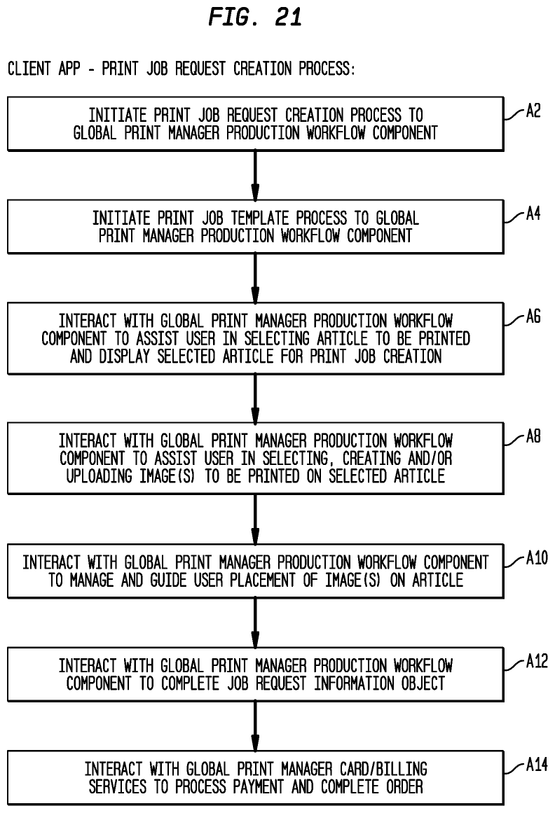

Turning now to FIGS. 20-23, flow diagrams are depicted to illustrate an example print job request/production print run workflow utilizing the global print manager of FIG. 13 in conjunction with a print production system, such as the scanning and print control system of FIGS. 1-12. The workflow begins with a sending user who initiates the workflow and ends with a receiving person who receives the printed articles. In this example, the user is a member of the public 108 who wishes to have a cookie 160 printed with a cake graphic 162 bearing a “Happy Birthday” message, thus forming a printed article 160/162, that is then sent to a receiving person 164.

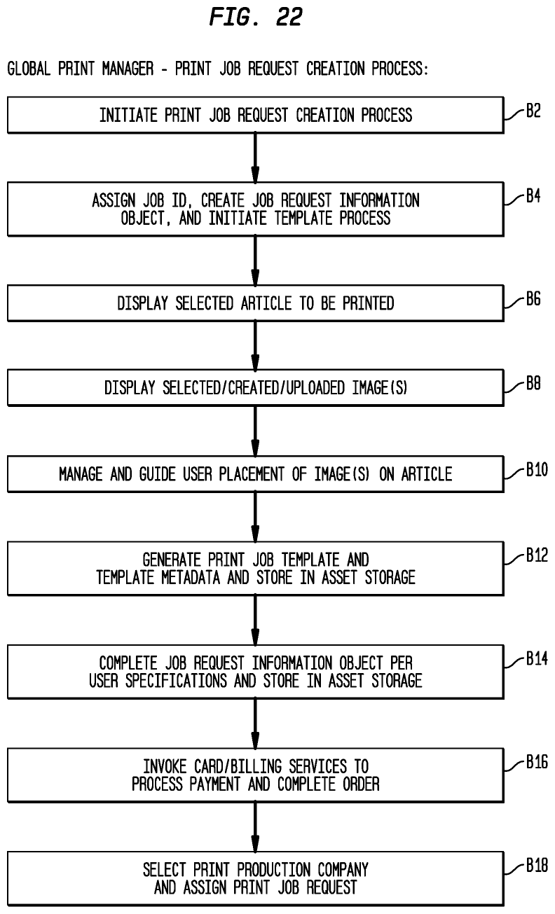

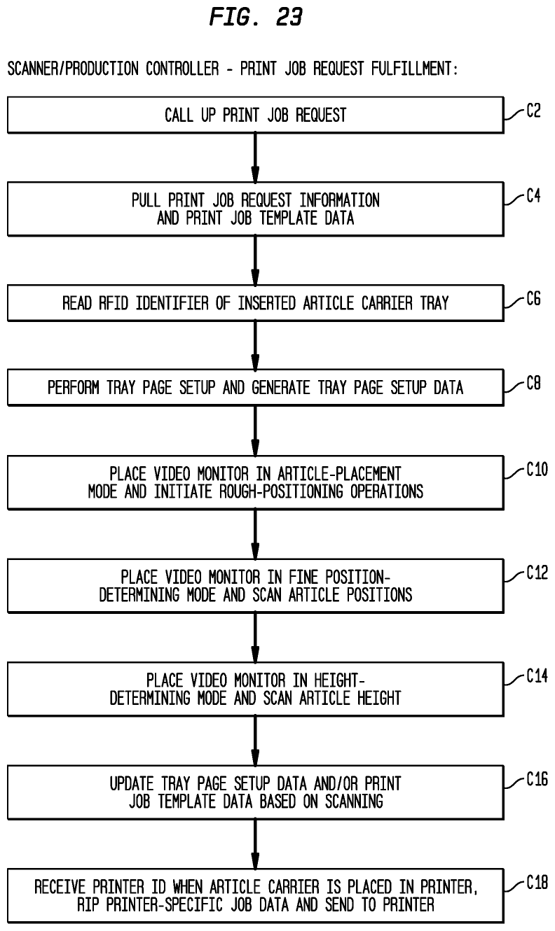

The sending user 108 may initiate the workflow by operating a user device 108B (e.g., smartphone, tablet, desktop computer, etc.) running a public direct application 108A that accesses the public side of the global print manager's sales/public access portal 116 (see FIG. 17). In accordance with FIGS. 21 and 22, the user application 108A interacts with the global print manager's production workflow component 124 to initiate a print job request creation session. The client application (108A) side of this operation is shown in the first block A2 of FIG. 21. The global print manager 124 side of this operation is shown in the first block B2 of FIG. 22. As shown in the second block A4 of FIG. 21, the user 108 utilizes the client application 108A to interact with the global print manager production work flow component 124 in order to initiate the template process 144 of FIG. 18. As shown in the second block B4 of FIG. 22, the global print manager production workflow component 124 assigns a job ID, creates a job request information object 142 and initiates the template process 144.

In the third block A6 of FIG. 21, the client application 108A interacts with the global print manager production work flow component 124 to enable the user to select an article on which to print (e.g, the cookie 160). The global print manager production work flow component 124 displays the selected article 160 as an article image per the third block B6 of FIG. 22. In the fourth block A8 of FIG. 21, the client application 108A interacts with the global print manager production work flow component 124 to allow the user to select, create and/or upload one or more images to be printed (e.g., the “Happy Birthday” cake graphic 162). The global print manager production workflow component 124 displays the selected, created and/or uploaded image(s) per the fourth block B8 of FIG. 22. In the fifth block A10 of FIG. 21, the client application 108A interacts with the global print manager production workflow component 124 to manage and guide the user as they drag the user image(s) over an article image/template (formed by the article image with its associated clipping path image and alpha channel orientation mark) to establish image positioning and placement of the user image(s) 162 on the article 160. The global print manager production workflow component 124 manages and guides the user placement of the image(s) 162 on the article 160 per the fifth block B10 of FIG. 22.

In the sixth block A12 of FIG. 21, the client application 108A interacts with the global print manager production workflow component 124 to specify the receiving person 164 and other print job information in order to complete the job request information object 142. This will cause the global print manager production work flow component 124 to generate a print job request (order) that includes a completed job request information object 142 and associated job template data and template metadata that are all stored in the global print manager's asset storage 118 (or elsewhere) per the sixth and seventh blocks A12 and A14 of FIG. 22. The client application 108A then interacts with the global print manager card/billing services 114 to process payment for the final product and complete the order. The client application side of this operation is shown in the seventh block A14 of FIG. 21. The global print manager side of this operation is shown in the eighth block B16 of FIG. 22.

In the ninth block B18 of FIG. 22, the global print manager 102 selects a print production company 110 and assigns it the print job request. The global print manager 102 will advise the print production system of the print job request and the latter may accept the request based on review of the job request information object 142.

As additionally shown in FIG. 23, a production operator may invoke the scanning and print production system 2 to call up the print job request and pull the job template data specified by the job request information object 142 in order to setup and execute the production print run. This is shown in the first and second blocks C2 and C4 of FIG. 23. The production operator may then select an article carrier tray 16 and insert the article carrier tray onto the tray carrier 14 of the scanner/production controller 4/6. As shown in the third, fourth and fifth blocks C6, C8 and C10 of FIG. 23, the scanner/production controller 4/6 reads the RFID identifier of the inserted article carrier tray 16, and activates the production system's rough positioning mode of operation to generate tray page setup data and display the article placement positions. The production operator may now place the articles 160 were requested.

As shown in the sixth and seventh blocks C12 and C14 of FIG. 23, the production operator may next initiate the production system's article fine position-determining and height-determining modes of operation, performing fine position scanning to scan article positions and height scanning to scan article height. In the eighth block C16 of FIG. 23, the scanner/production controller 4/6 makes any required updates to the tray page setup data and/or print job template data based on the scanning performed as part of the fine position-determining and height-determining modes of operation. This will ensure precise printing. When scanning has completed, the production operator (or an automated system) may remove the article carrier tray 16 from the scanner/production controller tray carrier 14 and insert it into a printer 10 (which reads the tray identifier). As shown in the ninth block C18 of FIG. 23, when the article carrier tray 16 is placed in the printer 10, the printer identifies itself to the scanner/production controller 4/6 by providing a printer ID, and the latter RIPs the print job into printer-specific job data, then sends it to the printer to initiate printing. Following printing, the printed articles 160/162 may be removed, packaged as specified in the print job request, and shipped to the receiving person 164.

Turning now to FIG. 24, an augmented reality (AR) controller 202 is shown that may be used alone or in conjunction with the global print manager 102 of FIG. 13-20 (or other print management system), either as a separate system or integrated therewith, to provide an enhanced printed article experience that includes AR effects. Specifically, the AR controller 202 may operate to capture, assign, distribute and logically bind a specific AR event/media related to a graphic image printed on (or otherwise associated with) a three-dimensional article, such as an edible food product, or logically bind the AR event/media to the article itself or to some other entity. The AR event/media (hereinafter referred to as an “AR asset”) will enhance the entity to which it is related with AR functionality, such that the entity may be thought of as being “AR-enhanced.”

Example components of the AR controller 202 may include a public access portal 204, a card/billing services component 206, an asset storage component 208, a transformation services component 210, an image encoding and binding component 212, a streaming services component 214, and a 3D object generator component 216.

The public access portal 204 provides an interface for members of the public 218 who wish to access the AR controller 202 by way of public direct applications 218A (e.g, mobile applications, web applications, etc.) running as AR controller client applications on user devices 218B (e.g., smartphones, tablets, desktop computers, etc.). The public direct applications 218A may include applications for AR content creators and AR content receivers. In an embodiment, each public direct application 218A may comprise both an AR content creator application 218A-1 and an AR content receiver application 218A-2. Alternatively, the creator and receiver applications 218A-1 and 218A-2 may be implemented as separate stand-alone applications.

The AR content creator application 218A-1 may be used to select a three-dimensional article that is to AR-enhanced, select, upload and create video, graphics and related templates, author AR content that incorporates the video, graphics and related templates, pay for the AR content via the card/billing services component 206, and track the AR-enhanced article associated with the AR content until it is delivered to a designated receiving user. In an embodiment, the AR controller 202 may act as a front end to the global print manager 102 of FIGS. 13-19, such that users running the content creator application 218A-1 may create print job requests (as previously described in connection with the global print manager 102) at the same time they create AR content. Such print job requests may be referred to as AR-enhanced print job requests. Alternatively, the AR controller 204 may be used to create AR content for use with print job requests that were created separately using the global print manager 102 (or other print management system), such that they become AR-enhanced print job requests, or to create AR content for use with unprinted articles, or with other objects and things, or even particular users. In each case, the AR controller 202 may run independently of the global print manager 102, or alternatively, the AR controller may be integrated with the global print manager (e.g., as a set of components thereof).

The AR content receiver application 218A-2 may be used by persons who receive a printed article that has been printed by the scanning and print control system 2 of FIGS. 1-12 (or other print production system), pursuant to an AR-enhanced print job request received from the global print manager 102 of FIGS. 13-19 (or other print management system). The AR content receiver application 218A-2 allows the recipient of the printed article to view AR content that is logically associated with an AR-encoded (or otherwise unique) image printed on the article (hereinafter the printed “anchor image”) or that is logically associated with the article itself, or with another object, thing, person or other entity. The AR content receiver application 218A-2 may be designed to run on a mobile device 218B equipped with a camera and a display, such that the latter functions as an AR content display device. The AR content receiver application 218A-2 may be provided with a reference copy of the printed anchor image that is printed on the AR-enhanced article. The reference anchor image is used for decoding the printed anchor image. When the camera is pointed at the printed article, the printed anchor image thereon, or the article itself, or the printed anchor image in combination with the article itself, will be perceived to match the reference anchor image, and the AR content will be activated. The AR content may be displayed on the mobile device display in a predetermined spatial relationship with the printed article. For example, the AR content may be superimposed over the article or its printed anchor image, displayed so as to float above or next to the article, displayed to move around in relation to the article, etc.

In an embodiment, the AR content creator application 218A-1 and AR content receiver application 218A-2 may be implemented using existing AR toolsets, such as Apple's ARKit developer platform for IOS devices or Google's ARCore developer platform for Android devices. As is known, these toolsets provide well-documented tools for combining device motion tracking, camera scene capture, advanced scene processing, and display conveniences to simplify the task of building an AR experience.

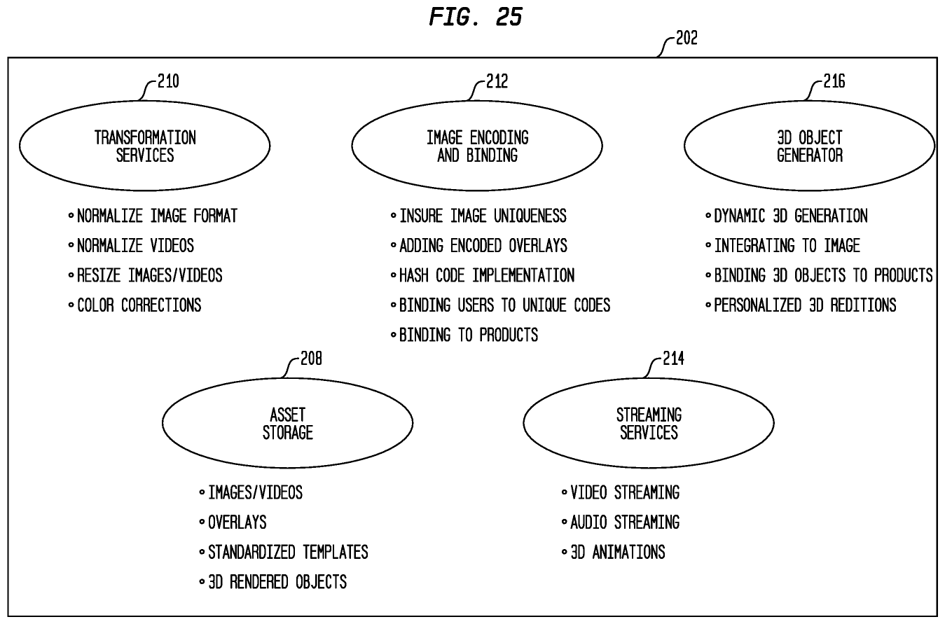

FIG. 25 illustrates example services and functionality that may be provided by the components of the AR controller 202.

The asset storage component 208 is analogous to its counterpart (asset storage component 118) in the global print manager 102 of FIGS. 13-19. If the AR controller 202 is integrated with the global print manager 102, the respective asset storage components 208 and 118 thereof could be one and the same. Example resources that may be maintained in the AR controller's asset storage 208 include images and overlays that serve as printed anchor images that can be assigned to or otherwise associated with articles to be printed, and to which AR content may be logically bound, videos and 3D rendered objects that may be selected for display as AR content, and standardized AR templates. In an embodiment, the standardized AR templates may be AR job templates that are analogous to the print job templates described above in connection with the global print manager 102. In particular, the AR templates may serve as containers for the above-mentioned images, overlays, videos, and 3D rendered objects, together with metadata required by the AR content receiver application 218A-2 to assemble and display AR content.

The transformation services component 210 of the AR controller 102 may operate in a manner that is analogous to the transformation services component 120 and the color management component 122 of the global print manager 102. Supported services may include normalizing image formats, normalizing videos, resizing images and videos, and making color corrections.

The image encoding and binding component 212 of the AR controller 102 allows the AR content creator application 218A-1 to bind AR content to images, articles and users, all of which may comprise unique visual fingerprints that can serve as a printed anchor image for triggering the AR content. This provides flexibility by allowing different AR content to be logically bound to a wide variety of entities, be they images, users, products or other objects and things. Supported services may include verifying printed anchor image uniqueness to ensure that a user-selected printable anchor image assigned to or otherwise associated with an article to be printed is sufficiently unique and distinguishable, when viewed as a printed ink pattern against the background provided by the article on which it is printed, to reliably activate AR content. If it is not, the image encoding and binding component 212 may be used to enhance the printed anchor image by making adjustments thereto that alter its appearance, such as color, intensity, contrast, or brightness adjustments, or adding encodings such as overlays to serve as printed anchor images, or implementing hash codes to serve as unique identifiers (fingerprints). The image encoding and binding component 212 may also be used for logically binding printed anchor images to AR content, logically binding users to unique codes, and logically binding AR content to printed articles. This allows an AR toolset (e.g., of an AR content receiver application 218A-2) to know what image it is looking at when viewing the AR-enhanced article, and what AR content, metadata, users and/or other entities are associated therewith.

The ability to verify the decodability of a printed anchor image as it will appear on the AR-enhanced article as a printed ink pattern, and to enhance the printed anchor image as necessary, is particularly advantageous when producing AR-enhanced three-dimensional edible articles for human consumption (e.g., food products, confections, vitamins and other consumable health products, pharmaceuticals, etc.). Such edible articles (especially food products such as cookies, cakes, pastries, candies) typically have non-de minimis length, width and height dimensions that may vary from one article to the next or even within a single article. This is in contrast to non-edible print media such as paper and other non-edible sheet substrates. Such media are nominally two-dimensional because their thickness (i.e., height dimension) is de minimus (e.g., typically less than 0.5 mm) and non-varying.

Applying AR-decodable printed anchor images directly onto edible articles using non-contact ink printing techniques (such as ink-jet printing) thus presents challenges not found when printing anchor images on non-edible print media. Edible articles also tend to have widely varying surface properties that create additional challenges apart from their three-dimensionality. Such varying surface properties include, but are not limited to, different textures, hardnesses, height profiles, surface irregularities, colors, shades, ink absorption properties, etc., all of which may differ depending on the shape, size, appearance, composition and mode of manufacture of the edible article. Given this wide variation in edible article surface properties, the appearance of any given printed anchor image when laid down as a printed ink pattern on an edible article may change drastically from one article to the next. By way of example, a printed anchor image that is easily decodable when printed on a white chocolate product may not be decodable when printed on a brown chocolate product. Similarly, a printed anchor image that is easily decodable when printed on a smooth-surfaced cookie may not be decodable when printed on a breakfast waffle.

Similar problems can arise when printing images onto edible media formed as sheet-like substrates designed for application onto the surface of an edible article (e.g., a preformed edible layer element that is printed and applied to the surface of a cookie, cake, pastry, candy or the like). Such edible media represent edible articles that are typically considered to be food products. Although they are formed as sheet-like substrates, edible media may likewise present image decoding challenges due to their varying surface properties and, in some cases, their three-dimensionality if configured as three dimensional edible articles having non-de minimus thickness.

The image encoding and binding component 212 of the AR controller 202 addresses the challenges of printing on articles whose length, width and height dimensions are non-de minimis and/or whose printable surfaces are widely varying and not like standard print media. The ability to verify and enhance a printed anchor image has been discussed. In an embodiment, the corresponding reference anchor image used by an AR content receiver application 218A-2 for decoding the printed anchor image may itself be optimized. In particular, the reference anchor image may be optimized so as to incorporate the printed anchor image in the precise context in which it will be viewed by an AR content display device that runs the AR content receiver application 218A-2, namely, as the printed anchor image appears when printed as an ink pattern on the article being viewed by the display device. A reference anchor image that is optimized to reflect the same context it will be seen in by the AR content display device (i.e., as a printed ink pattern on the AR-enhanced article) maximizes the likelihood of producing a successful AR experience for that article. When the reference anchor image is optimized in this manner, the article may itself provide ancillary level uniqueness, becoming merged with the reference anchor image for purposes of recognition and decoding by the AR content receiver application 218A-2. In such an embodiment, the reference anchor image used for decoding becomes a composite entity that encompasses both the printed anchor image and the visual-geometrical-tactile-compositional characteristics of the article substrate on which the printed anchor image is laid down. This composite entity may be referred as an “optimized” reference anchor image in order to distinguish it from other embodiments wherein the reference anchor image is identical to the printed anchor image used for printing on the AR-enhanced article. Techniques that may be used to generate an optimized reference anchor image are described in more detail below.

The 3D object generator component 216 of the AR controller 202 allows the AR content creator application to create 3D rendered objects to be displayed as AR content. Supported services may include dynamic 3D object generation, integration of 3D objects with images, logical binding of 3D objects to articles, and personalized 3D renditions. By way of explanation, a dynamic 3D object may be implemented by AR rendering software (such as an AR content receiver application 218A-2) that works to create the object and is subject to an algorithm and data set for its creation. Examples include a chart/graph or a globe that zooms in on a specific location. A personalized 3D asset may be an off-the-self asset into which a user can inject variable data to tailor the experience for their recipient.

The streaming services component 214 of the AR controller 202 allows AR content receiver applications to play multimedia AR content. Supported services include video streaming, audio streaming and 3D animations. These services respectively deliver video streams, audio streams and 3D animations to the AR content receiver application 218A-2 in response to AR content being activated.

The card/billing services component 206 is analogous to the card/billing services component 114 of the global print manager 102. As such, this component may only be necessary if the AR controller 202 operates separately from the global print manager 102 and there is a need to charge for AR content creation independently of charging for print job request creation.

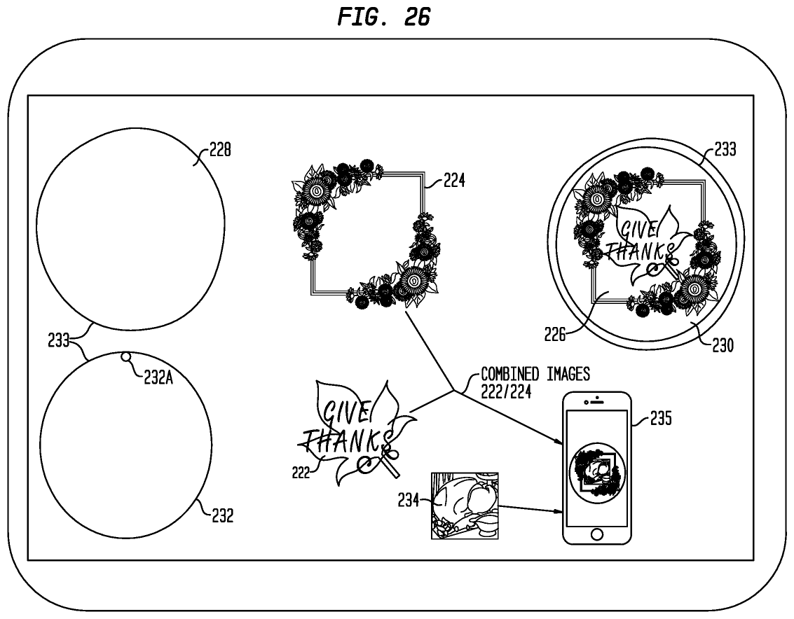

Turning now to FIG. 26, an example AR-enhanced template process 220 is shown that the AR controller 202 may provide for producing AR-enhanced print job templates that can be used to produce AR-enhanced articles by way of AR-enhanced print job requests. The AR-enhanced template process 220 of FIG. 26 is similar in many respects to the print job template process 144 described above in connection with FIG. 18. The AR-enhanced template process 220 differs insofar as a printed AR anchor image may constitute one or both of a primary image and an overlay image that are optionally combined and displayed in combination with an image of the AR-enhanced article. This is illustrated in FIG. 26, wherein a primary image 222 depicting a Thanksgiving holiday message is combined with an overlay image 224. The combined image 222/224 represents a two-layer printed anchor image 226 that will be printed onto an article, in this case a cookie, to produce an AR-enhanced article having a printed anchor image with sufficient uniqueness to trigger the display of AR content by an AR content receiver application 218A-2. In some cases, the primary image 222 may may be sufficiently unique to serve as a one-layer printed anchor image. In other cases, the overlay image 224 may be used to provide second level uniqueness, or may be particularly encoded for that purpose.

As part of the AR-enhanced template process 220, the printed anchor image 226 is superimposed on the image of a cookie 228 that is to be printed with the primary and overlay images 222 and 224. The resultant composite image 230 depicts how the printed anchor image 226 formed by the primary and overlay images 222 and 224 will appear when printed on the AR-enhanced article. The composite image 230 incorporates all the component parts of an optimized reference anchor image that may be generated (see below) in accordance with an embodiment in which the printed anchor image 226 formed by the primary and overlay images 222/224 provide a foreground portion of the optimized reference anchor image and the article image 228 provides a background portion of the optimized reference anchor image. In such an embodiment, the optimized reference anchor image, i.e., the composite image 230, may be circumferentially delimited by a clipping path image 232 (or some other delimiter). The clipping path image 232 removes peripheral portions of the article image 228 from the composite image 230, such that only a subregion of the article (e.g., the interior region) provides the background portion of the optimized reference anchor image. Delimiting the optimized anchor image 230 in this manner can eliminate article edge effects such as contour irregularities, localized discolorations, shadows, etc. As in the case of the template process 144 of FIG. 18, the clipping path image 232 may include a small alpha channel orientation mark 232A that defines a reference rotational orientation of the article image 228 for rotationally aligning the article image and the user-selected image(s) 222 and 224 placed thereon. The article image 228, together with its clipping path image 232 and orientation mark 232A, may be referred to as an article image/template 233. As in the case of the article image/template 150 of FIG. 18, the clipping path image 232 logically defines the shape and size of the article image 228 and the orientation mark 232A logically defines its rotational orientation.

In embodiments wherein the composite image 230 is used as an optimized reference anchor image, the optimized reference anchor image may be thought of as representing a virtual production item corresponding to a real production item that will be produced by printing an article corresponding to the article image 228 with the primary and overlay images 222 and 224. The virtual production item may be created as a multi-layer virtual image that represents a composite of the overlay image 224 overlaid onto the primary image 225, and with the resultant combination overlaid onto the article image 228 of the cookie (and clipped by the clipping path 232 if so desired) to form the optimized reference anchor image. The virtual production item may then serve as an optimized reference anchor image. Alternatively, a real production item may be created by physically printing an ink pattern, representing the primary image 222 combined with the overlay image 224, onto a real cookie. The real production item may then be used to generate an optimized reference anchor image by capturing an image of the printed cookie (e.g., photographing the cookie using a camera or other image capture device) and optionally cropping the image to eliminate edge effects (as discussed above).

Regardless of how the optimized reference anchor image is generated (i.e., as a virtual production item or a real production item), it may be stored (along with the article definition and the printed anchor image) in the asset storage 208 as part of the AR-enhanced print job template created by the AR-enhanced template process 222 of FIG. 26, or otherwise allocated, assigned or associated with the print job, or with the printed article once it has been printed. In an embodiment, the AR controller 202 may maintain a collection of pre-generated optimized reference anchor images that are optimized for particular articles that are to be printed (or which have been printed), and may thus serve as pre-qualified reference anchor images. Creating pre-generated, pre-qualified reference anchor images prior to commencement of the AR-template process 220 of FIG. 26 may expedite the production of AR-enhanced print job templates. In that case, the primary and overlay images selected by the user as part of the AR-enhanced template process may also be pre-generated. However, the user's ability to position the images over the article may need to be constrained so that the resultant composite image (such as the composite image 230 FIG. 26) matches one of the pre-generated, pre-qualified reference anchor images.

A further difference between the AR-enhanced template process 220 of FIG. 26 and print job template process 144 of FIG. 18 is that the former includes AR content authoring operations that allow a user to select, create and/or upload images or multimedia to be used as AR content and associate such content with the article to be printed. In the example of FIG. 26, AR content in the form of a Thanksgiving holiday-themed video 234 has been selected by the user. The AR-enhanced template process 220 may guide the user in binding of the AR content video 234 to the article that will be printed with the overlay image. For example, the image 235 of a mobile user device 218B (e.g., smartphone, tablet, etc.) may be displayed, with the composite image 230 representing the article image 228 overlaid with the primary and overlay images 222 and 224 (i.e., the printed anchor image 236) being depicted on the device display screen. Using a drag and drop gesture or the like, the user may place the AR content video 234 on top of the primary and overlay images 222 and 224 that serve as the printed anchor image 236 (or at some other location) on the device display. The AR controller 202 will logically bind the video 234 to the printed anchor image 236 and store the results in its asset storage 208 as an AR template.

In an embodiment, the AR-enhanced template process of FIG. 26 may completely supplant the template process of FIG. 18, thereby allowing a user to create an AR-enhanced print job template as part of an AR-enhanced print job request that supports AR content, and also select, create and/or upload the AR content that will be associated with the AR-enhanced print job request. Alternatively, the AR-enhanced template process of FIG. 26 could be implemented separately from the template process of FIG. 18. For example, the global print manager 102 of FIGS. 13-23 could maintain a print job request in its asset storage 118 that includes a print job template 142 created by a user using the template process 144 of FIG. 18. The same user may thereafter wish to create a new AR-enhanced print job request using the same print job template 142 but with added support for AR content. As part of the new AR-enhanced print job request, the existing print job template 142 created by the template process 144 of FIG. 18 could be called up and imported into the AR-enhanced template process 222 of FIG. 26. The imported print job template 142 could then be modified into an AR-enhanced print job template that supports AR content (by assigning an AR asset and generating an optimized or non-optimized reference anchor image), following which the AR-enhanced print job template may be stored in the global print manager's asset storage 118 (or in the AR controller's asset storage 208) as part of the new AR-enhanced print job request.

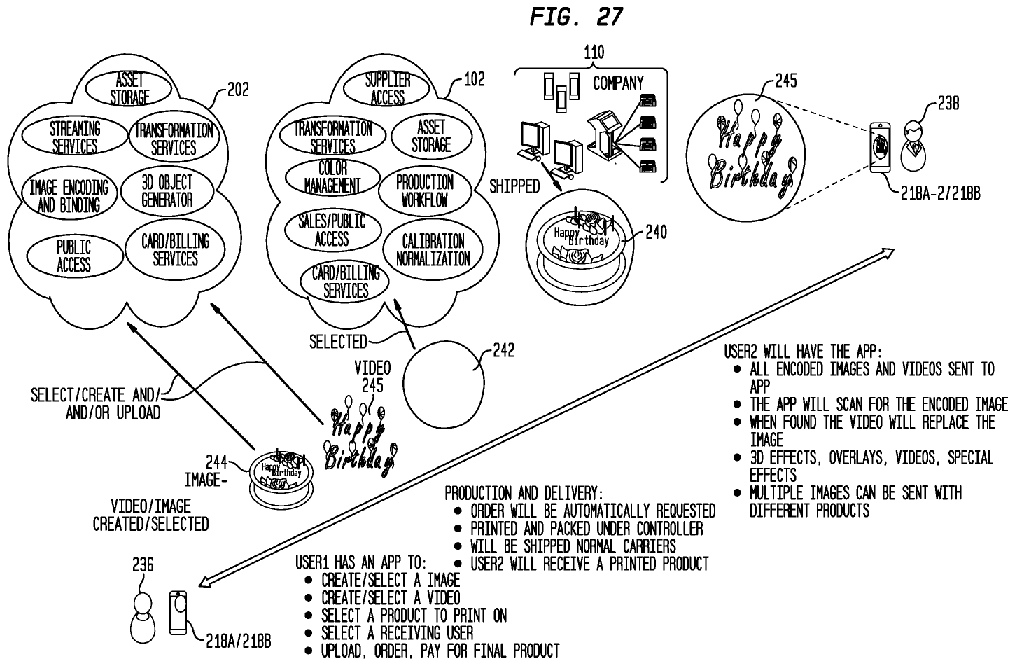

Turning now to FIGS. 27-30, flow diagrams are depicted to illustrate an example AR-enhanced print job request/production print run workflow utilizing the AR controller 202 of FIGS. 24-26, the global print manager 102 of FIGS. 13-19, and a print production company 110 running a print production system (such as the scanning and print control system 2 of FIGS. 1-12). The workflow begins with a sending user 236 who initiates the workflow and ends with a receiving user 238 who receives the printed articles and AR content. As shown in FIG. 27, the AR-enhanced article 240 may be a cookie 242 printed with the image of a birthday cake 244 and logically bound to an AR asset in the form of a happy birthday video message 245 (the logically binding being implemented by allocating the AR asset to the AR-enhanced print job template). The AR-enhanced article 240 will trigger the happy birthday video message 245 when received by the receiving user 238 and detected by the user's AR content display device 218B running an AR content receiver application 218A-2.

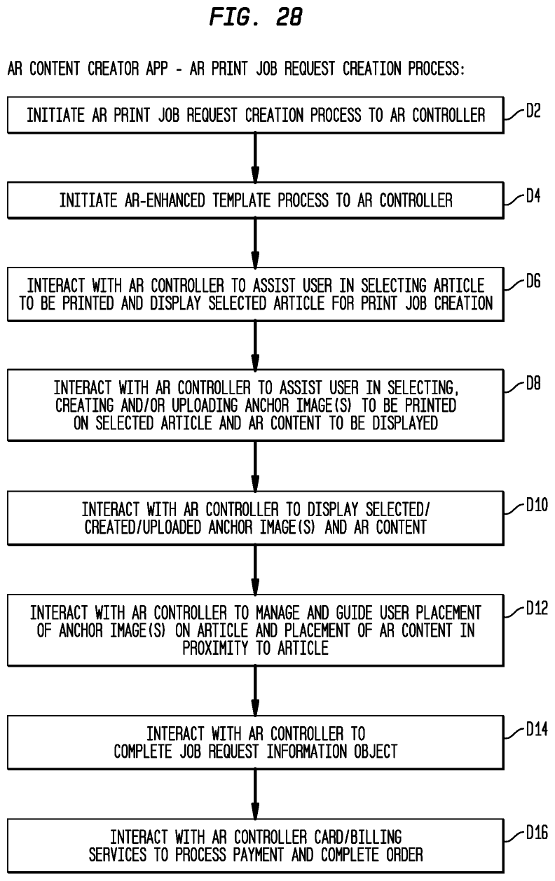

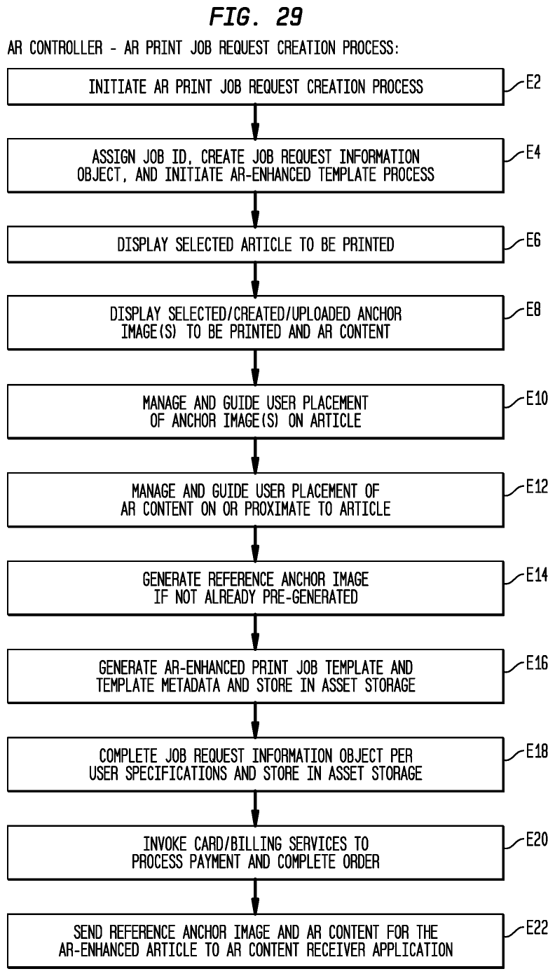

The sending user 236 may initiate the workflow by operating the AR content creator application 218A-1 on their user device 218B (e.g., smart phone, desktop computer, etc.) in accordance with FIG. 28. The AR content creator application 218A-1 interacts with the AR controller 202 (either alone or in combination with the global print manager 102 of FIG. 13) in order to generate an AR-enhanced print job request by implementing the (client-side) AR print job request creation operations illustrated in FIG. 29. Thus, in the first block D2 of FIG. 28, the AR content creator application 218A-1 interacts with the AR controller 202 to initiate an AR print job creation process. The AR controller 202 responds by initiating the (server-side) AR print job request creation process in the first block E2 of FIG. 29. As shown in the second block E4 of FIG. 29, the AR controller 202 assigns a job ID, creates a job request information object and initiates an AR-enhanced template process 222 in response to a request from AR content creator application per the second block D4 of FIG. 28.

Using the AR-enhanced job template process 222 of FIG. 26, the sending user 236 may invoke the third block D6 of FIG. 28, which causes the AR content creator application 218A-1 to interact with the AR controller 202 to assist the sending user in selecting the article to be printed (e.g., the cookie 240) and to display the selected article for print job creation. The AR controller 202 responds by displaying an image 228 (see FIG. 26) of the selected article to be printed, as shown in the third block E6 of FIG. 29. In the fourth block D8 of FIG. 28, the AR content creator application 218A-1 interacts with the AR controller 202 to assist the user in selecting, creating and/or uploading one or more anchor images (e.g., the birthday cake image 242) to be printed on the selected article and AR content (e.g., the happy birthday video message 245) to be displayed in association with the selected article. In the fifth block D10 of FIG. 28, the AR content creator application 218A-1 interacts with the AR controller 202 to display the selected/created/uploaded anchor image(s) and AR content. The AR controller 202 responds by displaying the anchor image(s) and AR content in the fourth block E8 of FIG. 29.

In the sixth block D12 of FIG. 28, the AR content creator application 218A-1 interacts with the AR controller 202 to manage and guide user placement of the anchor image(s) on the article and user placement of the AR content in proximity to the article. In the fifth block 10 of FIG. 29, the AR controller 202 manages and guides user placement of the anchor image(s) on the article. In the sixth block E12 of FIG. 29, the AR controller 202 manages and guides user placement of the AR content on or proximate to the article. In the seventh block E14 of FIG. 29, the AR controller 202 may generate a reference anchor image, which may be optimized as a composite of the user selected anchor image(s) and the article image. Alternatively, if the anchor image(s) to be printed were selected from a library of images maintained by the AR controller, there may also be a library of pre-generated, pre-qualified reference anchor images. In the eighth block E16 of FIG. 29, the AR controller 202 generates an AR-enhanced print job template and template metadata and stores these objects in the AR controller's asset storage 208 (or elsewhere). In the seventh block D14 of FIG. 28, the AR content creator application 218A-1 interacts with the AR controller 202 to complete the job request information object. In the ninth block E18 of FIG. 29, the AR controller 202 completes the job request information object per user specifications and stores it in the AR controller's asset storage 208 (or elsewhere). To complete the AR-enhanced print job request creation process, the user 236 will specify the printed article recipient (the receiving user 238), and confirm and pay for the order. This is shown in the eighth block 16 of FIG. 28 and the tenth block E20 of FIG. 29.

The print job request information and associated AR-enhanced print job template data created as a result of the AR-enhanced print job request creation process of FIGS. 28 and 29 may be stored by the AR controller 202 (or the global print manager 102) in the AR controller's asset storage 208 (or the global print manager's asset storage 118). When the AR-enhanced print job request is ready for production, the global print manager 102 will notify a print production company 110 (see FIG. 14) that operates a print production system (such as the scanning and print control system 2 of FIGS. 1-12) and the latter will download the AR-enhanced print job request information and AR-enhanced print job template data. The print production system will setup and execute a production print run that incorporates the AR-enhanced print job request to produce an AR-enhanced and supported printed article (e.g., the printed AR-enhanced cookie 240 of FIG. 27), and ship the article to the receiving user 238.

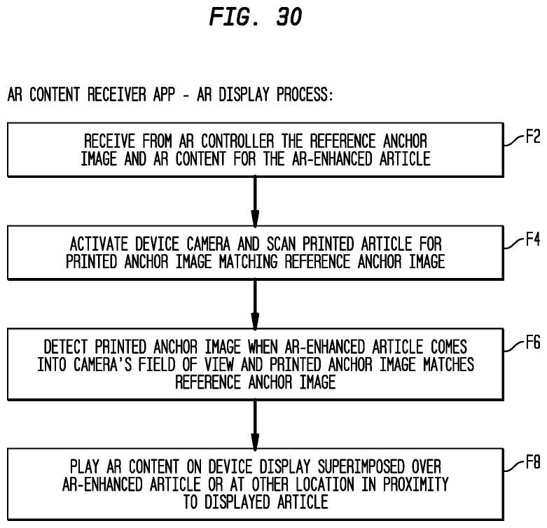

The receiving user 238 may view the AR content 245 logically bound to the printed article (e.g., a birthday cake video) using their camera-equipped mobile device 218B (e.g., a smartphone, tablet, etc.) that runs the AR content receiver application 218A-2 in accordance with FIG. 30. As previously noted, programming the receiving user's device with the AR content receiver application 218A-2 allows the device to function as an AR content display device. In response to the AR-enhanced article being received, the AR content receiver application 218A-2 may access the AR controller 202 (alone or in combination with the global print manager 102) and download the reference anchor image and the AR content associated with the article, together with any AR content positioning information that may have been specified in the template metadata created by the sending user 236. This is shown in the first block F2 of FIG. 30 and the eleventh block E22 of FIG. 29. When the receiving user 238 activates their device's camera using the AR content receiver application 218A-2, the application will scan for the AR-enhanced article for a printed anchor image that matches the reference anchor image. This is shown in the second block F4 of FIG. 30. Using the application's AR technology, the printed anchor image will be detected when the printed article comes into the camera's field of view and it is determined that the printed article image matches the reference anchor image. If the reference anchor image is optimized as a composite of the printed anchor image and a background image that includes some or all of the article, the image matching will necessarily take into account the article on which the printed anchor image is printed. Depending on the nature of the printed article, this may increase the likelihood of a match. The AR content (e.g., happy birthday video message 245 of FIG. 27) may then be played within the camera image on the mobile device display. This is shown in the third and fourth blocks F6 and F8 of FIG. 30. In an embodiment, the AR content (e.g., the happy birthday video message 245 of FIG. 27) will be positioned according to the AR template metadata created by the sending user 236. It may be superimposed over the printed anchor image(s) on the article or positioned in any other manner. Other AR effects may also be provided.

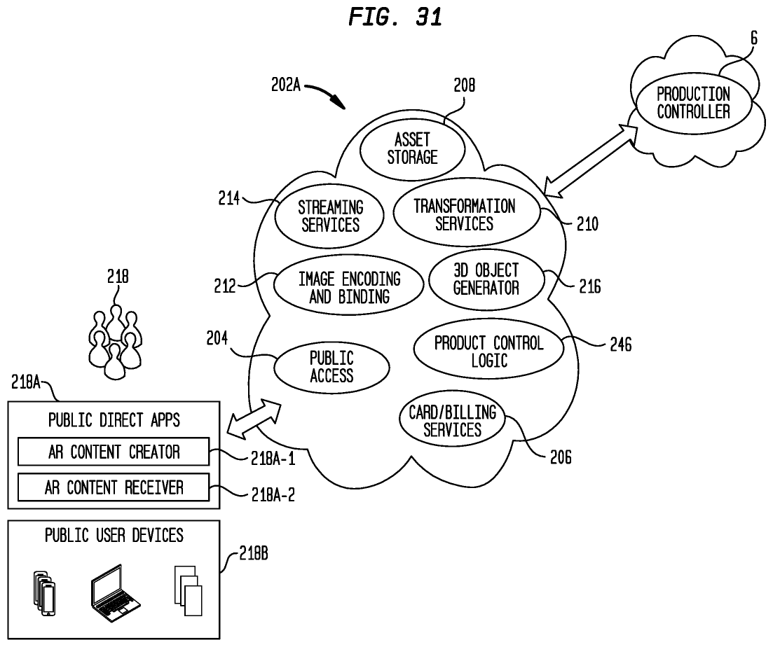

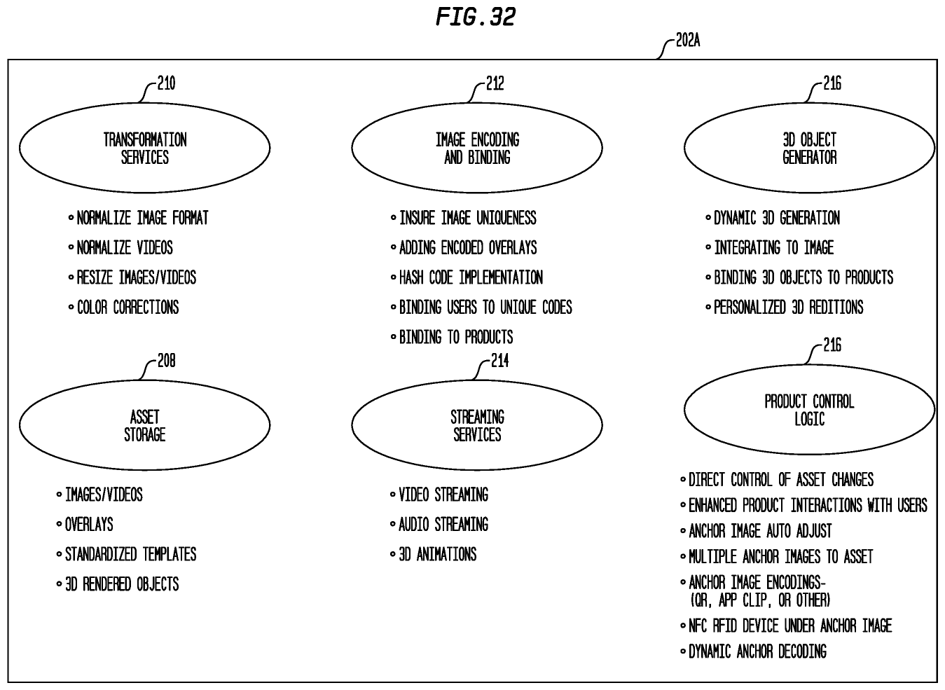

Turning now to FIG. 31, an augmented embodiment 202A of the AR controller 202 of FIG. 24 is depicted in which a product control logic component 246 provides various services that may be used to enhance the controller's AR functionality. As shown in FIG. 32, the services provided by the product control logic 246 may include a direct control of AR asset changes service 248, an enhanced product interactions with users service 250, an anchor image auto adjust service 252, a multiple anchor images to AR asset service 254, an anchor image encodings (QR, App Clip, or other) service 256, an NFC device under anchor image service 258, and a dynamic anchor decoding service 260.

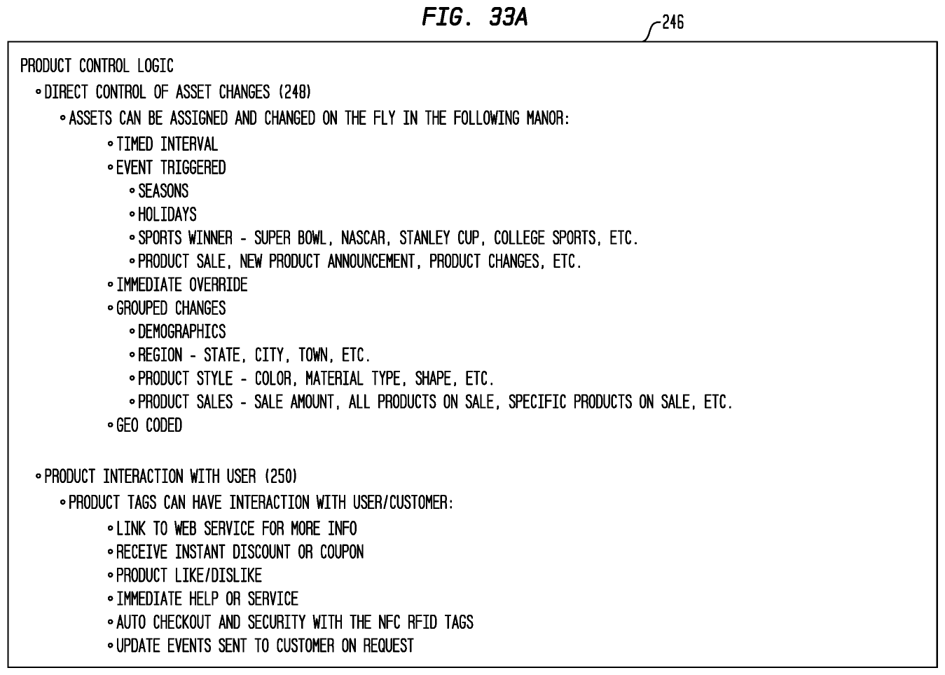

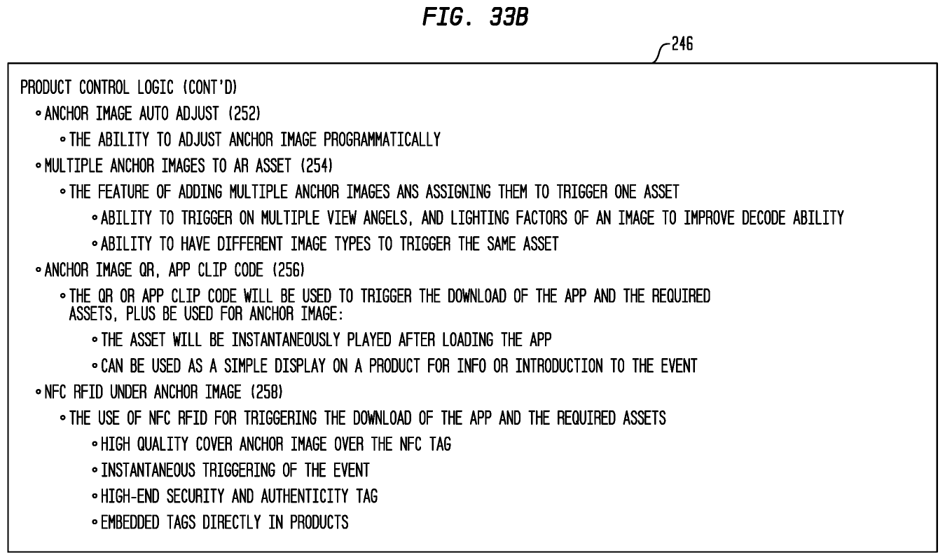

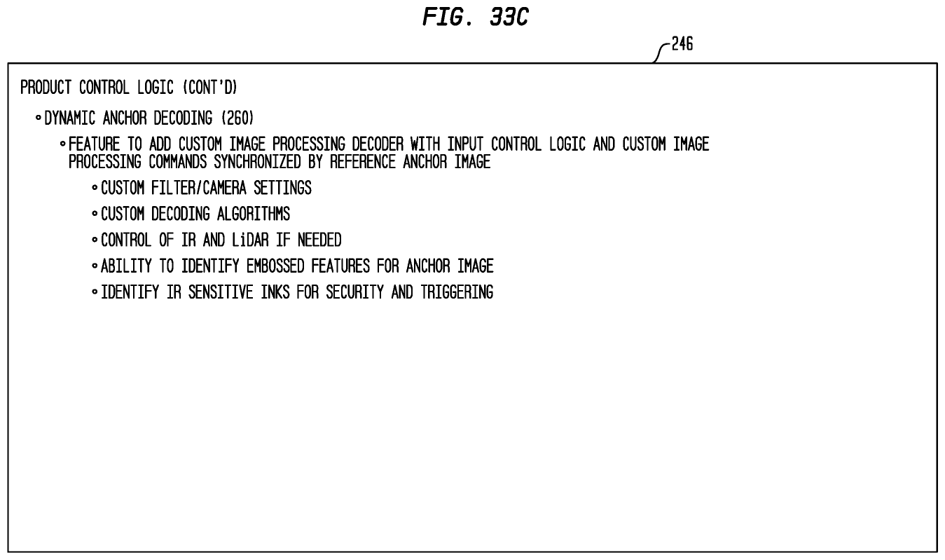

Turning now to FIGS. 33A-33C, the above-described services of the product control logic 246 are shown in more detail. As can be seen in FIG. 33A, the direct control of asset changes service 248 of the product control logic 246 allows AR assets to be assigned and dynamically changed on the fly, in an automated (or manual) manner, in response to specified events or conditions. For example, the product control logic 246 could be programmed to change the AR asset based on a timed interval or in response to specified events, such as a change of seasons, a holiday, the outcome of a sporting event, a product sale, a new product announcement, a product change, etc. An immediate override capability could also be provided that allows an AR asset change to be immediately implemented in a manner that overrides any existing AR asset change programming, such as in response to an asynchronous occurrence of local, regional, national or international significance, or for any other reason. Grouped changes to AR assets could be made for multiple articles that fall into definable categories or groups. Examples include products grouped by consumers demographics, products grouped by geographic region of distribution, products grouped by common style characteristics, products grouped by sales volume, pricing, discounts, etc. AR assets could also be changed using geocoding algorithms that update AR assets according to the geographic location where the article is situated when the AR content is viewed (such as by using the GPS functionality of the AR content display device), prompting for location information from the article recipient, or otherwise). It will be appreciated that algorithms for dynamically changing AR assets may be created at AR job template creation time (i.e., during the AR-enhanced print job request creation process) or at any time thereafter during the life-cycle of the article.

With continuing reference to FIG. 33A, the product interaction with users service 250 of the product control logic 246 provides a user interface that allows individuals who may be customers or users of the AR-enhanced article to have interactions involving the article, either prior to, during, or after product purchase. Example interactions may include but are not limited to linking to a web service where product information may be obtained, receiving a product coupon or discount, registering likes/dislikes or other commentary about the product, requesting immediate help or service regarding the product, receiving assistance with checkout for products with NFC RFID security tags, allowing product update notification events to be sent to customers on request, etc.

As shown in FIG. 33B, the anchor image auto adjust service 252 of the product control logic 246 provides the ability to adjust anchor images programmatically in order to improve subsequent anchor image recognition/decoding and display of an associated AR asset by AR content receiver applications. This service may be used to adjust both printed anchor images and reference anchor images. Adjustment of one or both of the printed and reference anchor images may be particularly advantageous when directly printing onto three-dimensional edible articles (e.g., food products, edible confections, vitamins and other consumable health products, pharmaceuticals, etc.). As previously noted, in such direct-to-article printing environments, the appearance of a printed anchor image may vary widely depending on the physical properties of the article, including its composition, manner of preparation, shape, size, etc. Such physical properties typically give rise to characteristic visual features such as hue, color, hardness, surface texture, height profile, to name but a few. For example, if a printed anchor image is composed of a primary image having a pale brown background color that is overlaid onto a brown cookie, the printed anchor image may have diminished contrast. In that case, adjusting the hue or color of the printed anchor image, or perhaps converting the reference anchor image to a grayscale image, may increase the AR content receiver application's ability to detect and decode the printed anchor image for reliable and repeatable AR content delivery. By way of further example, if the food article has a rough surface texture (such as some pastries, cakes, pies and other baked goods) or a highly-varying or patterned height profile (such as a waffle or waffle-cut product), one or both of the printed anchor image and the reference anchor image may need to be resized, reshaped, reoriented, modified as to hue, color or tint, enhanced with distinctive markings or features, or otherwise adjusted in order to generate an anchor image having sufficient signal-to-noise ratio to trigger a reliable and repeatable AR response.

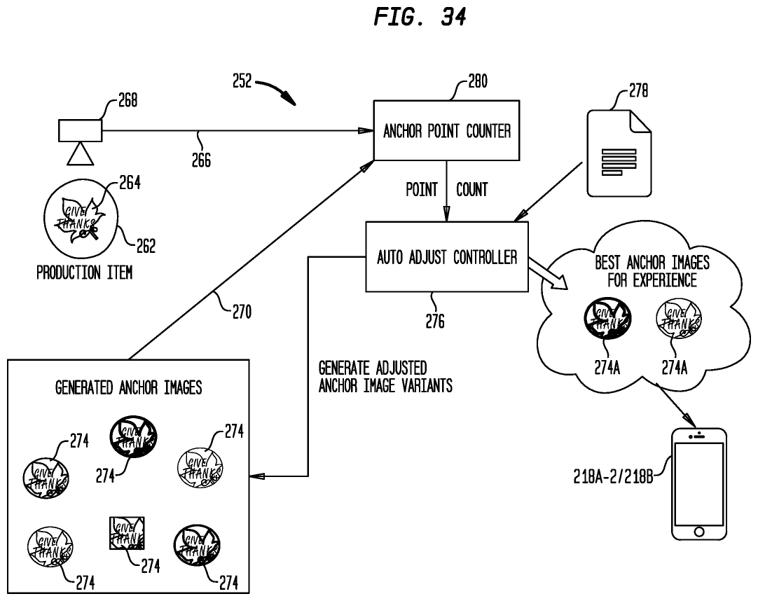

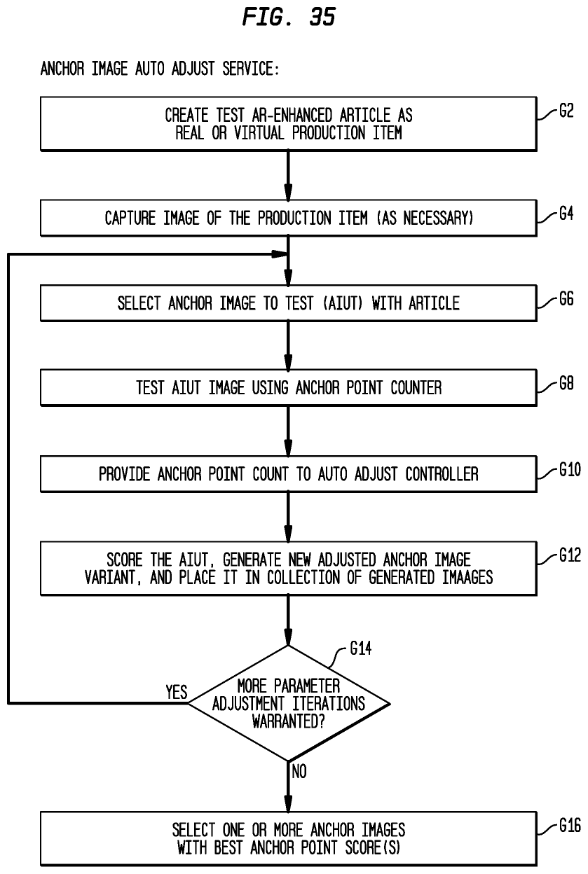

Example processing that may be performed programmatically by the anchor image auto adjust service 252 is shown in FIGS. 34 and 35. These figures depict how the production control logic 246 may adjust an anchor image by implementing a parameter optimization loop whose goal is to produce one or more adjusted anchor images that are most likely to provide the best AR content delivery experience for a particular AR-enhanced article. Although the illustrated processing is perhaps most advantageous for adjusting reference anchor images, the same or similar processing may also be used for adjusting printed anchor images.

As shown in the first block G2 of FIG. 35, an AR-enhanced test article may be created by printing an anchor image onto a physical article to create a real production item. Alternatively, the test article could be created by overlaying the original anchor image onto an image of the article to create a virtual production item. In FIG. 34, an example production item is shown as an edible article 262 (e.g., a cookie) with a printed anchor image 264 in the form of a Thanksgiving holiday message consisting of text and graphics displayed on the upper surface of the article. As shown in the second block G4 of FIG. 35, and with continuing reference to FIG. 34, an image of the production item 266 may be captured as necessary (e.g., by photographing it using a camera 268 or other image capture device). In an embodiment, the image capture operation may only be necessary if the production item is a real article with the anchor image printed thereon. If the production item is virtual, it will already constitute an image.

As shown in the third block G6 of FIG. 35, the parameter optimization loop may begin with the selection of an anchor image to test (hereinafter referred to as an AIUT or anchor-image-under-test). FIG. 34 depicts an AIUT 270 that may be selected from a collection 272 of generated anchor images 274 created by an Auto Adjust Controller 276 using a script of best parameter optimization methods 278 (discussed in more detail below). In an embodiment, the collection 272 of generated anchor images 274 may begin with an original anchor image that is identical to the one printed on the production item, and may thereafter be populated with variant anchor images in successive iterations of the parameter optimization loop.

As shown in the fourth block G8 of FIG. 35, and as additionally depicted in FIG. 34, an Anchor Point Counter 280 tests the ability of the AIUT to facilitate decoding of the captured image 266 of the production item. Using the AIUT, the Anchor Point Counter 280 may search the production item image for distinctive anchor points and count the number of such anchor points that are detected. In an embodiment, the Anchor Point Counter 280 may operate using one or more computer vision feature point detection algorithms, such as “BRISK” (“Binary Robust Invariant Scalable Keypoints”), “SURF” (Speeded Up Robust Features”) or “SIFT” (“Scale Invariant Feature Transform”), to identify and quantify the level of unique or otherwise distinctive information content in the production item image that can be reliably used to trigger AR content. In an embodiment, the output of the Anchor Pointer Counter may be a point count representing the number of detected anchor points.

As shown in the fifth block G10 of FIG. 35, the anchor point count information may be provided to the Auto Adjust Controller 276. As shown in the sixth block G12 of FIG. 35, the Auto Adjust Controller may use the anchor point count information to score the AIUT and save it (i.e., the AIUT and its associated score) in the collection 272 of generated anchor images 274, or elsewhere. The Auto Adjust Controller 276 may then make one or more adjustments to the AIUT that vary one or more of its image parameters to generate an adjusted anchor image that can be placed in the collection 272 of generated anchor images 274 for testing in a subsequent iteration of the parameter optimization loop. Examples of anchor image adjustments that can be made by the Auto Adjust Controller 276 include, but are not limited to, (1) adjusting an anchor image clipping path (e.g, to increase or decrease its information content by altering image size or shape), (2) performing color-to-gray scale translations, (3) performing foreground, background intensity adjustments, (4) adjusting contrast, sharpness, brightness, shadow, tint and/or hue, (5) performing alpha channel adjustments to turn-off/turn-on areas of the anchor image, (6) adding frames, rings, ticks or other distinctive visual information to the image to increase point count, etc. The end goal is to identify an optimal set of image parameters that maximizes anchor image decodability and AR asset identification.

In FIG. 34, it will be seen that the collection 272 of generated anchor images 274 includes anchor image variants having different foreground/background hues, colors or tints, grayscale shades, brightness levels, as well as different shapes and sizes. The Auto Adjust Controller 276 can perform parameter optimization using any suitable methodology, as may be specified by the script of best methods 278. Example parameter optimization techniques that may be used include, but are not limited to, brute force, hill climbing, random search, Bayesian optimization, etc.

As shown in the seventh block G14 of FIG. 35, the Auto Adjust Controller 276 may determine at the end of each pass through the parameter optimization loop whether further parameter adjustment iterations are warranted. If further iterations are likely to produce additional optimization, processing may return to the third block G6 of FIG. 35 for the next pass through the loop. If further iterations are not indicated, processing may advance to the eighth block G16 of FIG. 35, at which point one or more anchor images having anchor point scores that will provide the best AR experience may be selected. In FIG. 34, the anchor image auto adjust service 252 is shown to have generated two best adjusted anchor images 274A for use with the cookie 262 representing the AR-enhanced article to be printed. One is a circular color version of the anchor image. The other is a circular grayscale version of the anchor image. These adjusted anchor images 274A have been programmatically determined to have the greatest likelihood of generating reliable and repeatable AR content display on a receiving user's AR content display device 218B (e.g., the smartphone shown in FIG. 34) running an AR content receiver application 218A-2 when the display device captures an image of the production item cookie 262 (representing the AR-enhanced article).

As previously noted, the processing shown in FIG. 35 may be used advantageously to identify the most suitable reference anchor image(s) for decoding a particular printed anchor image on a particular AR-enhanced article. As further noted, the same or similar processing may be used to identify a most suitable printed anchor image for a particular AR-enhanced article. In that case, one or more of the adjusted anchor images shown in FIG. 34 could be used to print additional production items, each of which could be tested using the methodology of FIG. 35 to produce a most suitable adjusted anchor image. Ultimately, a combination representing an ideal printed anchor image to be printed on an AR-enhanced article and a most suitable reference anchor image for decoding the printed anchor image when printed on the AR-enhanced article could be identified and selected.

Returning now to FIG. 33B, the multiple anchor images to AR asset service 254 of the product control logic 246 provides the capability of adding multiple reference anchor images and assigning them to trigger a single AR asset. This capability may be used advantageously to further increase printed anchor image decoding capability, particularly when the AR-enhanced article is a three-dimensional edible article, such as a food product having non-de minimis length, width and height dimensions. The multiple reference anchor images may represent the same printed anchor image depicted from multiple angles and/or with different lighting factors, such as may be seen by the image capture component of an AR content display device when viewing the AR-enhanced article. Different reference anchor image types may also be used to trigger the same AR asset.

The rationale for the multiple anchor images to AR asset service 254 is that although an AR-enhanced article may be printed with a particular anchor image, the printed anchor image may vary in appearance from the standpoint of an image capture device depending on prevailing conditions. Conditions that can change the way a printed anchor image is seen by an image capture device include ambient light level and color, angle of viewing, distance from the AR-enhanced article, and other factors. The goal of the multiple anchor images to AR asset service 254 is to anticipate how the anchor image printed on an AR-enhanced article might appear under such varying conditions, replicate how the reference anchor image needed to trigger an AR response will appear under such conditions, and assign the replicated reference anchor images to the AR asset. In this way, when a receiving user's device captures an image of the AR-enhanced article, there is a greater likelihood that the captured printed anchor image will match either the original reference anchor image or one of its variants, each of which may be assigned to trigger the same AR asset.

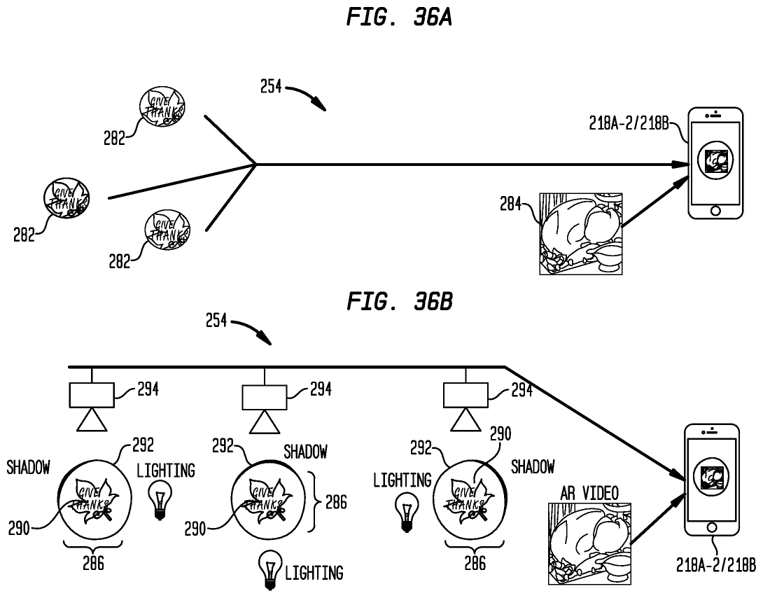

Turning now to FIGS. 36A and 36B, two different scenarios are shown in which multiple reference anchor images may be assigned to trigger the same AR asset. In FIG. 36A, three reference anchor image variants 282 representing a Thanksgiving holiday message containing text and graphics are assigned to an AR asset 284 representing a Thanksgiving holiday-themed video. These reference anchor image variants 282 differ from each other by virtue of their hue-color-tint characteristics, with one variant being a full color version of the printed anchor image, a second variant being a low contrast grayscale version of the printed anchor image, and a third variant being a high contrast grayscale version of the printed anchor image. These variants 282 may be used to represent how the anchor image printed on an AR-enhanced article (i.e., the Thanksgiving holiday message) will appear to a receiving user's AR content display device when the AR-enhanced article is encountered under different lighting conditions. For example, the full color variant may correspond to how the printed anchor image will appear to the AR content display device when the AR-enhanced article is encountered in a well-lit environment. On the other hand, the grayscale variants may correspond to how the printed anchor image will appear to the AR content display device when the AR-enhanced article is encountered in poorly lit environments.

In FIG. 36B, three reference anchor image variants 286 representing a Thanksgiving holiday message containing text and graphics are assigned to an AR asset 288 representing a Thanksgiving holiday-themed video. A printed anchor image 290 representing the Thanksgiving holiday message is printed on an AR-enhanced article 292 embodied as an edible article (e.g., a cookie). The reference anchor image variants 286 differ from each other by virtue of how the printed anchor image 290 printed on the AR-enhanced article 292 may be shadowed when the article is predominantly lighted from particular angles while being viewed by a receiving user's AR content display device 218B (via its camera or other image capture device shown schematically by reference number 294). FIG. 36B depicts three lighting examples in which the AR-enhanced article 292 is predominantly lit by a light source positioned at 90°, 180°, and 270°, respectively. Although not shown, a further reference anchor image variant could be generated at the 0° lighting position, or at any other position.

The multiple anchor images to AR asset service of the product control logic may be implemented in several ways. One method is to produce a test AR-enhanced article as real production item (as previously described in connection with FIGS. 34 and 35), and then capture images of the production item under different viewing conditions to produce the multiple reference anchor image variants. For example, the reference anchor image variants 282 of FIG. 36A could be generated by illuminating the production item with lighting of different intensities, and the reference anchor image variants 286 of FIG. 36B could be generated by illuminating the production item with lighting placed at different locations to create different light shadowing effects.

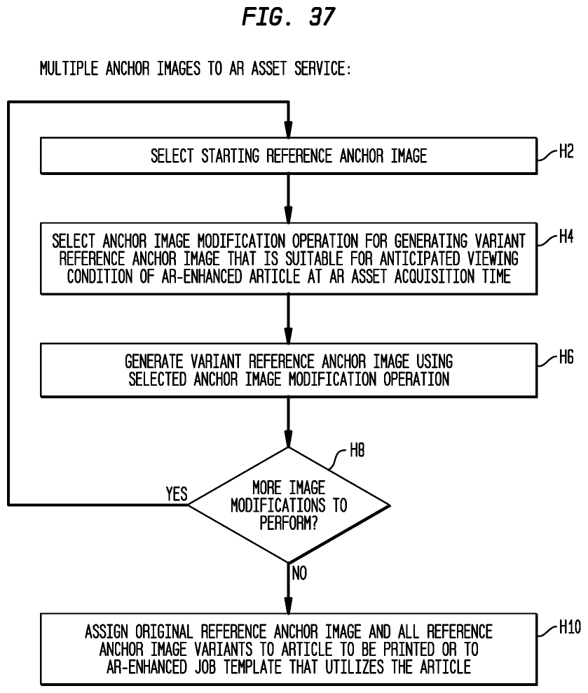

Another way to implement the multiple anchor images to AR asset service 254 is to used the programmatic processing shown in FIG. 37. In the first block G2 of FIG. 37, a reference anchor image that has been assigned to a particular AR asset is selected as a starting reference anchor image. If the anchor image auto adjust service 252 of FIGS. 34-35 is available for use, the starting reference anchor image could be an adjusted reference anchor image selected by that service for providing an optimal AR experience. In the second block G4 of FIG. 37, an anchor image modification operation is selected for generating a variant reference anchor image that is suitable for an anticipated viewing condition of the AR-enhanced article at AR asset acquisition time. Each reference anchor image modification operation may designed to generate the variant reference anchor image in a manner that emulates how the printed anchor image will appear when the anticipated viewing condition is encountered.

Examples anchor image modification operations may include, but are not limited to, operations that produce the reference anchor image variants 282 of FIG. 36A to emulate variable light level conditions, and operations that produce the reference anchor image variants 286 of FIG. 36B to emulate variable light shadowing conditions. Additional anchor image modification operations include, but are not limited to, (1) removing specific RGB colors from the raw data to eliminate interference patterns, (2) changing brightness and contrast to give the best AR experience, (3) using IR sensitive ink patterns in the IR frequency range, (4) using embossing to produce some or all of the anchor image, and (5) adding frames, fades, highlights, etc.

In the third block G6 of FIG. 37, the variant reference anchor image is generated using the anchor image modification operation selected in the second block of FIG. 37. In the fourth block G8 of FIG. 37, a determination is made whether additional anchor image modification operations remain to be performed to produce additional reference anchor image variants. If there are such additional anchor image modification operations, processing may return to the first block G2 of FIG. 37. In that case, the reference anchor image that is selected as the starting anchor image may be the original reference anchor image that existed at the commencement of the multiple anchor image to AR asset processing, or it may be the reference anchor image variant that was most recently generated, or generated during some prior iteration of the process. If there are no additional anchor image modification operations left to perform, processing may proceed to the fifth block G10 of FIG. 37, wherein the original reference anchor image and all of the generated reference anchor image variants may be assigned to the AR-enhanced article to be printed or to a completed AR-enhanced job template that utilizes that article.

Returning now to FIG. 33B, the anchor image QR, App Clip code service 256 of the product control logic 246 may be used to trigger the download of an AR content receiver application 218A-2 on the receiving user's AR content display device 218B, together with the AR asset and any related assets needed for AR content display, such as the reference anchor image(s) associated with the AR-enhanced article. In order to utilize this service, the anchor image printed on the AR-enhanced article may include a standardized encoded image, such as a QR code and/or App Clip code. In some embodiments, the standardized encoded image may represent the entirety of the printed anchor image, such that the printed anchor image consists of nothing more than a QR code, an App Clip code, or some other standardized encoded image. In other embodiments, standardized encoded image may represent only a portion of the printed anchor image, such that the printed anchor image includes other image content. For example, the printed anchor image might consist of a user-selected image with a QR code, an App Clip code, or other standardized encoded image incorporated into a portion of a user-selected image, or placed adjacent to such a user-selected image, or superimposed on the user-selected image as an encoded overlay image, or otherwise combined with the user-selected image. In such an embodiment, the QR code, App Clip code or other standardized encoded image could be printed with an ink that is not detectable using visible light imaging but can be detected using non-visible light imaging, such as an IR-sensitive ink that can be detected using Infrared imaging. In still other embodiments, an AR-enhanced article may have more than one printed anchor image, any of which could include a standardized encoded image.

A QR code, App Clip code or other standardized encoded image could also be printed on a printable medium formed by a substrate that is distinct from the AR-enhanced article itself. In that case, the printable medium may be physically associated with the AR-enhanced article in some way, such as by way of attachment or connection thereto, one example being a printable medium provided by packaging for the AR-enhanced article.

As is known, standardized encoded images such as QR codes and App Clip codes may be encoded to serve as a locator, identifier, or tracker that links to a website or an application, one or both of which may be associated with the AR Controller or a third party resource such as the Google Play Store or the Apple App Store. Incorporating such encoded images in the printed anchor image of an AR-enhanced article (or on a printable medium associated with the AR-enhanced article) increases the user-friendliness of the AR experience by providing functionality such as automatically downloading an AR content receiver application to program a device (e.g., smartphone, tablet, etc.) so that it can be made to function, on the fly, as an AR content display device. All that is needed for such automatic downloading is for the receiving user's device to detect the standardized encoded image and process its encoding (e.g., using conventional smartphone processing capability). Such standardized encoded images may also be used to trigger the product interaction with user service previously described in connection with FIG. 33A.

With continuing reference to FIG. 33B, the NFC RFID under anchor image service 258 of the product control logic 246 may be used in conjunction with a printed anchor image that is printed on a printable medium embedded with RFID technology, such as an NFC tag. In an embodiment, the printable medium may be a substrate that is distinct from the AR-enhanced article itself. In that case, the printable medium may be physically associated with the AR-enhanced article in some way, such as by way of attachment or connection thereto. One example of a printable medium that may be used for this application would be a removable (or non-removable) sticker, label or tag made from paper or other material that is adhered (or otherwise affixed) to the article. Another example printable medium would be a printable packaging surface, which could be a sticker, label or tag as mentioned above, but also a substrate that forms part of a box, container, wrapper, header card, backer card, blister card, or any other packaging component. In each instance, the NFC tag may be embedded in the printable medium in any suitable manner, such as by placing it underneath or within the printable medium so that it is hidden from view.

In an embodiment, the printable medium may be a substrate that forms part of the AR-enhanced article itself. For example, the AR-enhanced could be an item of apparel, including but not limited to footwear. In that case, an NFC tag or other RFID device could be placed within a material that forms the article, or on an inside surface of the material, and an anchor image could be printed on an outside surface of the material so as to be situated above or otherwise in close proximity to the RFID device. Thus, there may be any number of applications in which it is desirable to associate an RFID device with an image printed directly on the article. It should therefore be understood that printable media for use with the NFC RFID under anchor image service 258 of the product control logic 246 include direct-to-article print substrates, i.e., AR-enhanced articles themselves.

The NFC RFID under anchor image service 258 may be used to trigger the download of an AR content receiver application on the receiving user's AR content display device 218B, together with the AR asset and any related assets needed for AR content display, such as the reference anchor image(s) associated with the AR-enhanced article. An NFC tag or other RFID device may also be encoded with information needed to trigger an AR event or to invoke other functionality (such as the product interaction with user service 250 previously described in connection with FIG. 33A).

Utilizing a printable medium that is embedded with RFID technology and printed with an anchor image has several advantages. For example, the printable medium may be formed of a material (e.g., paper) that provides an ideal substrate for printing high quality anchor images that can be placed on or otherwise physically associated with many different types of articles. This may improve the accuracy of the image processing used to decode the printed anchor image. In addition, the embedded RFID device triggers AR asset detection via RF communication of digital information, such that computer vision-assisted decoding is not the only available mechanism for triggering the AR asset. Although digital decoding is also provided by using QR or App Clip codes (as previously described), those codes are visible to the human eye (if printed with human visible ink), whereas an embedded NFC tag is hidden from human viewing. The NFC-embedded anchor image medium may thus provide a more pleasing aesthetic. Finally, the RFID device can used for other purposes, such as to trigger the product interaction with user service 250, and particularly its security and authenticity tag functionality (as previously described in connection with FIG. 33A).

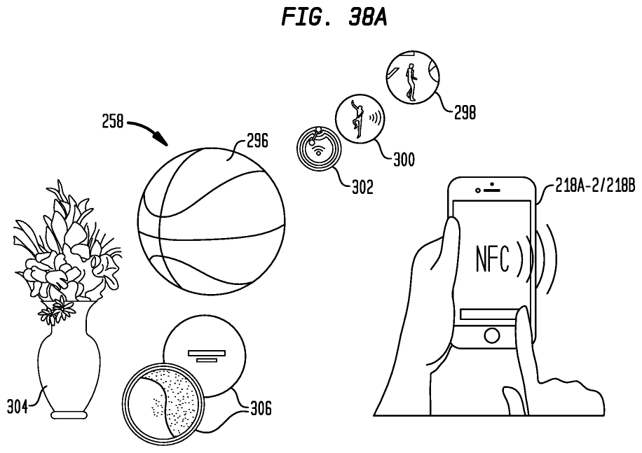

Turning now to FIG. 38, the NFC RFID under anchor image service 258 supports an NFC tap mode of operation 290 in which an NFC-embedded printable medium may be printed with both an anchor image and an NFC tap mode symbol, thereby signifying that the printable medium is associated with an NFC tap mode interface. In response to seeing the NFC tap mode symbol, a receiving user may activate the NFC tag read capability of their AR content display device (if present) to activate the AR asset associated with the AR-enhanced article. FIG. 38 illustrates an example scenario in which the product to be AR-enhanced is a basketball 296 and the AR asset represents a video 298 depicting basketball game play. Adhered to the basketball 296 is a sticker 300 having an embedded NFC tag 302 (e.g., affixed to its lower surface) and an upper surface printed with both an NFC tap mode symbol and an anchor image depicting a basketball player shooting a basket. As noted, this is but one example of an AR-enhanced article that may utilize an NFC tag (or other RFID device) and an associated printable medium printed with an anchor image. FIG. 38 also illustrates two additional examples of products that can be AR-enhanced to support NFC tap mode activation of an associated AR asset, one being a vase 304 carrying a floral arrangement and the other being a cosmetic case 306.

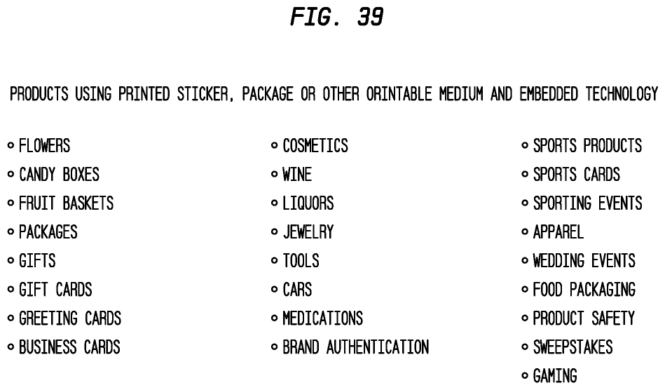

Turning now to FIG. 39, various examples are shown of AR-enhanced articles and other end uses for which AR-enhancement using printable media could be utilized in lieu of direct-to-article printing. As previously described in connection with FIG. 38, examples of such printable media include, but are not limited to, stickers, labels or tags affixed to products, product packaging, and articles themselves. Such printable media could have an anchor image printed thereon, and the anchor image could include (or consist of) a standardized encoded image. The printable media could alternatively or additionally include some form of embedded technology, such as an NFC tag or other RFID device.

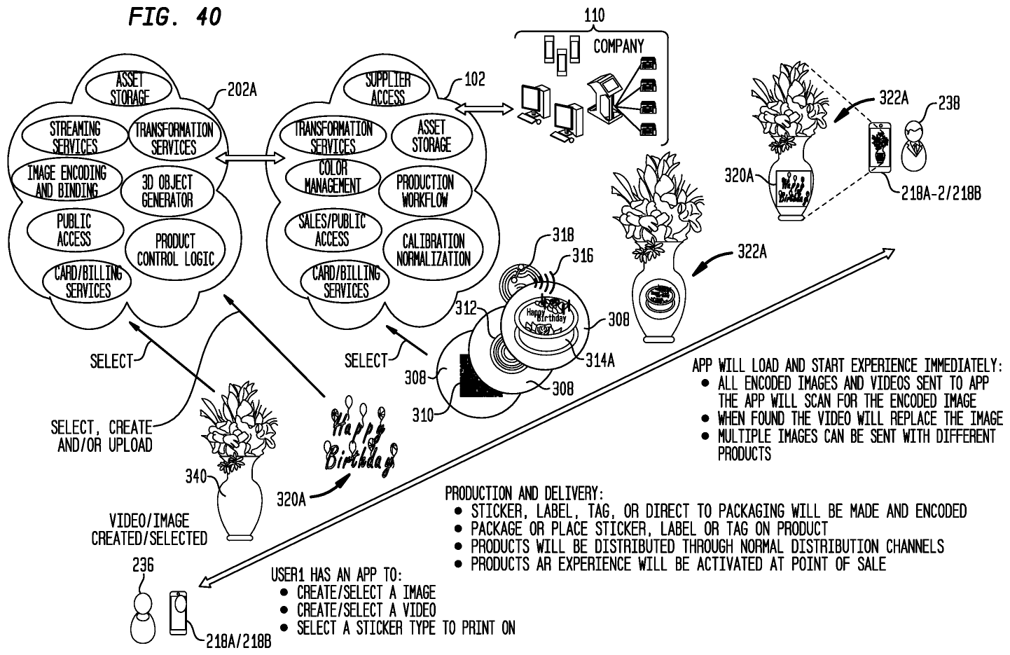

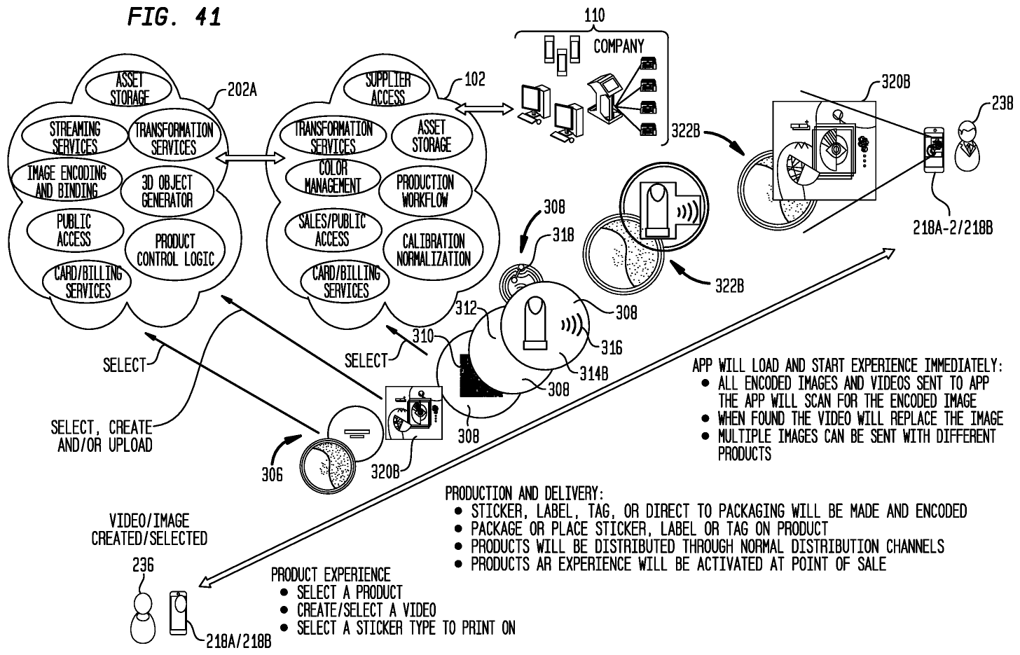

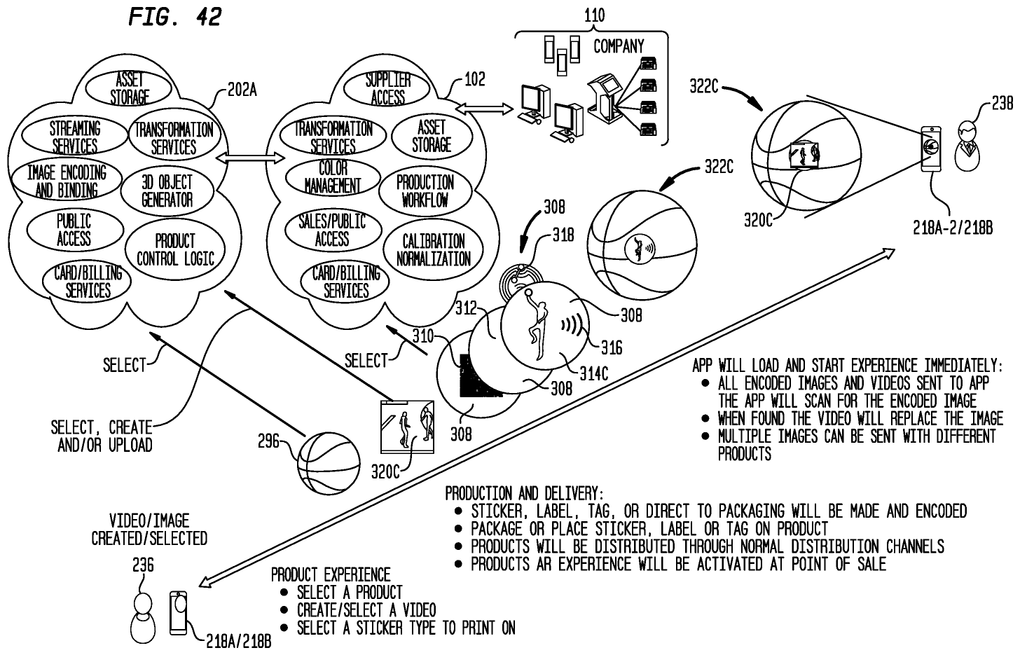

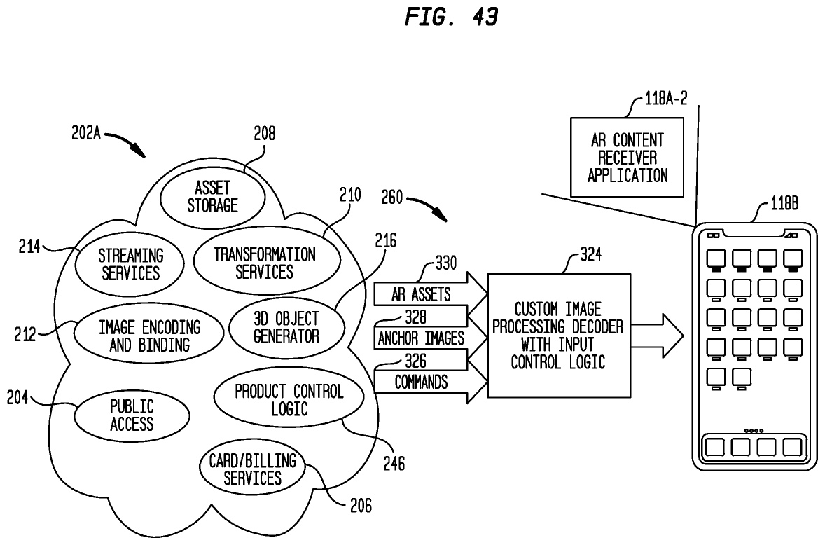

Turning now to FIGS. 40-42, flow diagrams are depicted to illustrate examples of AR-enhanced print job request/production print run workflows utilizing the AR controller 202A of FIGS. 24-26, the global print manager 102 of FIGS. 13-19, and a print production company 110 running a print production system (such as the scanning and print control system 2 of FIGS. 1-12). The workflows of FIGS. 40-42 are similar in most respects to the workflow described above in connection with the FIG. 27, with the main difference being that the anchor images are printed on printable media that are distinct from the AR-enhanced article itself, namely stickers applied to products or product packaging (in lieu of direct-to-article printing), as described above in connection with FIG. 39. FIGS. 40-42 respectively illustrate workflows for producing the three AR-enhanced articles shown in FIG. 38, with FIG. 40 depicting AR-enhancement of the vase/floral arrangement 304, FIG. 41 depicting AR-enhancement of the cosmetic product 306, and FIG. 42 depicting AR-enhancement of the basketball 296. In each example, the printable medium is a sticker 308, but could also be a printable substrate provided by a product packaging component (e.g., as previously described). Each example depicts three different choices of anchor image, one being a QR code anchor image 310, another being an App Clip code anchor image 312, and still another being a user-selected image 314 (i.e., a birthday cake 314A in FIG. 40, a lipstick image 314B in FIG. 41, and a basketball image 314C in FIG. 42) with an NFC tap mode symbol 316 whose printable medium includes an embedded NFC tag 318. These anchor image/printable medium implementations may be used alone or together in any combination with each other.

In FIG. 40, the AR asset is a Birthday-themed video 320A. The resultant AR-enhanced article 322A includes the vase/floral arrangement 304 affixed with the sticker 308. The sticker 308 may be printed with any of the anchor images shown in FIG. 40 (alone or in combination), namely, the anchor image 314A that depicts a birthday cake (together with the NFC tap mode symbol 316 overlying an embedded NFC tag 318), the QR code anchor image 310, or the App Clip anchor image 312. When the AR-enhanced article 322A is viewed by the receiving user's AR content display device 218B, the AR content receiver application 218A-2 running thereon will display the Birthday-themed video 320 superimposed over the sticker 308.

In FIG. 41, the AR asset is a Cosmetic/Beauty-themed video 320B. The resultant AR-enhanced article 322B includes the cosmetic case 306 affixed with the sticker 308. The sticker 308 may be printed with any of the anchor images shown in FIG. 41 (alone or in combination), namely, the anchor image 314B that depicts a lipstick tube (together with the NFC tap mode symbol 316 overlying an embedded NFC tag 318), the QR code anchor image 310, or the App Clip anchor image 312. When the AR-enhanced article 322B is viewed by the receiving user's AR content display device 218B, the AR content receiver application 218A-2 running thereon will display the cosmetic/beauty-themed video 320B superimposed over the sticker 308.

In FIG. 42, the AR asset is a basketball-themed video 320C. The resultant AR-enhanced article 322C includes the basketball 296 affixed with the sticker 308. The sticker 308 may be printed with any of the anchor images shown in FIG. 42 (alone or in combination), namely, the anchor image 314C that depicts a basketball player shooting a basket (together with the NFC tap mode symbol 316 overlying an embedded NFC tag 318), the QR code anchor image 310, or the App Clip anchor image 312. When the AR-enhanced article 322C is viewed by the receiving user's AR content display device 218B, the AR content receiver application 218A-2 running thereon will display the basketball-themed video 320C superimposed over the sticker 308.

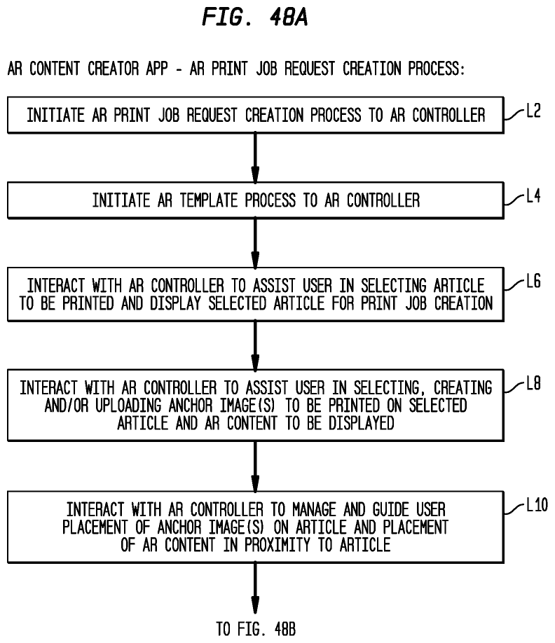

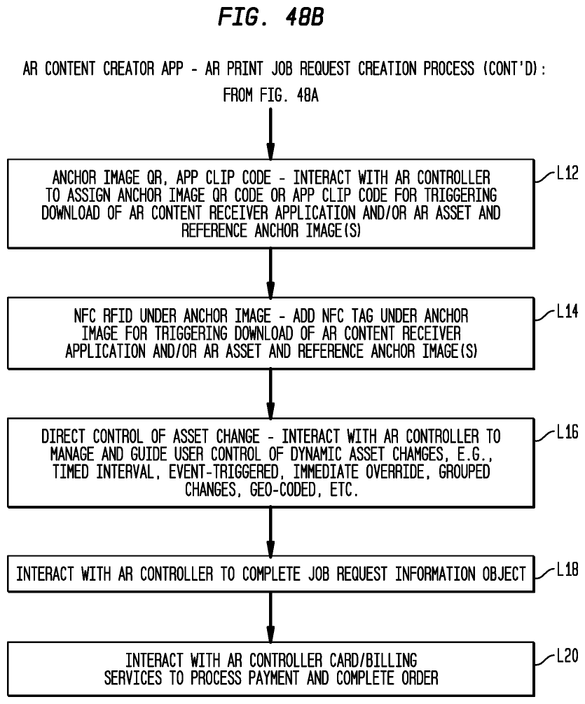

Further details of example processing that may be performed in FIGS. 40-42 are described in more detail below in connection with FIGS. 48-50.

Turning now to FIG. 33C, the dynamic anchor decoding service 260 of the product control logic 246 may be used to improve the decoding of a printed anchor image for a particular AR-enhanced article by a receiving user's AR content display device 118B. The improved anchor image decoding service 260 helps the AR content receiver application 118A-2 optimize its detection of the anchor image printed on the AR-enhanced article by dynamically provisioning custom image processing commands that are optimized for use with a particular AR-enhanced article printed with a particular particular anchor image in conjunction with a particular AR asset (or assets). The improved anchor image decoding service 260 also helps the AR content receiver application display the AR-enhanced article with image properties that will be best suited for displaying the AR content associated with the article. This improves the AR experience presented to the receiving user.

As will now be described, the dynamic anchor decoding service 260 realizes these goals by installing a custom image processing decoder on the receiving user's AR content display device 118B. The custom image processing decoder represents a reprogrammed version of the image processing subsystem on the receiving user device 118B so that, as noted above, it is optimized for viewing a particular AR-enhanced article printed with a particular anchor image in conjunction with a particular AR asset (or assets). The custom decoder includes input control logic that can be invoked by the AR content receiver application 118A-2 in order to utilize custom image acquisition and decoding settings, parameters and algorithms that can help the AR content receiver application process the printed anchor image and display the associated AR asset. As described in more detail below, the custom imaging decoder may add functionality such as (1) custom filter/camera settings, (2) control of IR (Infrared) and LiDAR (Light Detection And Ranging) if needed, (3) ability to identify embossed features for anchor image, and (4) ability to identify IR sensitive inks for security and triggering, and more.

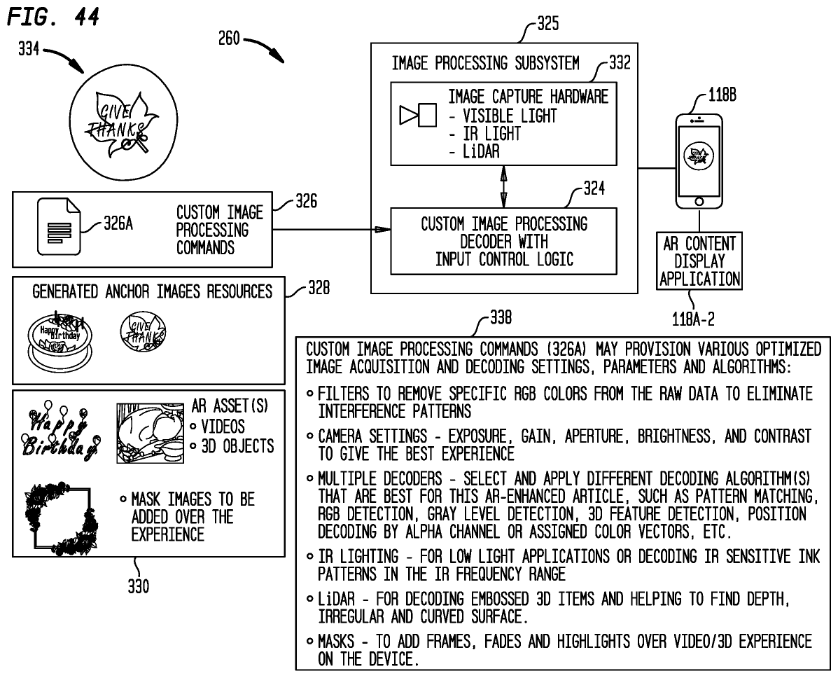

FIGS. 43-44 illustrate the above-summarized functionality of the dynamic anchor decoding service 260. FIG. 43 depicts the AR controller 202 interacting with a receiving user's smartphone (or other device) 118B on which an AR content receiver application 118A-2 has been installed. The product control logic 246 of the AR controller communicates with the AR content receiver application 118A-2 in order to reprogram the native image processing subsystem of the receiving user device to provision it with the custom image processing decoder 324 for use in decoding a particular AR-enhanced article. The custom image processing decoder 324 may be provisioned by a selected set of one or more custom image processing commands 326 that are synchronized by associated reference images 328 for the AR-enhanced article that may be sent (uploaded) by the product control logic 246 to the AR content receiver application 118A-2 running on the receiving user device 118B. The custom image processing commands 326 assigned to a particular AR-enhanced article and synchronized to its associated reference anchor image(s) 328 may be called in when the reference anchor image(s) is/are being used for decoding the AR-enhanced article's printed anchor image(s) by the AR content receiver application 118A-2. FIG. 43 further depicts the AR controller 202 downloading the AR asset 330 that defines the AR experience provided by the AR-enhanced article, along with any additional AR-related assets that may be needed to display the associated AR content (such as mask images for dynamically adding frames, fades or highlights over or around the AR content).

As shown in FIG. 44, the custom image processing commands 326 used to provision the custom image processing decoder 324 alter the native programming (e.g., firmware) of one or more components of the image processing subsystem 325 of the receiving user device 118B. For modern smartphones, such image processing components may include an ISP (Image Signal Processor) together with other computational photography resources, including but not limited to, an AI-capable VP (Vision Processor) or an NPU (Neural Processing Unit). Such image processing components process image information output by the image capture hardware 332 of the device. For modern smartphones, the image capture hardware may include a camera that can detect visible light images, IR (Infrared) light images, and/or operate as a LiDAR (Light Detection And Ranging) scanner that supports three-dimensional mapping.

FIG. 44 illustrates example features of the dynamic anchor decoding service 260 that may be used to enhance printed anchor image detection and AR content presentation. The AR-enhanced article in this example is a cookie 334 on which is printed an anchor image 326 containing graphics and text that convey a Thanksgiving holiday-themed message. As previously described, the augmented reality controller 202 may store AR-enhanced job template information for each AR-enhanced print job. This information may include, for each AR-enhanced article, a set of one or more reference anchor images 328 and a set of one or more AR assets 330, with the latter possibly including videos, 3D objects, and possibly mask images to be dynamically added over or around the AR experience in order to frame it. This template information collectively defines a unique AR experience that will be provided by the AR-enhanced article. For the dynamic anchor decoding service 260, a selected set of the custom image processing commands 326 may be associated with the AR-enhanced article by storing (or otherwise associating) the commands with the AR-enhanced job template (e.g., as additional template information for the AR-enhanced article).

In an embodiment, the custom image processing commands 326 may be written and stored in an anchor processing command script 326A in XML format or the like. The anchor processing command script 326A may be formatted so that custom image processing commands 326 which are synchronized to a particular reference anchor image 328 may be readily identified and provisioned by the AR content receiver application 118A-2 when it is uses that reference anchor image for decoding the AR-enhanced articles printed anchor image. If there are multiple reference anchor images 328, the AR content receiver application 118A-2 may access the anchor processing command script 326A as each reference anchor image is invoked for decoding, identify the custom image processing commands 326 that are synchronized to that reference anchor image, and provision those commands.

The custom image processing commands 326 may be created so as to implement a set of optimized image acquisition and decoding settings, parameters and algorithms 338 that will provide the best anchor image acquisition, decoding, and AR content display result for the AR-enhanced article. These commands 326 may be used to reprogram the image processing subsystem of a receiving user's AR content display device 118B to provide the custom image processing decoder 324 that implements the optimized image acquisition and decoding settings, parameters and algorithms 338 for the benefit of the receiving user.

As shown in FIG. 44, examples of the custom image processing commands 326 that may be used to implement the optimized image acquisition and decoding settings, parameters and algorithms 338 include, but are not limited to, (1) one or more commands for adding filters to remove specific RGB colors from raw image data to eliminate interference patterns, (2) one or more commands for modifying camera settings such as exposure, gain, aperture, brightness, and contrast to provide the best AR experience, (3) one or more commands for selecting and applying the best decoding algorithm (or combination of algorithms) for the AR-enhanced article from a set of multiple decoders that may perform different types of decoding, such as pattern matching, RGB detection, gray level detection, 3D feature detection, and position decoding by alpha channel or assigned color vectors, (4) one or more commands for utilizing IR lighting for low light applications or decoding of IR sensitive ink patterns in the IR frequency range, (5) one or more commands for utilizing LiDAR for decoding anchor images formed in whole or in part by embossing (e.g., as embossed 3D images or text) and/or helping to find depth and detect irregular and curved surfaces, and (6) one or more commands for utilizing mask images to dynamically add frames, fades and highlights over or around the video/3D or other AR experience presented on the receiving user device. Such mask images may be associated with the AR-enhanced article after it is printed, and made available for download by the AR content receiver application for display on a receiving user's AR content display device during AR content presentation.

The input control logic of the custom image processing decoder 324 provides an interface to the decoder that the AR content receiver application 118A-2 may use to control the decoder's settings, parameters and algorithms 338. In this way, the AR content receiver application 118A-2 may control all aspects of anchor image acquisition, decoding and AR content display in any manner that it sees fit.

In an embodiment, a decoder optimization method may be used to identify custom image processing commands 326 that are to be synchronized to a particular reference anchor image 328. As part of this optimization method, a test version of an AR-enhanced article may be printed with an anchor image. The test article may then be scanned and decoded using a test AR content display device (not shown) and a selected reference anchor image. During decoding, different image acquisition and decoding settings, parameters or algorithms 338 may be provisioned on the test device to determine which techniques produce the best anchor image acquisition, decoding and AR content display result. The test results may be evaluated in any suitable manner, such as by assessing image quality, detection error rates, or other suitable quantitative and/or qualitative metrics.

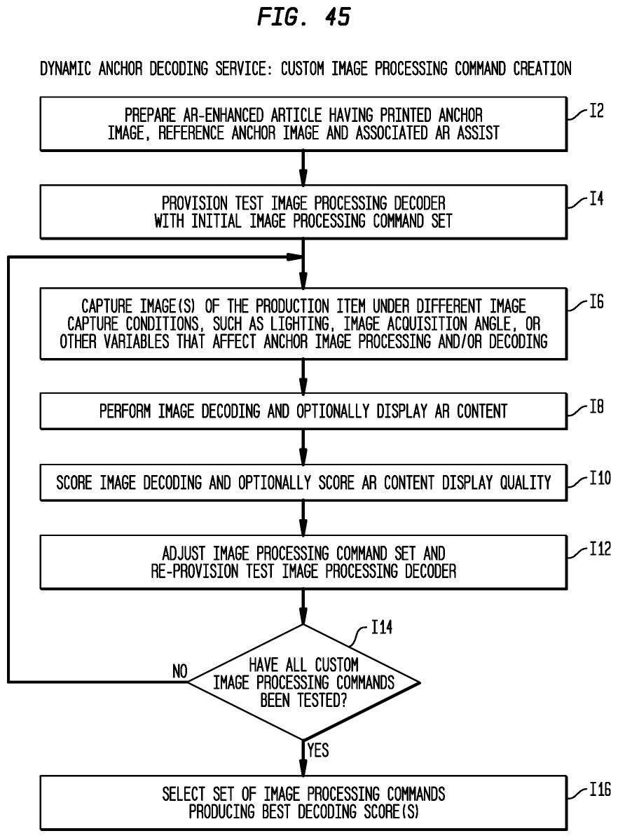

The foregoing testing used to identify custom image processing commands for an AR-enhanced article may be performed as trial and error processing using a technique that is analogous to the parameter optimization technique used by the anchor image auto adjust service 252 (see FIG. 33B) to identify optimal anchor images. An example of this trial and error processing is shown in FIG. 45. In an embodiment, at least a portion of this processing may be performed using hardware and software processing resources that are the same or similar to those shown in FIG. 34, including the production image capture equipment, the anchor point counter and the auto adjust controller, but with a different script of best methods being used to program the auto adjust controller.

In the first block 12 of FIG. 45, an AR-enhanced article to test is prepared. The AR-enhanced article may be a real production item having an anchor image printed thereon, one or more associated reference anchor images, and an AR asset. For example, the AR-enhanced article shown in FIG. 44 (the cookie 334) may be used. In the second block 14 of FIG. 45, an initial image processing decoder is provisioned in the image processing subsystem 325 of a test apparatus (not shown) using an initial image processing command set. In an embodiment, this may be a standard image processing command set as may be implemented by an image processing subsystem of a standard smartphone.

In the third block 16 of FIG. 45, one or more images of the production item are captured under different image capture conditions, such as lighting level or color, imaging acquisition angles, or other variables that affect anchor image processing and/or decoding, such as shadowing or the like. In the fourth block 18 of FIG. 45, image decoding is performed on the captured images using a selected reference anchor image. In an embodiment, the AR content associated with the AR-enhanced article may be displayed on a display device of the test apparatus (if the apparatus is so equipped). In the fifth block 110 of FIG. 45, and one or more decoding scores are generated (e.g., one for each image capture condition). The decoding scoring may be performed using any suitable techniques and benchmarks. For example, in an embodiment, the anchor point counting technique used by the above-described anchor image auto adjust service could be used to score the image processing decoder's ability to detect the anchor image. In an embodiment wherein AR content is displayed the fourth block 18 of FIG. 45, the quality of the AR content display experience may be optionally scored in the fifth block 110 of FIG. 45 using a suitable graphical scoring method.

Irrespective of the manner in which the image decoding and AR content display quality are tested and scored, the final result of the operations performed in the fifth block 110 of FIG. 45 will be a determination of the effectiveness of the image processing command set being used to image-capture the production item and decode it using a selected reference anchor image. This determination of effectiveness could be represented by a set of individual scores representing each of the tested image capture conditions used to image the production item, or by a single score representing all of the tested image capture conditions, or by some other scoring representation.

In the sixth block 112 of FIG. 45, the image processing command set currently being used is adjusted. Adjustment options including adding one or more new commands, removing one or more existing commands, or replacing one or more existing commands with one or more new commands. The adjusted image processing command set is then used to re-provision the test image processing decoder of the test apparatus.

In the seventh block 114 of FIG. 45, a check is made to determine whether all custom image processing commands to be tested have been tested. If not, processing returns to the third block HI of FIG. 45. Otherwise, processing proceeds to the eighth block 116 of FIG. 45.

In the eighth block 116 of FIG. 45, a set of custom image processing commands that produces the best decoding score result (and optionally the best AR content display score result) is selected. The selected set of custom image processing commands may then be stored as part of an AR-enhanced job template (e.g., as additional template information for the AR-enhanced article). As previously noted, the object used to store the custom image processing commands may be embodied as an anchor processing command script 326A written in XML format or the like.

As also previously noted, the custom image processing commands used to provision a custom image processing decoder may be synchronized to particular a reference anchor image. If an AR asset has multiple reference anchor images assigned to it, the processing of FIG. 45 may be used to identify the custom image processing commands that are most suitable for each reference anchor image. The AR content receiver application 118A-2 may then call in the custom image processing commands needed for each reference anchor image when it is used for decoding the printed anchor image of an AR-enhanced article.

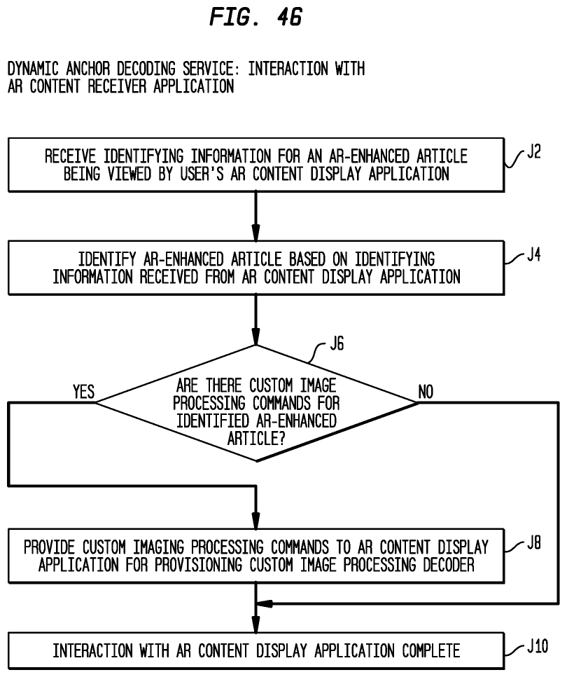

Turning now to FIG. 46, example processing is shown that may be performed by the dynamic anchor decoding service 260 when interacting with an AR content receiver application 118A-2 that requests custom image processing commands 326 for use in providing an AR experience for an AR-enhanced article. In the first block J2 of FIG. 46, the product control logic 246 receives identifying information about the AR-enhanced article being viewed (or to be viewed) by the AR content receiver application 118A-2. The identifying information could be any type of information that identifies the AR-enhanced article to the AR content receiver application. By way of example, this information could be printed on product packaging, a packaging insert, on the product itself, or in other ways. The identifying information could take many forms, such as a standardized encoding (e.g., QR code, App Clip code, etc.), an RFID code, a product name or other identifier, a product number, a print job number, information about the receiving user, etc. Alternatively, the identity of the AR-enhanced article may already known to the AR content receiver application 118A-2 (e.g., as a result of being programmed into the application).

In the second block J4 of FIG. 46, the dynamic anchor decoding service 260 identifies the AR-enhanced article based on the identifying information received from the AR content receiver application 118A-2. In the third block J6 of FIG. 46, a determination is made whether the identified AR-enhanced article has any associated custom image processing commands 326. If it does, the anchor processing command script 326A (or other stored resource) containing the custom image processing commands 326 may be provided to the AR content receiver application 118A-2, per the fourth block J8 of FIG. 46. Otherwise, the interaction between the dynamic anchor decoding service 260 and the AR content receiver application 118A-2 is complete in the fifth block J10 of FIG. 46. At this time, the AR controller 202 may also provide the AR content receiver application 118A-2 with the reference anchor image(s) associated with the AR-enhanced article, including any variant reference anchor images that may have been generated by the anchor image auto adjust service 252 (see FIG. 33B) or the multiple anchor images to AR asset service 254 (see FIG. 33B). The AR controller 202 may also at this time provide the AR content receiver application 118A-2 with the AR asset associated with the AR-enhanced article (and possibly other assets such as mask images), as shown by reference number 330 in FIG. 44.

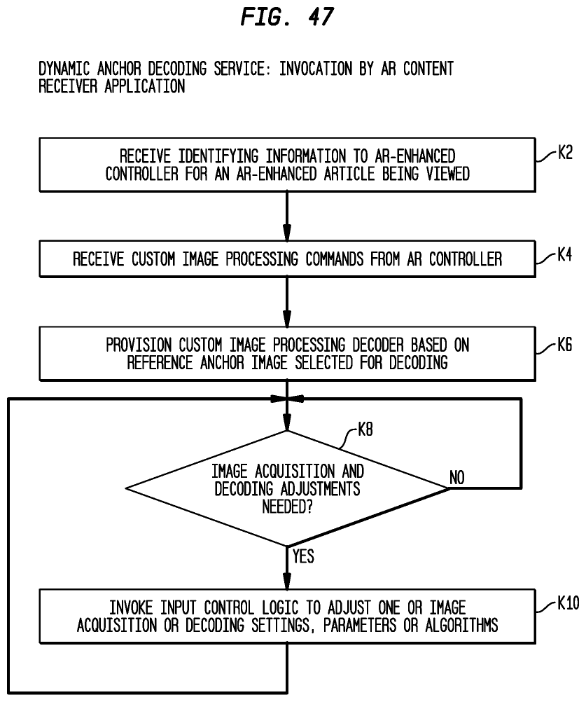

Turning now to FIG. 47, example processing is shown that may be performed by the receiving user's AR content receiver application 118A-2 to invoke the dynamic anchor decoding service 260. In the first block K2 of FIG. 47, the AR content receiver application 118-A provides identifying information about an AR-enhanced article being viewed (or to be viewed) to an AR controller 202 whose product control logic 246 implements the dynamic anchor decoding service 260. As described above in connection with the first block J2 of FIG. 46, the identifying information may take different forms.

In the second block K4 of FIG. 47, the AR content receiver application 118A-2 receives custom image processing commands 326 from the AR controller. As discussed in connection with FIG. 46, the custom image processing commands 326 may be received as an anchor processing command script 326A (or other stored resource) that contains the custom image processing commands.

In the third block K6 of FIG. 47, the AR content receiver application 118A-2 provisions a custom image processing decoder 324 on one more components of its image processing subsystem 325 based on the reference anchor image to be used for decoding. As previously set forth, such image processing subsystem components may include an ISP (Image Signal Processor) together with other computational photography resources, including but not limited to, an AI-capable VP (Vision Processor) or an NPU (Neural Processing Unit).

In the fourth and fifth blocks K8 and K10 of FIG. 47, the AR content receiver application 118A-2 evaluates the quality and decodability of the image(s) acquired by the image capture hardware 332 of the receiving user's AR content display device 118A-2. If there are any image quality or decoding issues, the AR content receiver application 118A-2 may invoke the input control logic of the custom image processing decoder 324 to make appropriate image processing adjustments. If AR content is being displayed while such adjustments are being made, the AR content receiver application 118A-2 may also evaluate the quality of the AR experience to as part of its image adjustment operations.

Assuming the custom image processing decoder 324 is provisioned as shown in FIG. 44, the AR content receiver application 118A-2 may adjust any of the listed image acquisition and decoding settings, parameters and algorithms 338. To implement such adjustments, the AR content receiver application 118A-2 may assess the AR-enhanced article image(s) using its native camera scene capture, advanced scene processing and display conveniences. As previously discussed, the AR content receiver application may be provisioned with such functionality using existing AR toolsets, such as Apple's ARKit developer platform for IOS devices or Google's ARCore developer platform for Android devices.

For example, if the AR content receiver application 118A-2 determines that there are interference patterns in the captured printed anchor image, it can instruct the custom image processing decoder 324 to apply filters to remove specific colors (e.g, RGB) from the raw image data in order to eliminate the interference patterns.

By way of further example, if the AR content receiver application 118A-2 determines that corrections for image characteristics such as brightness, contrast, saturation, color balance or gamma are required for the captured printed anchor image, it can instruct the custom image processing decoder 324 to adjust camera settings such as exposure, gain, aperture, brightness and contrast to provide a better experience.

By way of further example, if the AR content receiver application 118A-2 determines that there are issues in regard to decoding the captured printed anchor image, it can instruct the custom image processing decoder 324 to try multiple decoders and select the best decoding algorithm (or combination of algorithms) for the AR-enhanced article. Example decoding algorithms including pattern matching, RGB detection, gray level detection, 3D feature detection, and position decoding by alpha channel or assigned color vectors.

By way of further example, if the AR content receiver application 118A-2 determines that the available light level is too low for optimal image capture and decoding, or is programmed with knowledge that the AR-enhanced article has been printed with an IR sensitive ink pattern (e.g., to provide a QR code, an App Clip code, or other standardized encoding, it can instruct the custom image processing decoder 324 to employ IR light detection or pattern recognition in the IR band.

By way of further example, if the AR content receiver application 118A-2 determines that adequate decoding of the captured printed anchor image cannot be achieved by using other image acquisition and decoding settings, parameters and algorithms, it can instruct the custom image processing decoder 324 to employ LiDAR detection. This may be especially useful for decoding embossed 3D anchor image content, or for helping to find depth, irregular and curved surfaces, or for verifying a 3D finger print for the 3D anchor image.

By way of further example, the AR content receiver application 118A-2 may instruct the custom image processing decoder 324 to add AR image content that enhances the AR experience provided by the AR asset. Such AR image content may include mask images that add frames, fades and/or highlights over or around the AR content being displayed on the receiving user's AR content display device 118B. These mask images can be downloaded from the AR controller 202 by the AR content receiver application 118A-2. They may be applied automatically by the AR content receiver application 118A-2, or conditionally in response to either user input or a determination by the AR content receiver application that such mask images are needed in order to enhance the AR experience.

In an embodiment, the processing implemented in the fourth and fifth blocks K8 and K10 of FIG. 47 may continuously loop throughout the duration of the AR content viewing session. This will allow the AR content receiver application 118A-2 to make image acquisition and decoding adjustments in response to image quality changes that occur during the AR content viewing session. Such image quality changes could result from a variety of events or circumstances, such as changes in lighting, changes in viewing angle, or other conditions that affect image quality and AR content display.

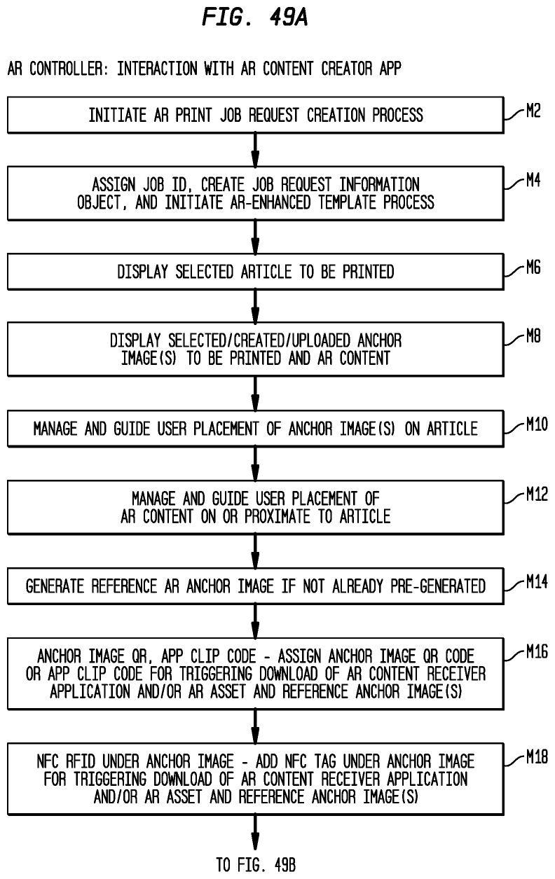

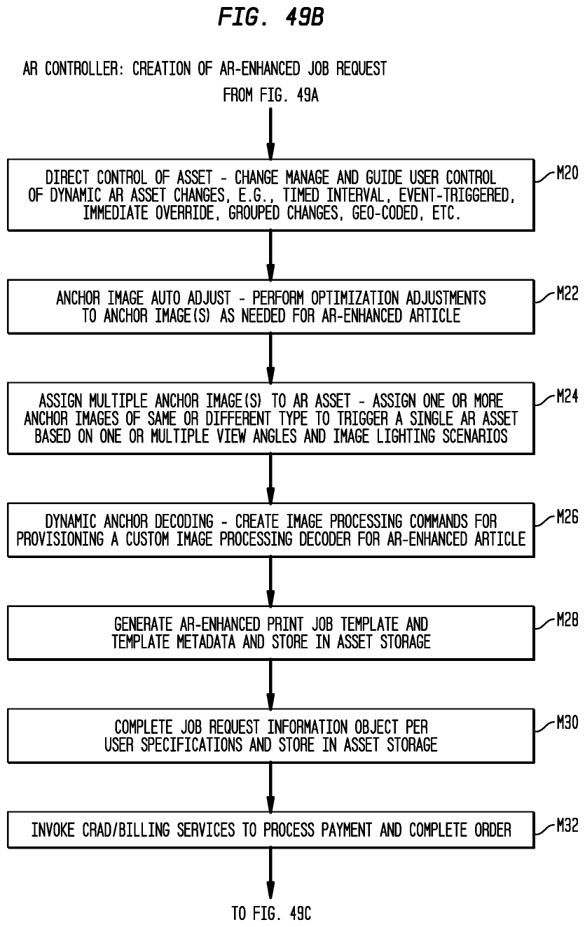

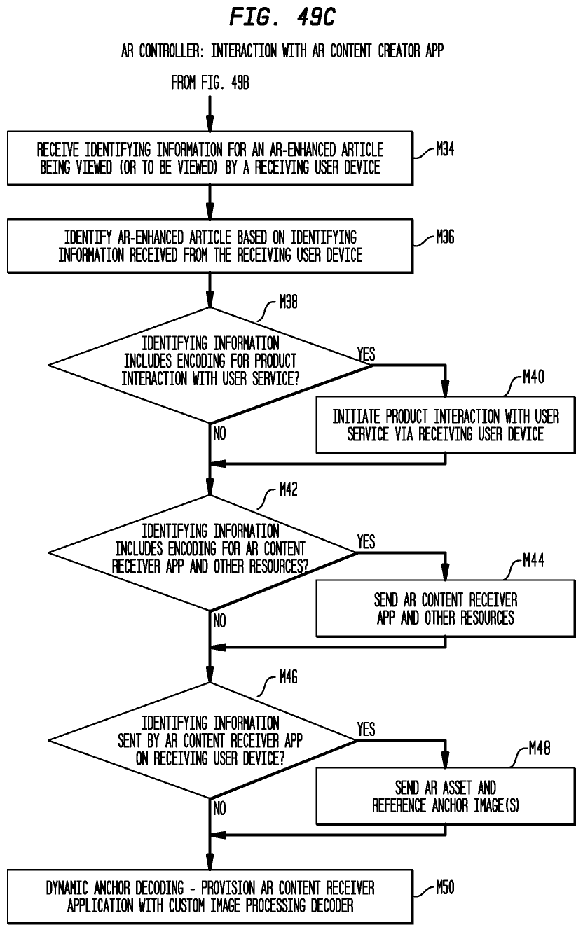

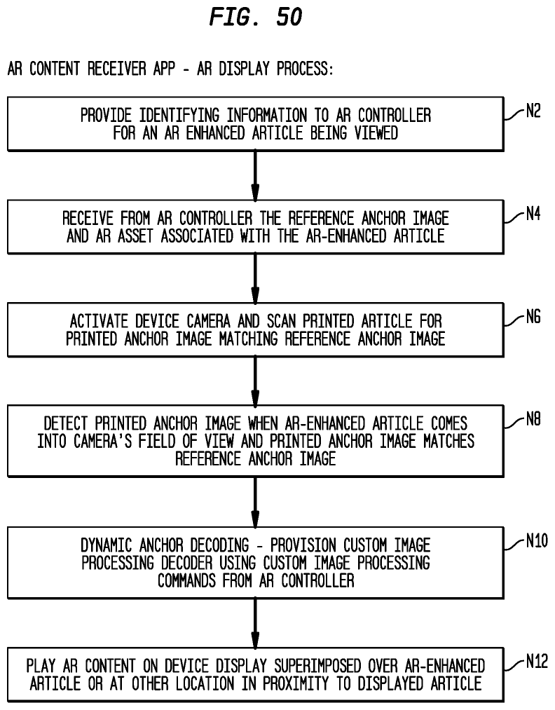

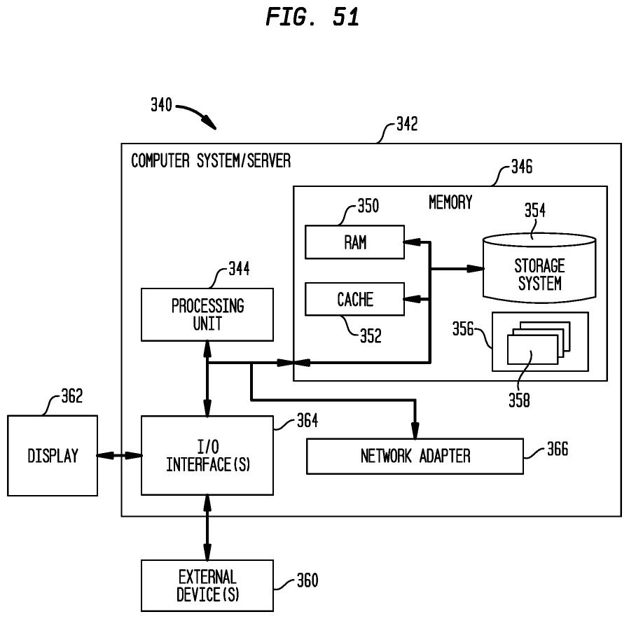

Turning now to FIGS. 48-50, the example processing previously described in connection with the AR content creator application 118A-1 of FIG. 28, the AR controller 202 of FIG. 29, and the AR content receiver application 118A-2 of FIG. 30, will now be revisited in order to consider how the services provided by the product control logic 246 of FIGS. 31-47 may be utilized to provide augmented functionality. FIGS. 48A-48B depict an augmented embodiment of the AR content creator application 118A-1. FIGS. 49A-49C depict the augmented embodiment 202A of the AR controller 202. FIG. 50 depicts an augmented embodiment of the AR content receiver application 118A-2.

In FIGS. 48A-48B, the processing performed by the AR content creator application 118A-1 is mostly the same as described above in connection with FIG. 28. As such, processing operations that remain unchanged will not be re-described here. Where the AR content creator application processing of FIGS. 48A-48B differs from the AR content creator application processing of FIG. 28 is found in the first, second and third blocks L12, L14 and L16 of FIG. 48B.

The first block L12 of FIG. 48B adds optional processing that may be provided by the anchor image QR, App Clip code service 256 described above in connection with FIG. 33B. Specifically, the first block L12 of FIG. 48B represents an optional interaction between the AR content creator application 118A-1 and the AR controller 202A that invokes the anchor image QR, App Clip service 256. In an embodiment, this interaction may be in response to a user request for assignment of a QR code, an App Clip code, or other standardized encoding to a printed anchor image for triggering the download of an AR content receiver application 118A-2 and/or an AR asset and one or more reference anchor images. The processing of the first block L12 of FIG. 48B is optional because in some embodiments, the AR controller 202A could automatically add a QR code, an App Clip code, or other standardized encoding without user input.

The second block L14 of FIG. 48B adds optional processing that may be provided by the NFC RFID under anchor image service 258 described above in connection with FIGS. 33B and 38. Specifically, the second block L14 of FIG. 48B represents an optional interaction between the AR content creator application 118A-1 and the AR controller 202A that invokes the NFC RFID under anchor image service 258. In an embodiment, this interaction may be in response to a user request for addition of an NFC tag to be placed under an anchor image for triggering the download of an AR content receiver application and/or an AR asset and one or more reference anchor images. The processing of the second block L14 of FIG. 48B is optional because in some embodiments, the AR controller 202A could automatically add an NFC tag without user input.

The third block L16 of FIG. 48B adds processing that may be provided by the direct control of asset change service 248 described above in connection with FIG. 33A. Specifically, the third block L16 of FIG. 48B represents an interaction between the AR content creator application 118A-1 and the AR controller 202A that invokes the direct control of asset change service 248 to manage and guide user control of dynamic asset changes, such as timed interval asset changes, event-triggered asset changes, immediate override asset changes, grouped asset changes, geocoded asset changes, etc.

In FIGS. 49A-49C, the processing performed by the AR controller 202A includes certain processing described above in connection with FIG. 29 (which will not be repeated here), as well as additional processing not previously described. Where the AR controller processing of FIGS. 49A-49C differs from the AR controller processing of FIG. 29 is found in the addition of the eighth and ninth blocks M16 and M18 of FIG. 49A, the first, second, third and fourth blocks M20, M22, M24 and M26 of FIG. 49B, and all of the blocks of FIG. 49C.

FIG. 49A sets forth example processing that may be performed by the AR controller 202A when interacting with the AR content creator application 118A-1. The eighth block M16 of FIG. 49A adds processing provided by the anchor image QR, App Clip code service 256 described above in connection with FIG. 33B. Specifically, the eighth block M16 of FIG. 49A represents the AR controller 202A invoking the anchor image QR, App Clip service 256 to assign a QR code, an App Clip code, or other standardized encoding to an anchor image for triggering the download of an AR content receiver application 118A-2 and/or an AR asset and one or more reference anchor images. In some embodiments, this operation may be performed as a result of a user request sent from the AR content creator application 118A-1. In other embodiments, the AR controller 202A could automatically add a QR code, an App Clip code, or other standardized encoding without user input.

The ninth block M18 of FIG. 49A adds processing that may be provided by the NFC RFID under anchor image service 258 described above in connection with FIGS. 33B and 38. Specifically, the ninth block M18 of FIG. 49A represents the AR controller 202A invoking the NFC RFID under anchor image service 258 to specify the addition of an NFC tag that is to be placed under an anchor image for triggering the download of an AR content receiver application 118A-2 and/or an AR asset and one or more reference anchor images. In some embodiments, this operation may be performed as a result of a user request sent from the AR content creator application 118A-1. In other embodiments, the AR controller 202A could automatically add the NFC tag specification (to the print job request) without user input.

FIG. 49B sets forth example processing that may be performed by the AR controller 202A (alone or in combination with the global print manager 102) when creating an AR-enhanced job request (e.g., during or following interaction with the AR content creator application 118A-1).

The first block M20 of FIG. 49B adds processing that may be provided by the direct control of asset change service 248 described above in connection with FIG. 33A. Specifically, the first block M20 of FIG. 49B represents an interaction between the AR controller 202A and the AR content creator application 118A-1 that invokes the direct control of asset change service 248 to manage and guide user control of dynamic asset changes, such as timed interval asset changes, event-triggered asset changes, immediate override asset changes, grouped asset changes, geocoded asset changes, etc.

The second block M22 of FIG. 49B adds processing that may be performed by the anchor image auto adjust service 252 described above in connection with FIGS. 33B and 34. Specifically, the second block M22 of FIG. 49B represents the AR controller 202A performing optimization adjustments to one or more anchor images selected for printing on an article or to be used as reference anchor images. If the user supplies anchor image(s) using the AR content creator application 118A-1, the optimization adjustments may be performed when the AR-enhanced job template is created or at any time prior to completion of the associated AR-enhanced print job request. On the other hand, in cases where the user selects a pre-existing anchor image provided by the AR controller (e.g., from a library of pre-existing anchor images), the optimization adjustments may have been previously performed by the anchor image auto adjust service 252.

The third block M24 of FIG. 49B adds processing provided by the multiple anchor images to AR asset service 254 described above in connection with FIGS. 33B, 36A-36B and 37. Specifically, the third block M24 of FIG. 49B represents the AR controller 202A assigning one or more reference anchor image variants of the same or different type to trigger a single AR asset based on one or multiple view angles and image lighting scenarios. If the reference anchor image variants derive from an image supplied by a user, the variants may be created when the AR-enhanced job template is created or at any time prior to the completion of the associated AR-enhanced print job request. On the other hand, in cases where the user selects a pre-existing anchor image provided by the AR controller (e.g., from a library of pre-existing anchor images), variant reference anchor images may have been previously created by the multiple anchor images to AR asset service 254.

The fourth block M26 of FIG. 49B adds processing provided by the dynamic anchor decoding service 260 described above in connection with FIGS. 33C and 43-46. Specifically, the fourth block M26 of FIG. 49B represents the AR controller 202A creating custom image processing commands 326 for provisioning a custom image processing decoder 324 for the AR-enhanced article. As previously described, the custom image processing commands may be associated with the AR-enhanced article, and synchronized to particular reference anchor images.

FIG. 49C illustrates example processing that may be performed by the AR controller 202A (alone or in combination with the global print manager 102) when interacting with a receiving user's device 118B, which may or may not be initially running an AR content receiver application 118A-2.

In the first block M34 of FIG. 49C, the AR controller 202A receives identifying information about an AR-enhanced article being viewed (or to be viewed) by a receiving user device 118B. As previously discussed in connection with the first block J2 of FIG. 46, the identifying information may take different forms.

Reiterating, the identifying information could be any type of information that identifies the AR-enhanced article. By way of example, this information could be printed on product packaging, a packaging insert, on the product itself, or in other ways. The identifying information could take many forms, such as a standardized encoding (e.g., QR code, App Clip code, etc.), an RFID code, a product name or other identifier, a product number, a print job number, information about the receiving user, etc. Alternatively, if the receiving user's device 118B is currently running an AR content receiver application 118A-2, the identity of the AR-enhanced article may already known (e.g., as a result of being programmed into the application).

In the second block M36 of FIG. 49C, the AR controller 202A identifies the AR-enhanced article based on the identifying information from the receiving user device 118B.

In the third and fourth blocks M38 and M40 of FIG. 49C, the AR controller 202A initiates the product interaction with user service 250 of FIG. 33A in the event that the identifying information from the receiving user device 118B includes an encoding for that service. As previously described, the product interaction with user service 250 may be triggered in response a receiving user device 118B detecting a QR code, an App Clip code or standardized encoding, or an RFID tag. During the operations performed in the third and fourth blocks M38 and M40 of FIG. 49C, the receiving user device 118B may or may not be running an AR content receiver application 118A-2 capable of interacting with the AR-enhanced article.

In the fifth and sixth blocks L42 and L44 of FIG. 49C, the AR controller 202A sends (uploads) the AR content receiver application 118A-2 and other resources (such as an AR asset and one or more reference anchor images) to the receiving user device 118B in the event that the identifying information includes an encoding for such resources. As previously described, events that may trigger the AR controller 202A to send an AR content receiver application 118A-2 and/or and AR asset and one or more reference anchor images include a receiving user device 118B detecting a QR code, an App Clip code or other standardized encoding, or an RFID tag. During the operations performed in the fifth and sixth blocks M42 and M44 of FIG. 49C, the receiving user device 118B is assumed not to be already running an AR content receiver application 118A-2 capable of interacting with the AR-enhanced article.

In the seventh and eighth blocks M46 and M48 of FIG. 49C, the AR controller 202A sends (uploads) an AR asset and one or more reference anchor images associated with an AR-enhanced article to the receiving user device 118B in response to the identifying information having been sent by an AR content receiver application 118A-2 that is already currently running on the receiving user device and capable of interacting with the AR-enhanced article.

In the ninth block M50 of FIG. 49C adds processing provided by the dynamic anchor decoding service 260 described above in connection with FIGS. 33C and 43-46. Specifically, the sixth block M50 of FIG. 49C represents the AR controller 202A using custom image processing commands 326 associated with the AR-enhanced article to provision an AR content receiver application 118A-2 on the receiving user device 118B. If the custom image processing commands 326 are implemented as a command script 326A, this script may be sent (uploaded) to the receiving user's AR content receiver application 118A-2, which then provisions the image processing subsystem 325 of the receiving user device 118B to implement a custom image processing decoder 324.

In FIG. 50, the processing performed by the AR content receiver application 118A-2 is mostly the same as described above in connection with FIG. 30. As such, processing operations that remain unchanged will not be re-described here. Where the AR content receiver application processing of FIG. 50 differs from the AR content receiver application processing of FIG. 30 is found in the addition of the first and fifth blocks N2 and N10 of FIG. 50.

In the first block N2 of FIG. 50, the AR content receiver application 118A-2 provides identifying information about an AR-enhanced article being viewed to the AR controller 202A. This communication represents the sending side of the information-receiving operation described above in connection with the first block M34 of FIG. 49C. As such, the identifying information sent in the first block N2 of FIG. 50 could be any of the various types of identifying information received in the first block M34 of FIG. 49C.

The fifth block N10 of FIG. 50 adds processing that may be performed by the AR content receiver application 118A-2 to interact with the custom anchor decoding service 260 described above in connection with FIGS. 33C and 44-46. Specifically, the processing of the fifth block N10 of FIG. 50 represents the AR content receiver application 118A-2 receiving a set of one or more custom image processing commands 326 from the AR controller 202A and provisioning a custom image processing decoder 324. As previously described, the sending of custom image processing commands 326 may be initiated by either the AR controller 202A or the AR content receiver application 118A-2.

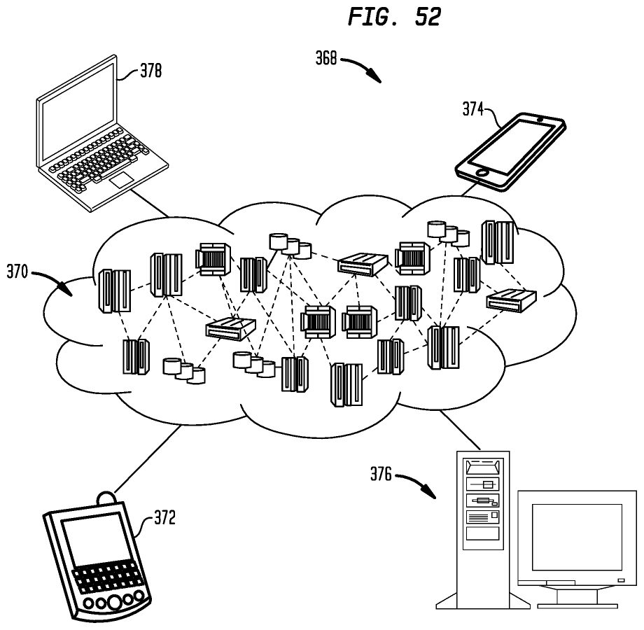

Turning now to FIG. 51, a schematic of example data processing functionality 340 is shown that may be used to implement any of the various computing devices and systems disclosed herein, such as the scanner/production controller 4/6, the global print manager 102, the AR controllers 202 and 202A, and the various user devices and applications. The data processing functionality of FIG. 51 may represent either a standalone device or system, or a node in a multi-node computing environment, such as a cloud computing node. The illustrated data processing functionality 340 is only one example of a suitable computing device, system or node, and is not intended to suggest any limitation as to the scope of use or functionality of embodiments of the invention described herein. Regardless, the data processing functionality 340 is capable of being implemented and/or performing any of the functions, processes, services and operations set forth hereinabove.

In the data processing functionality 340 of FIG. 51, there may be a computer system/server 342 that is operational with numerous general purpose or special purpose computing system environments or configurations. Examples of well-known computing systems, environments, and/or configurations that may be suitable for use with the computer system/server 342 include, but are not limited to, personal computer systems, server computer systems, thin clients, thick clients, hand-held or laptop devices, smartphones, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system/server 340 may be described in the general context of computer system-executable instructions, such as program modules, being executed by a computer system. Generally, program modules may include routines, programs, objects, components, logic, data structures, and so on that perform particular tasks or implement particular abstract data types. The computer system/server 340 may be practiced in distributed cloud computing environments where tasks are performed by remote processing devices that are linked through a communications network. In a distributed cloud computing environment, program modules may be located in both local and remote computer system storage media including memory storage devices.

By way of example only, the computer system/server 342 of FIG. 51 is shown in the form of a general-purpose computing device. Thus embodied, the components of the computer system/server 342 may include, but are not limited to, one or more processors or processing units 344, a system memory 346, and a bus 348 that couples various system components including system memory 346 to processor 344. The bus 348 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The computer system/server 342 may include a variety of computer system readable media. Such media may be any available media that is accessible by computer system/server 342, and may include both volatile and non-volatile media, removable and non-removable media.

The system memory 346 can include computer system readable media in the form of volatile memory, such as random access memory (RAM) 350 and/or cache memory 352. The computer system/server 342 may further include other removable/non-removable, volatile/non-volatile computer system storage media. By way of example only, a storage system 354 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 348 by one or more data media interfaces. As will be further depicted and described below, the memory 336 may include at least one program product 356 having a set (e.g., at least one) of program modules 358 that are configured to carry out the functions of embodiments of the invention.

A program/utility, having a set (at least one) of program modules, may be stored in memory 346 by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of embodiments of the invention as described herein.

The computer system/server 342 may also communicate with: one or more external devices 360 such as a keyboard, a pointing device, a display 362, etc.; one or more devices that enable a user to interact with computer system/server; and/or any devices (e.g., network card, modem, etc.) that enable computer system/server to communicate with one or more other computing devices. Such communication can occur via Input/Output (I/O) interfaces 364. Still yet, the computer system/server 342 can communicate with one or more networks such as a local area network (LAN), a general wide area network (WAN), and/or a public network (e.g., the Internet) via a network adapter 366. As depicted, the network adapter communicates with the other components of the computer system/server via the bus 348. It should be understood that although not shown, other hardware and/or software components could be used in conjunction with the computer system/server 342. Examples, include, but are not limited to: microcode, device drivers, redundant processing units, external disk drive arrays, RAID systems, tape drives, and data archival storage systems, etc.

Turning now to FIG. 52, an illustrative cloud computing environment 368 is depicted. As shown, the cloud computing environment 368 includes one or more cloud computing nodes 370 with which local computing devices used by cloud consumers, such as, for example, a personal digital assistant (PDA) 372, a cellular telephone 374, a desktop computer 376, a laptop computer 378, and/or other computerized system or device may communicate. The nodes 370 may represent instances of the data processing functionality 340 of FIG. 51 that may communicate with one another. They may be grouped (not shown) physically or virtually, in one or more networks, such as Private, Community, Public, or Hybrid clouds, or combinations thereof. This allows the cloud computing environment 368 to offer infrastructure, platforms and/or software as services for which a cloud consumer does not need to maintain resources on a local computing device. It is understood that the types of computing devices 372-378 shown in FIG. 52 are intended to be illustrative only and that the computing nodes 370 and cloud computing environment 368 can communicate with any type of computerized device over any type of network and/or network addressable connection (e.g., using a web browser).

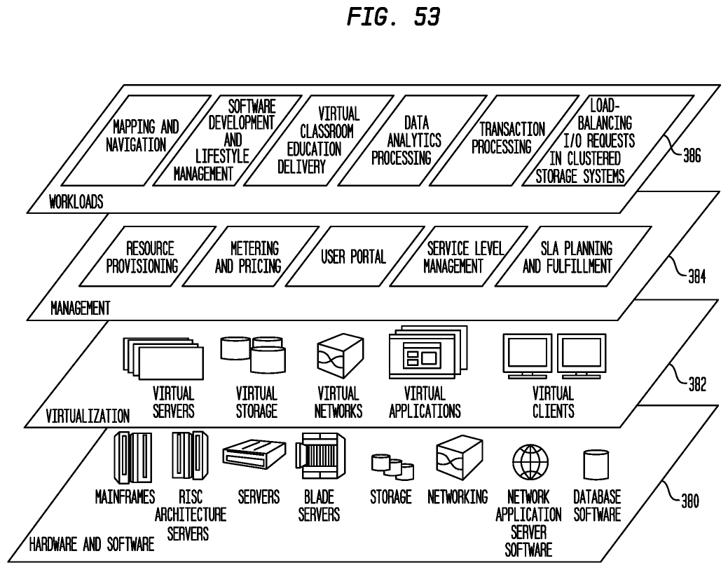

Referring now to FIG. 53, a set of functional abstraction layers that may be provided by the cloud computing environment 368 of FIG. 52 is shown. It should be understood in advance that the components, layers, and functions shown in FIG. 53 are intended to be illustrative only and embodiments of the invention are not limited thereto. As depicted, several layers and corresponding functions may be provided.

A hardware and software layer 380 includes hardware and software components. Examples of hardware components include: mainframes; RISC (Reduced Instruction Set Computer) architecture based servers; storage devices; networks and networking components. In some embodiments, software components include network application server software.

A virtualization layer 382 provides an abstraction layer from which the following examples of virtual entities may be provided: virtual servers; virtual storage; virtual networks, including virtual private networks; virtual applications and operating systems; and virtual clients.

In one example, a management layer 384 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. A user portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

A workloads layer 386 provides examples of functionality for which the cloud computing environment may be utilized. Examples of workloads and functions which may be provided from this layer include: mapping and navigation; software development and lifecycle management; virtual classroom education delivery; data analytics processing; transaction processing; and load-balancing I/O requests in clustered storage systems.

The present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions as described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Accordingly, apparatus, systems, methods and computer program products for end-to-end direct printing of three-dimensional articles (including but not limited to food product articles), with or without AR-enhancement, have been disclosed. While various embodiments have been shown and described, it should be apparent that many variations and alternative embodiments could be implemented in accordance with the present disclosure. It is understood, therefore, that the invention is not to be in any way limited except in accordance with the spirit of the appended claims and their equivalents.

1: A machine-implemented method for producing an article having a related augmented reality (AR) asset that can be displayed in association with the article, comprising:
assigning a printable anchor image to be printed on the article as a printed anchor image;
preparing a reference anchor image to be used by an AR content display device for optical decoding of the printed anchor image;
the reference anchor image comprising an altered form of the printable anchor image that is altered in a manner that facilitates the optical decoding of the printed anchor image on the article; and
logically binding the AR asset to the printed anchor image so that the printed anchor image may be used to trigger a display of the AR asset on the AR content display device when the printed anchor image is optically decoded by the AR content display device using the reference anchor image.

2: The method of claim 1, further including printing the article by direct application of the printable anchor image onto the article to form the printed anchor image.

3: The method of claim 1, wherein the reference anchor image comprises an altered form of the printable anchor image as a result of being optimized, adjusted, modified or varied to match the printed anchor image as it will appear when printed on the article during optical decoding by the AR content display device.

4: The method of claim 1, wherein the reference anchor image comprises an optimized reference anchor image formed as a composite of the printable anchor image overlaid onto an image of the article, with the printable anchor image forming a foreground portion of the optimized anchor image and the image of the article forming a background portion of the optimized reference anchor image.

5: The method of claim 4, wherein the optimized reference anchor image comprises an image of a real production item comprising the printed anchor image printed on the article.

6: The method of claim 4, wherein the background portion of the optimized anchor image formed by the image of the article is delimited to eliminate one or more edge portions of the article.

7: The method of claim 1, wherein the reference anchor image comprises an adjusted reference anchor image comprising one or more of (1) an adjusted anchor image clipping path to increase or decrease its information content by altering image size or shape, (2) a color-to-gray scale translation, (3) a foreground or background intensity adjustment, (4) contrast, sharpness, brightness, shadow, tint or hue adjustments, (5) an alpha channel adjustment to turn-off or turn-on areas of the anchor image, or (6) added frames, rings, ticks or other distinctive visual information to increase an image point count.

8: The method of claim 1, wherein the reference anchor image comprises a plurality of modified variant reference anchor images that are each associated with the AR asset so that any of the modified variant reference anchor images can be used for optical decoding of the printed anchor image to trigger the display of the AR asset.

9: The method of claim 8, wherein the modified variant reference anchor images depict the same subject matter viewed under different lighting characteristics or from different viewing angles.

10: The method of claim 1, further including generating one or more custom image processing commands for programming a custom anchor image processing controller on the AR content display device.

11: The method of claim 10, wherein there are plural reference anchor images that are each assigned to a particular set of the one or more custom image processing commands.

12: The method of claim 1, wherein the binding of the AR asset is user-programmable to dynamically change the AR asset in response to specified events or conditions.

13: The method of claim 1, wherein the printed anchor image comprises a QR code, an App Clip code, or other standardized encoding that is encoded to trigger an imaging device to download an AR content receiver application, the AR asset, or either of them, in response to the imaging device detecting the encoding.

14: The method of claim 1, wherein the article comprises a three-dimensional article formed as a non-sheet-like entity having non-de minimus length, width and height dimensions.

15: The method of claim 11, wherein article comprises an edible article for human consumption.

16-21. (canceled)

22: A system, comprising:
one or more processors;
a memory coupled to said one or more processors, the memory including a computer readable storage medium tangibly embodying at least one program of instructions executable by the one or more processors to perform operations for producing an article having a related augmented reality (AR) asset that can be displayed in association with the article, comprising:
assigning a printable anchor image to the article to be printed on the article as a printed anchor image;
preparing a reference anchor image to be used by an AR content display device for optical decoding of the printed anchor image on the article;
the reference anchor image comprising an altered form of the printable anchor image that is altered in a manner that facilitates the optical decoding of the printed anchor image on the article; and
logically binding the AR asset to the printed anchor image so that the printed anchor image may be used to trigger a display of the AR asset on the AR content display device when the printed anchor image is optically decoded by the AR content display device using the reference anchor image.

23: The system of claim 22, wherein the operations further include printing the article by direct application of the printed anchor image onto the article.

24: The system of claim 22, wherein the reference anchor image comprises an altered form of the printable anchor image as a result of being optimized, adjusted, modified or varied to match the printable anchor image as will appear when printed on the article during optical decoding by the AR content display device.

25: The system of claim 22, wherein the reference anchor image comprises an optimized reference anchor image formed as a composite of the printable anchor image overlaid onto an image of the article, with the printable anchor image forming a foreground portion of the optimized anchor image and the image of the article forming a background portion of the optimized reference anchor image.

26: The system of claim 25, wherein the optimized reference anchor image comprises an image of a real production item comprising the printed anchor image printed on the article.

27: The system of claim 25, wherein the background portion of the optimized anchor image formed by the image of the article is delimited to eliminate one or more edge portions of the article.

28: The system of claim 22, wherein the reference anchor image comprises an adjusted reference anchor image comprising one or more of (1) an adjusted anchor image clipping path to increase or decrease its information content by altering image size or shape, (2) a color-to-gray scale translation, (3) a foreground or background intensity adjustment, (4) contrast, sharpness, brightness, shadow, tint or hue adjustments, (5) an alpha channel adjustment to turn-off or turn-on areas of the anchor image, or (6) added frames, rings, ticks or other distinctive visual information to increase an image point count.

29: The system of claim 22, wherein the reference anchor image comprises a plurality of modified variant reference anchor images that are each associated with the AR asset so that any of the modified variant reference anchor images can be used for optical decoding of the printed anchor image to trigger the display of the AR asset.

30: The system of claim 29, wherein the modified variant reference anchor images depict the same subject matter viewed under different lighting characteristics or from different viewing angles.

31: The system of claim 22, wherein the operations further include generating one or more custom image processing commands for programming a custom anchor image processing controller on the AR content display device.

32: The system of claim 31, wherein there are plural reference anchor images that are each assigned to a particular set of the one or more custom image processing commands.

33: The system of claim 22, wherein the binding of the AR asset is user-programmable to dynamically change the AR asset in response to specified events or conditions.

34: The system of claim 22, wherein the printed anchor image comprises a QR code, an App Clip code, or other standardized encoding that is encoded to trigger an imaging device to download an AR content receiver application, the AR asset, or either of them, in response to the imaging device detecting an image of the encoding.

35: The system of claim 22, wherein the article comprises a three-dimensional article formed as a non-sheet-like entity having non-de minimus length, width and height dimensions.

36: The system of claim 22, wherein article comprises an edible article for human consumption.

37-42. (canceled)

43: A computer program product, comprising:
one or more computer readable data storage media;
program instructions stored on the one or more computer readable data storage media for programming a data processing system having one or more processors to perform operations for producing an article having a related augmented reality (AR) asset that can be displayed in association with the article, comprising:
assigning a printable anchor image to be printed on the article as a printed anchor image;
preparing a reference anchor image to be used by an AR content display device for optical decoding of the printed anchor image on the article;
the reference anchor image comprising an altered form of the printable anchor image that is altered in a manner that facilitates the optical decoding of the printed anchor image on the article; and
logically binding the AR asset to the printed anchor image so that the printed anchor image may be used to trigger a display of the AR asset on the AR content display device when the printed anchor image is optically decoded by the AR content display device using the anchor image.

44: The computer program product of claim 43, wherein the operations further include printing the article by direct application of the printed anchor image onto the article.

45: The computer program product of claim 43, wherein the reference anchor image comprises an altered form of the printable anchor image as a result of being optimized, adjusted, modified or varied to match the printable anchor image as will appear when printed on the article during optical decoding by the AR content display device.

46: The computer program product of claim 43 wherein the reference anchor image comprises an optimized reference anchor image formed as a composite of the printable anchor image overlaid onto the image of the article, with the printable anchor image forming a foreground portion of the optimized anchor image and an image of the article forming a background portion of the optimized reference anchor image.

47: The computer program product of claim 46, wherein the optimized reference anchor image comprises an image of a real production item comprising the printed anchor image printed on the article.

48: The computer program product of claim 46, wherein the background portion of the optimized reference anchor image formed by the image of the article is delimited to eliminate one or more edge portions of the article.

49: The computer program product of claim 43, wherein the reference anchor image comprises an adjusted reference anchor image comprising one or more of (1) an adjusted anchor image clipping path to increase or decrease its information content by altering image size or shape, (2) a color-to-gray scale translation, (3) a foreground or background intensity adjustment, (4) contrast, sharpness, brightness, shadow, tint or hue adjustments, (5) an alpha channel adjustment to turn-off or turn-on areas of the anchor image, or (6) added frames, rings, ticks or other distinctive visual information to increase an image point count.

50: The computer program product of claim 43, wherein the reference anchor image comprises a plurality of modified variant reference anchor images that are each associated with the AR asset so that any of the modified variant reference anchor images can be used for optical decoding of the printed anchor image to trigger the display of the AR asset.

51: The computer program product of claim 50, wherein the modified variant reference anchor images depict the same subject matter viewed under different lighting characteristics or from different viewing angles.

52: The computer program product of claim 43, wherein the operations further include generating one or more custom image processing commands for programming a custom anchor image processing controller on the AR content display device.

53: The computer program product of claim 52, wherein there are plural reference anchor image that are each assigned to a particular set of the one or more custom image processing commands.

54: The computer program product of claim 43, wherein the binding of the AR asset is user-programmable to dynamically change the AR asset in response to specified events or conditions.

55: The computer program product of claim 43, wherein the printed anchor image comprises a QR code, an App Clip code, or other standardized encoding that is encoded to trigger an imaging device to download an AR content receiver application, the AR asset, or either of them, in response to the imaging device detecting an image of the encoding.

56: The computer program product of claim 43, wherein the article comprises a three-dimensional article formed as a non-sheet-like entity having non-de minimus length, width and height dimensions.

57: The computer program product of claim 43, wherein the article comprises an edible article for human consumption.

58-147. (canceled)
